(19) United States
(12) Patent Application Publication
(10) Pub. No.: US 2008/0316206 A1
(43) Pub. Date: Dec. 25, 2008

(54) Drawing standards management and quality control

(76) Inventors: Jerry Jaynes, Nederlands, TX (US); Brett Binkley, Houston, TX (US)

Correspondence Address: TIMOTHY F. MILLS, 1177 WEST LOOP SOUTH, SUITE 400, HOUSTON, TX, 77027-9012, US

(21) Appl. No.: 11/821,133

(22) Filed: Jun. 22, 2007

(51) Int. Cl. G06T 17/00

(52) U.S. Cl. 345/420

(57) ABSTRACT

The computer implemented business method for marketing a CADD standards management system of the present invention comprises providing a CADD user with a centralized distributive control system for managing, controlling and updating CADD standards from a single source, permitting interactive input from a client, enabling data analysis of information included with the standards, and marketing the products of that system.

### CROSS-REFERENCE TO RELATED APPLICATION

Not applicable.

### STATEMENT REGARDING FEDERALLY FUNDED SPONSORED RESEARCH OR DEVELOPMENT

Not applicable.

### BACKGROUND OF THE INVENTION

1. Field of the Invention

The design drawing, on paper or other medium, is a visual means of interpreting and relaying a design from an architect or artist to an engineer or designer. The engineer or designer then adds any necessary additional information to the design drawing to communicate to the manufacturer or contractor how to implement the design of the architect or artist. The drawing may also be used as a basis for a bid tabulation, to determine the cost of construction, and other uses.

Before the invention and wide spread utilization of “computer aided drafting and design”, or simply “computer aided design” in the art, (hereinafter, CADD) the production of design drawings was largely a manual effort. Quality design drawings required an individual well trained in the art of drawing and drafting. By utilizing paper, or other medium such as Bristol board or onion skin, an ink pen or pencil, a t-square and various templates, design drawings of numerous types could be created. This endeavor took years to master and was time consuming to make even one drawing. Board drafting used pencil or ink with one predominant color and all geometry was drawn on a single paper surface. The draftsman would use skill to differentiate between various features such as light and dark lines, wide and narrow lines, dashed and solid lines, etc. If changes were required, frequently the entire drawing had to be redrawn from the beginning.

As the manual methods progressed, it became apparent that when certain techniques were employed in the creation of the drawing that it made the drawing easier to read and would allow the reader to easily differentiate between different design elements. Examples of different drawing techniques are in the weight of the pen used, the size of the letter, using regular or bold line weights or text, and employing symbols that would be represented in a later drawing of a larger scale and increased detail. As the drawing methods continued to progress other techniques such as creating multiple layers of paper or film were employed.

With film, this technique was called “pin bar” (the drawing layers were manually affixed by pens and aligned on a bar). This method would allow the author to draw various design components on different pieces of film and include or exclude the layers for printing in the blue line machine without having to completely reproduce a new drawing. This system was seen as a tremendous advantage by not having to reproduce various aspects of a set of plans that may need to be represented in other disciplines of the plan set. On drawings requiring illustration of numerous types of systems information, a semi-transparent paper such as onion skin, and later Mylar® plastic, would be utilized to visualize just one specific type of information or system.

The advantage of the transparent sheet was that each design system could be overlaid individually, or combined as needed, to illustrate the additional information with the base drawing. If changes had to be made to a specific system drawing, then just that drawing had to be reproduced—not the entire drawing comprising all of the required design systems. For example, on a highway construction or maintenance project, the plans of the architect would include multiple systems such as road placement in relation to local geography and topography, road layer composition, curbing or shoulder placement, utility pole placement, and underground design systems placement such as water, electrical, telephone, gas and sewer lines. The extensive amount of information required to adequately illustrate each system would be very difficult to draw, or decipher, on a single sheet of paper. Thus, the ability to present single or combined systems on separate drawings aided the draftsman, the engineer and the contractor.

Techniques that were identified above, such as weight and thickness of lines, various line styles, etc., were also employed to represent different types of geometry and even the placement of symbols that would be represented in greater detail on a standard details sheet within the plan set. These same techniques have been carried into today's design methods with each entity creating unique criteria that is employed to make their plan sets more aesthetically appealing, orderly and of course accurate for the reader, and ultimately, the entity responsible for construction.

Computer aided drafting and design (CADD) was a term coined to describe a new process of using computers to replace the manual creation of design drawings. Prior to the introduction of the computer, design drawings were two-dimensional representations in ink or pencil. With the electronic format of the computer, the drawing could be represented in three dimensions with multiple layers representing different design systems. For example, in a road construction drawing, the roadway surface system would be placed on a separate electronic ‘level’, sidewalks would be shown on a different level, subsurface water drainage would be shown on a different level, and so on until all the systems were drawn and contained in the completed electronic drawing file(s). Another advantage of the electronic drawing was that different levels could be highlighted individually or in combination to allow visualization as needed. With the introduction of the computer, the electronic environment became an indispensable tool to assist the draftsman in creating drawings while eliminating the need for hand drafting tools such as pen, pencil eraser, t-square, templates, etc. The use of CADD had promise in developing drawings faster, cheaper and more accurately than conventional methods.

The use of computers introduced a set of variables not previously available in manual drafting. The electronic CADD file holding the geometry of the drawing could be a complex structure of multiple layers, colors, line weights, and line codes known in the art as ‘symbology’. Layers or levels were employed in even the earliest versions of CADD because of the unique time saving and compartmentalizing of like information to create a neat and orderly drawing. With CADD the draftsman could choose any level, color, weight, line code, font, text size, etc, which they desired while placing geometry in the drawing. In the early days of CADD each draftsman would create a drawing using a variety of symbology pleasing to them. Since every draftsman used primarily their own symbology, the results were sets of drawings which frequently differed in appearance when plotted.

Gradually, companies began defining what symbology would be assigned to the features drawn in an effort to standardize the final appearance of the project drawings. Features which were drawn repeatedly, such as a valve or a stop sign, were given a unique identifier and saved in a digital format for use again when needed. This collection of named features is referred to in the art as a ‘symbol library’. Companies began publishing level assignments and symbol libraries in CADD Standards Manuals not only for their own employees to use, but also for their independent contractors, such as consultants, to use. With each contract between a client and a consultant, a separate document identifying CADD standards was made a part of the contractual obligations.

The CADD environment eventually expanded into development of Infrastructure design, engineering and architectural design, e-government, construction, manufacturing, and organizational operations, as well as many other systems and industries. Regardless of the use, in order to maintain uniformity, reproducibility and quality control of CADD drawings, criteria for the placement of geometry, symbols, intelligent attributes and any information developed in the CADD process must be set to the required client “standards” as defined or adopted by the client.

The importance of the “standards” for objects in the CADD drawing is initially to guarantee uniformity in the information conveyed in the drawing. That finished drawing may then be relied upon in several subsequent project stages, such as determining the cost of building, constructing or manufacturing the project, obtaining bids for various types of work detailed on the drawings, tracking construction progress and identifying errors, and determining the value of the final product. For example, in a public highway construction project, the responsible government body would rely upon the CADD drawings to estimate costs of construction, provide the drawings to construction companies in requests for bids, guide the engineers and contractors during construction, and finally be used by government to determine the value of the finished project, or asset. Asset valuation of the completed project may then used by the government to adjust property valuation for taxation purposes, or as basis or collateral for a loan, such as a public bond appropriation.

While CADD standards provide for uniform application of geometry in drawings, their implementation has been found to slow the overall execution of the design drawing. For every line, circle, arc, etc. that has to be drawn, the designer must consult the published CADD Standard Manual to determine what attributes, such as level, color, line style, and weight, are to be used. This constant referring to the Standards Manual adds hours of non-productive labor cost to a drawing, and decreases the reliability of drawings due to the reliance on user input of the correct attributes for each standard.

2. Description of Related Art

Various attempts have been made to develop a better way to deliver these standards for use by the designer while maintaining quality control of the finished drawing. For example, design companies have hired programmers to make the written standards available in a computer readable format by creating custom pages which display standards from the written manual for the designer. In addition, CADD software providers have incorporated a variety of methods within their software to implement standards. Other companies have seen the opportunity and have developed costly solutions to market to those not having the resources to develop a solution.

Since the introduction of CADD, companies (generally know as “clients” in the art) who contract work to engineering firms (generally known as “consultants” in the art) stipulate how they expect the design drawings to be constructed pertaining to the elements (generally known as “geometry” or “objects” in the art) placed in the drawing. For example, they may require that all lines representing primary piping must be the color red, with a line thickness of 3, and a line style of solid, and placed on the ‘primary piping’ layer, or level. The valves and fittings (generally known as “symbols” in the art) on this piping should match the same settings.

As clients began to organize their requirements for appearance and placement of geometry in a drawing, they were, in effect, creating a set of CADD design standards. These new standards were eventually compiled into written manuals, company by company, project by project, or designer by designer, as time and resources permitted. A lengthy set of written CADD standards tended to slow the design process as a user would have to search the list before beginning to draw an element. Each time the user wanted to place another type of element in the drawing, the CADD Standards Manual had to be consulted so the user would know what color, thickness, line style, and layer was to be input into the CADD application program before the element could be drawn.

The impact of manual placement of standards is significant to time and cost. Even for a single draftsman, the number of elements drawn in an eight hour period is considerable. In addition, each standard may contain a plurality of attributes to define an element and each of these attributes must be manually input into the CADD application before the element may be added to the drawing. The impact of researching and setting standards from the written source for each element is that it impedes progress on the project, slows the design and drawing process, lengthens the project completion time, increases the labor requirement since more draftsmen are required to finish the project in the time allotted, and, therefore, increases the overall cost of completion of the drafting project.

Various CADD software vendors such as AutoDesk, Inc., and Bentley, Inc., have added functionality within their respective applications, AUTOCAD® and MICROSTATION®, to harness CADD drawing standards and make them more readily available to the draftsman. These two CADD drawing application software packages are the most widely used in the industry. Each software application contains the ability to harness a set of client standards and allow the user to apply them at will. They do not develop and market an application tool for a specific set of standards for a client, but they do make the functionality available for each client or consultant to develop their own method of standards interaction with the application.

Altivasoft, Inc., and Axiom, Inc., are two companies which provide software and services to the clients and consultants who use AUTOCAD® and MICROSTATION® products. Each company has developed software to harness a set of CADD standards. Their software allows a user to accurately apply these standards to their design drawings. There are other companies who provide consulting and programming services but do not offer a comprehensive suite of software such as ALTIVASOFT or AXIOM.

The common theme of these solutions is that they must be installed as a database on the local desktop workstation computer for the user. As changes or additions occur in the standards database, an updated version of the standards must be physically re-installed on every computer. Uniformity in applying the correct versions of the standards to every drawing becomes the concern when depending on multiple users and consultants to deliver drawings requiring the use of the same standards.

In contrast to these solutions for standards management supplied to multiple workstations, the method of the present invention utilizes a centralized compilation of client standards and symbols accessed from a remote network server application, hereinafter a ‘network user interface application’ or ‘user interface’ and incorporated herein by reference, within the CADD application software, such as AUTOCAD® or MICROSTATION®. This centralization of standards on a network accessible application allows all project users to directly upload or input standards and symbols into their respective CADD application from a centrally managed source. In addition, the availability of the standards through the network application enables the user to automatically update the standards and other information required for the specific drawing and client.

In summary, the drawings may not be accurate if the designer has not installed the latest standards update version before submitting the drawings to the client. With potentially hundreds of draftsmen from various consultants, companies and/or government organizations working simultaneously on a construction project, it becomes increasingly difficult for the CADD administrator to manage the plurality of standards in any one project and maintain quality control by determining and guaranteeing that every drawing has implemented the latest required version of the relevant standards.

### BRIEF SUMMARY OF THE INVENTION

The method of the present invention substantially departs from the conventional concepts of the related art by providing CADD drawing standards management and quality control from a centralized network source, or ‘single source’, via a network accessible application.

A method for maximizing quality control of standards inputting and updating in CADD drawings, and thereby cost reductions in drawing production is disclosed.

Methods for providing and automatically updating design standards for use in CADD drawings, and producing a CADD drawing there from are disclosed.

The method of the present invention overcomes the limitations of the related art by isolating standards for CADD drawing input to one source available to all users simultaneously, and upon selection automatically inputting the correct standard and attributes for the drawing into the CADD application.

Regardless of the industry or project, criteria for the placement of geometry, symbols, intelligent attributes, and any information developed or included in the CADD process must be set to exacting client standards for each element. The method of the present invention is the automated delivery and quality control for standards in the CADD environment.

The network based application of the method of the present invention provides an on-screen user interface menu which acts a consistent, online, instantly available delivery mechanism for CADD drawing standards and any other information, such as imbedded data, intelligent attributes, and the like, that may be included in the network based application. In addition to acting as the standards delivery mechanism for the CADD drawing, the network user interface application of the present invention also performs the operation of command execution within the CADD application which is possible since the network application of the present invention is directly linked to the CADD drawing application.

In the method of the present invention the command execution is selected and executed from the network environment and delivered through this direct link within the CADD application. The network application tools of the present invention are internet compatible code based, completely resident on the network accessible computer or server, and platform or operating system independent. Internet compatible code includes but is not limited to HTML, dHTML, JAVASCRIPT® and PEARL®. Thus the network application of the present invention works on any platform, including but not limited to WINDOWS®, MACINTOSH®, LINUX® and UNIX®. Whatever operating system and platform is supported by the CADD drawing application, direct access will always be available to the application and methods of the present invention.

In addition in the methods of the present invention, software is not required to be installed on the user workstation by the network application of the present invention, and there is no reliance on either the workstation operating system or browser software. When the network application of the present invention is accessed it displays the entire complement of CADD standards within user interface windows, such as tool palettes, provided by the CADD application software. Upgrades to CADD drawing application software or to the computer operating system will not require an upgrade to the network application of the present invention since it is a separate application based remotely on a network server or other computer.

By comparison, the standards management solutions provided by both ALTIVASOFT and AXIOM require the user to be running a single proprietary platform, WINDOWS® 2000 or higher, and their respective applications must be installed on the user's workstation computer. With every change in the WINDOWS® operating system or the CADD application, these companies must develop and recompile an upgrade to their existing version. The upgrade must be redistributed and reinstalled on every computer. Users are constantly faced with the management and cost effects of new application upgrades on their existing CADD environment.

Since the user interface application or on-screen menu of the method of the present invention resides on the network server and not on the user's computer, the user interface application of the present invention is not workstation dependent. A user can be at home, at another office, or at any location in the world and access the on-screen network user interface menu from any internet or network capable computer.

ALTIVASOFT and AXIOM use a node locking arrangement so the software can only be used on a specific computer. Their applications must be installed on an individual computer along with the standards of the client. If the software needs to be uninstalled from one computer and reinstalled on another, a new password key must be obtained before the application will successfully operate on the new computer. The user cannot use their application when away from the office unless they carry their workstation computer with them, or license a separate notebook computer application for transportability. Whereas in the method of the present invention the standards management and control application is not installed on a user workstation, but accessibly via a network. Thus the workstation and license limitation does not exist in the method of the present invention.

CADD drawing standards frequently require changes and many such changes may be made over the life of a project. ALTIVASOFT and AXIOM can read CADD standards from the individual workstation computer or from an intranet server. As a change is made to the standards, the database on the server must be recompiled and the changes made available for the users in that company to upload. If the company has multiple sites, the physical standards database must be distributed and loaded on other servers for each user to have access to changes. Thus there exists a constant problem for maintaining standards quality control, in that individual sites may not timely import the updates and then one or more drawings will be produced using an incorrect set of CADD standards. However, when a change is made to the standards compilation of the network user interface application of present invention, the update is instantly available for all users since it is only necessary to make the change in one location on a remote network server. This method of network distributive control maximizes quality control for the standards and any information that is included with the standards, and assures uniform application of the information. This provides the client with accuracy of quality control never before possible.

An additional challenge of CADD standards management is how to assure consulting engineering firms that their sub-consultants are also using the correct and up-to-date CADD standards version required by their client. ALTIVASOFT and AXIOM make their software available for installation on each workstation to be used. If a consultant wants his sub-consultants to use the same CADD Standards, then either the consultant must provide, or the sub-consultant must purchase, the necessary licenses for the number of computers to be used. The database of CADD standards must then be distributed to every computer used in the project. As the standards change, this change must also be distributed to each computer used in the project. Thus, the problem of managing and confirming the input of updated standards is multiplied when sub-consultants are employed. The question of whether everyone creating design drawings has actually installed the most current version of CADD Standards will always be present in such a system.

The method of the present invention is not dependent upon or affected by fragmented project management or distributed labor since every internet or network capable computer can access the network user interface application of the present invention. From the centralized network distributive control center, a single set of CADD Standards can be accessed by the client, consultant or sub-consultant and all design drawings produced will be uniform and standard in their appearance.

In regard to the cost of maintaining and managing standards by the methods of the related art, ALTIVASOFT and AXIOM provide their application to administer CADD standards at an average cost of $600 per license (per computer) and an annual maintenance fee of $200 per license. The software must be installed on each individual computer and there are no internet components to the software for accessing CADD Standards. Whereas, in a preferable embodiment of implementing the method of the present invention, the user would be charged a monthly subscription fee with no annual maintenance fee. With the present invention there is no deliverable application to the end user to install on the workstation computer. All CADD Standards posted on the network user interface application in a Standards Distributive Control Center will be available to any subscriber.

Thus such a platform and workstation independent CADD standards management and quality control system may be marketed and provided to clients including the numerous advantages and features of the present invention to increase productivity and reduce the cost of CADD drawings, revisions and updates. The interactive features of the invention provide flexibility by allowing clients to directly manage their standards, products and quality control, while gaining additional value by including data that may be analyzed for cost, value, location and a plurality of other variables defined by the needs of the client.

In regard to the compilation of standards, the methods of the related art compile the standards and information into a database. A set of CADD Standards can be shown on paper or maintained in various file formats such as an Excel™ spreadsheet, an ASCII file, or a database. These standards are a collection or compilation of categories of elements or attributes to be placed in a drawing with assigned colors, levels, weights, line styles, fonts, text sizes, etc. This collection of CADD Standards is commonly referred to in the art as a ‘feature table’ file. ALTIVASOFT uses a database to maintain CADD Standards for a client. Their requirement is that an open database connectivity (ODBC) compliant database application is necessary. ODBC is a database access method developed to allow access to data from any application regardless of the database management system. The dependency on the ODBC compliant structure for the CADD Standards limits the choices to the user. AXIOM uses an ASCII text file to maintain the CADD Standards for a client. However, the network user interface applications of the present invention do not rely on a database. Rather, the feature table containing the CADD standards is resident on the network server or other computer and is used to create the user interface application menus. Since the resident code is an ASCII format, the speed and ease of use is maximized when accessing this code by a network connection.

In accord with the methods of the present invention, a customized network on-screen, or user interface, application and menus are constructed comprising the relevant CADD drawing standards, and any other information, including but not limited to embedded data, intelligent attributes, subsets of standards, and the like, identified to be used or included in a drawing. These standards and other included information has been converted to usable code which resides on a network server to be displayed as network user application on-screen menus. The internal network linkage feature of the different CADD software applications, such as MICROSTATION® or AUTOCAD®, is utilized to access the network user interface application URL (universal resource locator or network address). Once the network on-screen application menu is opened it contains sub-menus of the CADD standards and any other information requested to be included in the drawing. This network on-screen application menu may be programmed to contain a plurality of additional functions comprising automatic input and update of standards.

An additional advantage of the present invention over the related art is that the CADD standards reside in one location on the network but are available to every networked computer in the world. There is no software to deliver or install on the computer for the CADD user since the standards are accessed and input through the network accessible application user interface menu. Any network accessible designer in the world can open the application network user interface application and begin choosing standards and placing symbols in their drawing since the standards and any other required information resides on a remote network accessible server or other computer.

The method of the present invention differs from the related art in that design drawing standards for CADD drawings were initially compiled in written manuals and made available to the draftsman. The draftsman would have to manually look up each object in the manual to determine the associated standard and attributes, and change each bit of information in the CADD application to meet the required standard. In the method of the present invention, the user selects from an on-screen menu which is reading the network based application of the present invention and immediately provides access to the up-to-date standards feature table resident in the single source network server.

The method of the present invention further differs from the related art in that changes or additions to standards are immediately available at the same time to all users through the network. The advantage is that the CADD Administrator can have full assurance, in real time, that everyone on the design team, wherever they are, is using an identical set of CADD standards.

The methods of the present invention further differ from the related art in that information related to a standard may be embedded electronically in the computer file of the CADD drawing. An example of embedded information, in addition to the attributes of a standard, would comprise price or cost information of the object in the drawing. Such Information would generally not be shown in the completed drawing but would be embedded in the CADD drawing electronic file from which it could be retrieved when needed. Once retrieved by the appropriate computer application, the embedded information could be immediately presented to the user in a readable format. For example, the cost of an object to purchase and install could be determined as the object is added to the drawing by including that information in the network application feature table along with the standards. A further advantage of including embedded cost information with a drawing standard is that the cost information could be set to automatically update from a linked database or similar compilation of cost information, thus providing reliable costs estimates to the user based upon the most current cost data. Therefore, the user would have the assurance of the most up-to-date cost data estimates as the basis for any analysis for a bid tabulation, asset valuation or loan valuation.

A further advantage to including embedded information with a standard is that lists of quantities such as volume, units, linear details, distances, etc., could be compiled, analyzed and compared to a chart to create a bid tabulation.

The method of the present invention further differs from the related art in that portions of the CADD drawing constructed from information obtained from the user interface application of the present invention may be extracted electronically and analyzed for a particular purpose, or further divided and analyzed as needed into smaller and smaller sub-sets. Thus the method of the present invention provides scalability of the standards compilation for use and analysis. The advantage is the ability to isolate certain portions of the CADD drawing and mine or manipulate the associated data as needed.

Thus the method of the present invention provides the user with advantages over the related art in that a CADD drawing may be constructed with geometry standards and other embedded information from a network user interface application located on a remote server or other computer. Once completed, the geometry standards in the CADD drawing may be manually or automatically updated through access to the network user interface application. In addition, the electronic version of the drawing file may contain a plurality of types of additional information associated with the geometry, such as embedded information or intelligent attributes, associated with the respective standards, or needs of the client. Such additional information may be retrieved and compiled as necessary to analyze projects and variables. The combined value of the additional information may be retrieved to accurately determine pricing or costs as a basis for bid tabulations, asset and loan values, and other comparable purposes.

According to one aspect of the invention, widely known standards such as government approved and published standards, and symbol libraries, are incorporated into a feature table included in a network on-screen menu application and made available to users via the method of the present invention. The user will then access and update CADD drawings by accessing the menu through the network. The on-screen or user interface menu application provides a network based set of tools and menus that advance and enhance the CADD environment and are instantly available to anyone with a network connection, in the same location as the standards server or around the globe. The network user interface menu and tools are the delivery mechanism for setting the CADD environment in an automated fashion to meet the client standards set forth.

In yet another aspect of the invention, a client that has their own set of unique standards and symbol libraries to be used in their disciplined drawings may have a custom feature table compiled and made available to its users via the methods of the present invention. Each network application on-screen menu is created and customized specifically for the client. The client will then direct each of its employees, as well as its independent contractors or consultants, to the one location on the network where the CADD standards for the contracted project can be obtained. The method of the present invention provides a network based set of tools and menus that advance and enhance the CADD environment for the specific needs of the client, and are instantly available to anyone around the globe with an internet connection.

### BRIEF DESCRIPTION OF THE DRAWINGS

Note: The patent or application file contains at least one drawing executed in color. Copies of this patent or patent application publication with color drawings will be provided by the Office upon request and payment of the necessary fee. 37 C.F.R. §184 and MPEP 608.02(V).

FIG. 1 is a flow diagram illustrating the manual method of the existing art managing and inputting standards to create a CADD drawing;

FIG. 2A-2M, inclusive, are screenshots of a computer user interface illustrating a manual method of the existing art of placing an object standard in a MICROSTATION® brand CADD drawing;

FIG. 3A-3O, inclusive, are screenshots of a computer user interface illustrating a manual method of the existing art of placing a symbol standard in a MICROSTATION® brand CADD drawing;

FIG. 4A-4T, inclusive, are screenshots of a computer user interface illustrating a manual method of the existing art of placing text or annotation in a MICROSTATION® brand CADD drawing;

FIG. 5 is a schematic diagram of an exemplary environment in which the method of a preferred embodiment of the invention may be used to input, process, retrieve and display a drawing or derived data;

FIG. 6 is a flow diagram illustrating a preferred embodiment of the present invention;

FIG. 7A-7H, inclusive, are a preferred embodiment of the present invention showing screenshots of an exemplary computer user interface that interactively displays information to the user permitting input and updating of an object in a MICROSTATION® brand CADD drawing;

FIG. 8A-8F, inclusive, are a preferred embodiment of the present invention showing screenshots of an exemplary computer user interface that interactively displays information to the user permitting input and updating of a symbol in a MICROSTATION® brand CADD drawing;

FIG. 9A-9E, inclusive, are a preferred embodiment of the present invention showing screenshots of an exemplary computer user interface that interactively displays information to the user permitting input and updating of text in a MICROSTATION® brand CADD drawing;

FIG. 10A-10M, inclusive, are screenshots of a computer user interface illustrating a manual method of the existing art of placing an object standard in an AUTOCAD® brand CADD drawing;

FIG. 11A-M, inclusive, are screenshots of a computer user interface illustrating a manual method of the existing art of placing a symbol in an AUTOCAD® brand CADD drawing;

FIG. 12A-J, inclusive, are screenshots of a computer user interface illustrating a manual method of the existing art of placing text in an AUTOCAD® brand CADD drawing;

FIG. 13A-E, inclusive, are a preferred embodiment of the present invention showing screenshots of an exemplary computer user interface that interactively displays information to the user permitting input and updating of an object in an AUTOCAD® brand CADD drawing;

FIGS. 14A and B, inclusive, are a preferred embodiment of the present invention showing screenshots of an exemplary computer user interface that interactively displays information to the user permitting input and updating of a symbol in an AUTOCAD® brand CADD drawing;

FIG. 15A-E, inclusive, are a preferred embodiment of the present invention showing screenshots of an exemplary computer user interface that interactively displays information to the user permitting input and updating of text (annotation) in an AUTOCAD® brand CADD drawing;

### DETAILED DESCRIPTION OF THE INVENTION

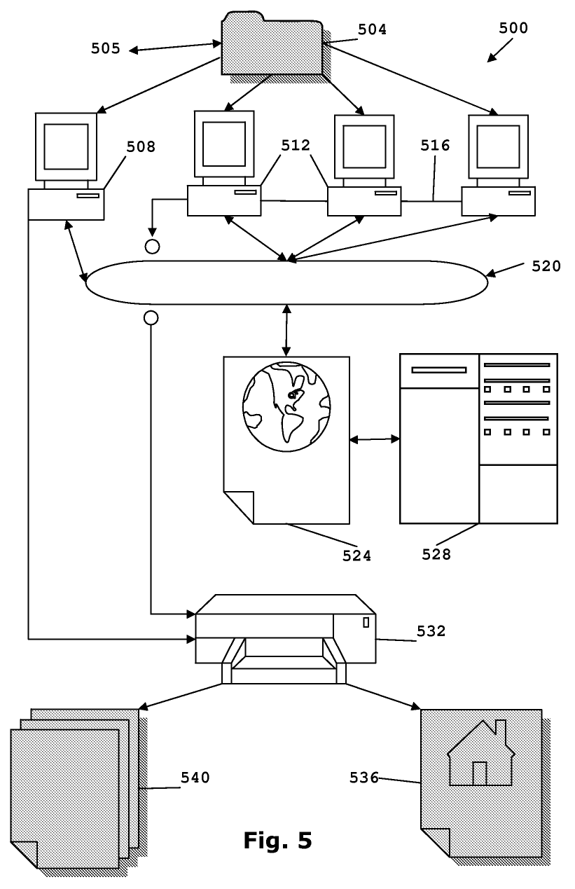

The present invention is described more fully by reference to the preferred embodiments of the figures. However, the embodiments of the invention may be in different forms and these figures should not be construed as limiting the scope of the invention as described herein. FIGS. 5 through 9 and 13 through 15 are illustrious of embodiments of the present invention and are in accord therewith.

Before symbols, also known as geometry in the art, can be placed in a CADD drawing by the draftsman, the attributes of the symbols must be set according to a pre-defined set of parameters, generally known to those skilled in the art as CADD drafting ‘standards’. Standards may be designed and produced to be unique to specific requirements dictated by a client, or from available public, industry, government or other sources.

One of the limitations of paper drawings is that they are two-dimensional, but are used to describe three-dimensional elements. To draft the detail of three-dimensional objects in a two-dimensional drawing, the draftsman may utilize a variety of line forms, textures, shapes, colors, intelligent attributes, coordinates, unique identifiers, codes, etc. To provide further flexibility to the draftsman and users of the final drawing, the drawing may be divided into multiple levels.

The following illustrations will make a comparison between the long-standing manual methods known in the art of applying CADD standards to a design drawing, and the newly developed CADD standards management and quality control methods of the present invention.

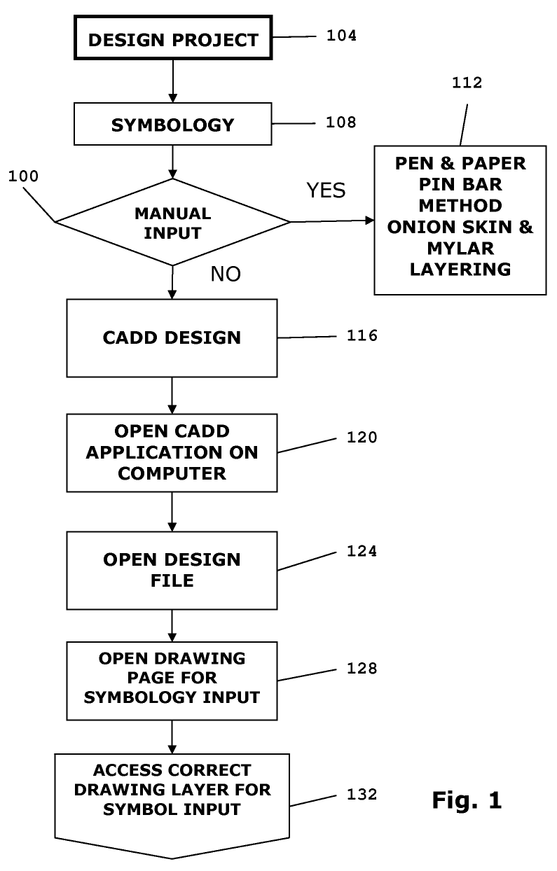

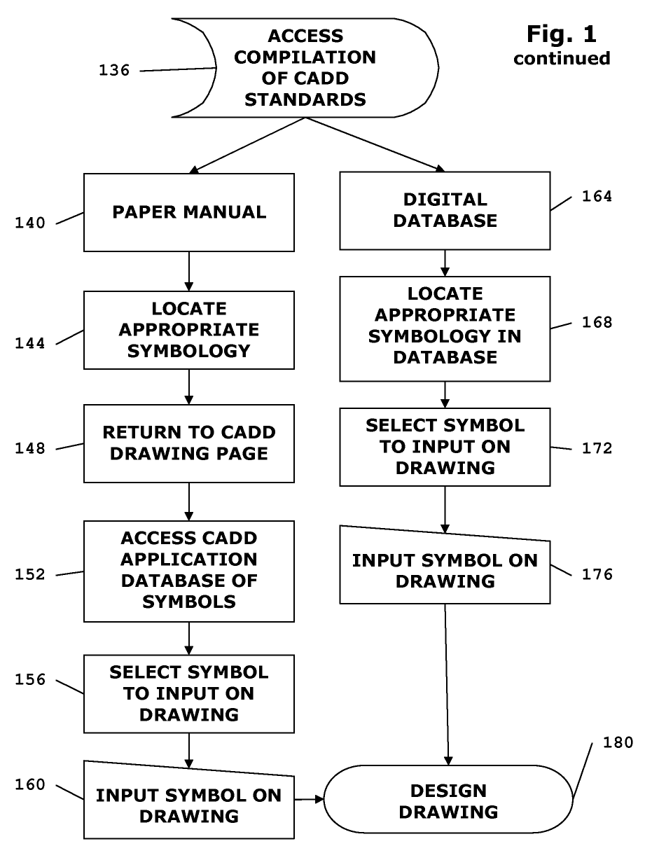

The representative existing method 100 in the art of manually placing symbology (also known as geometry in the art and incorporated herein by reference) 108 in a drawing 180 is described in the provided block diagram of FIG. 1. Initially, a design project idea 104 is provided by a client that requires a drawing 180 to be drafted. The drawing 180 must contain sufficient detail and instructions to permit a designated manufacturer or contractor to build the project from the detail on the drawing 180. Manually inputting the symbology 108 is a time consuming and error prone process. In the manual method of the original pen and ink 112 described above, the symbology 108 is drawn by hand on one or more layers of paper or plastic, as in the pin bar method. In the manual method of CADD design 116, the draftsman first identifies the symbology 108 to be input in the drawing 180 and then opens the CADD application 120. The draftsman then proceeds to open the computer file containing the design 124 and then the specific drawing page 128 in which the symbol is to be placed. Within drawing pages there may be more than one layer for symbol input 132. Once the correct drawing page and layer are identified, the draftsman must access the compilation of CADD standards 136 to find the required symbol for input. In the method of using a paper manual or compilation of standards 140 the draftsman must locate the manual 140, open it and consult an index or table of contents and navigate through the pages to the page that shows the appropriate symbol 144. Upon identification of the appropriate symbol in the paper manual 140 the draftsman returns to the CADD drawing page 148 and opens the database of symbols 152 included in the CADD application. The database is reviewed until the correct symbol is identified and selected 156 and then input on the drawing 160. This process is repeated until all symbols are input and the drawing 180 is completed. However, providing a drawing with the most up to date standards requires physical production and distribution of updated pages for the manual, review of all updates by the draftsman, selection of geometry already in the drawing to update, and then manually updating each entry. A laborious, time consuming process that introduces potential error by incorrect entry or simple omission of an updated standard.

A further refinement of the manual method of standards control and symbol placement 100 is the adaptation and conversion of the paper manual of standards and symbols 140 into a digital database 164. The digital database 164 is accessible only within the CADD application on the individual workstation as reviewed above. The draftsman locates the appropriate symbol in the database 168, selects the symbol 172, and performs the input function 176 to place the symbol 108 in the drawing 180.

Updating and maintaining current standards in the digital database 164 is dependent upon distribution and installation of updates on each workstation either by diskette or access through a computer network. Thus, the digital databases of standards 164 of the existing art enable more rapid access to the compilations of symbology 136 but have not improved on the laborious and time consuming process of distributing updates and requiring existing drawings to be manually reviewed for updating by the draftsman. Again, errors in the drawings occur if all updates are not installed on the workstation or if the drawing is not updated with the newest standards release.

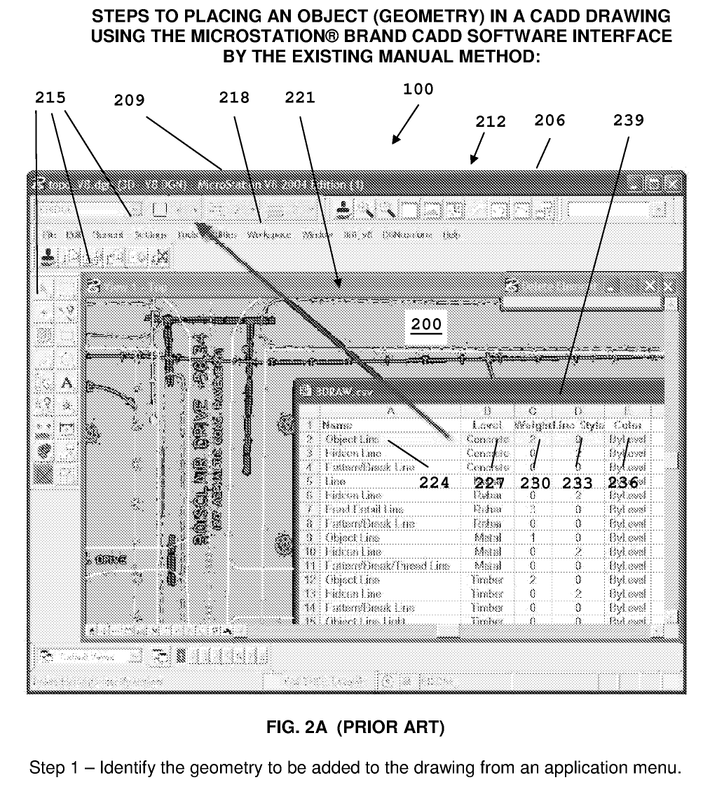

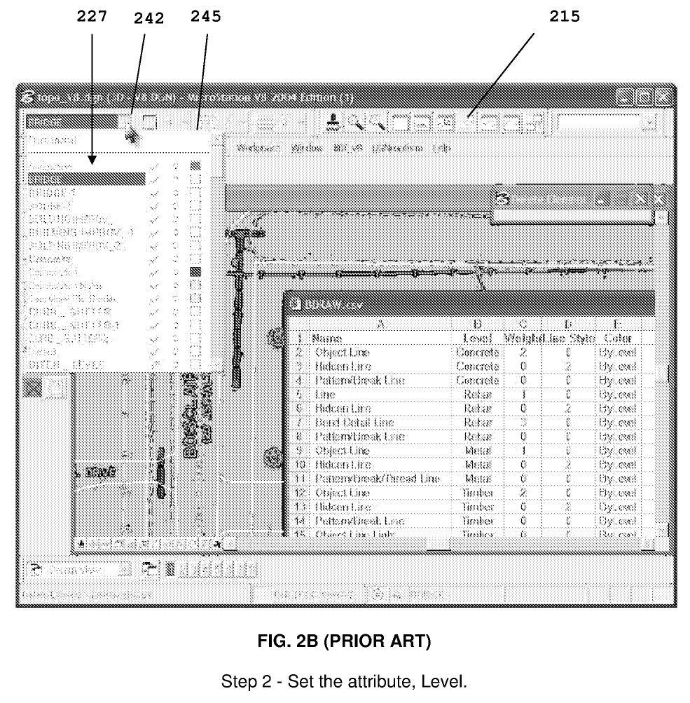

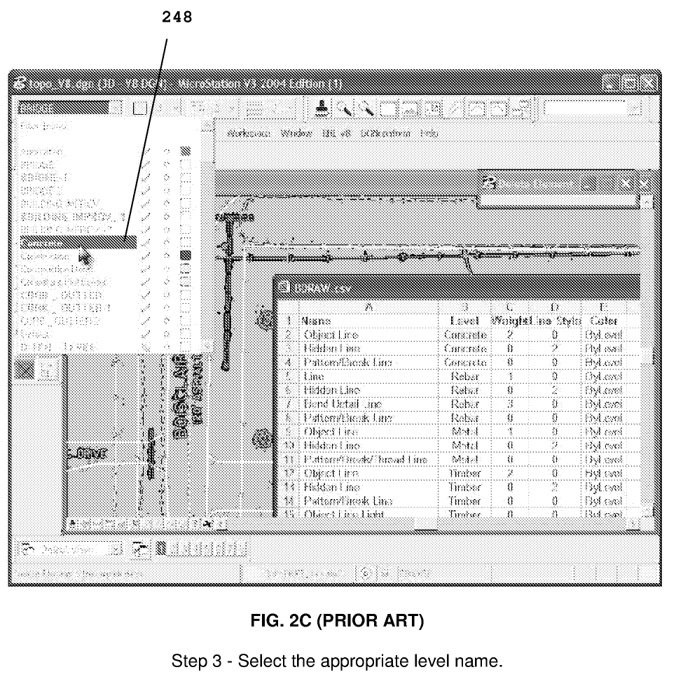

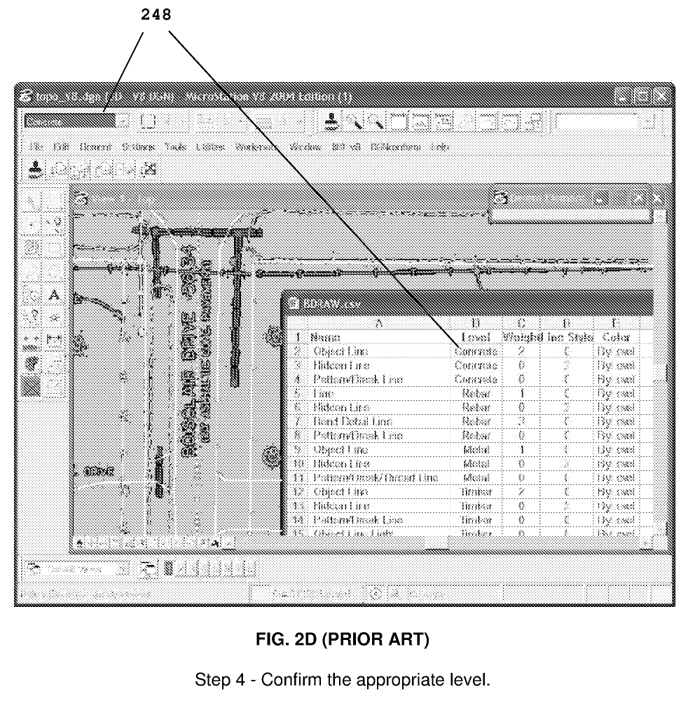

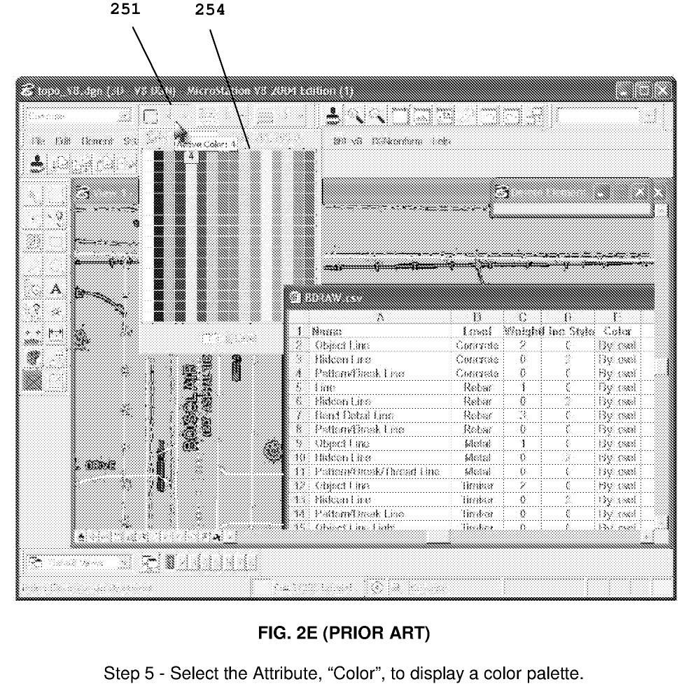

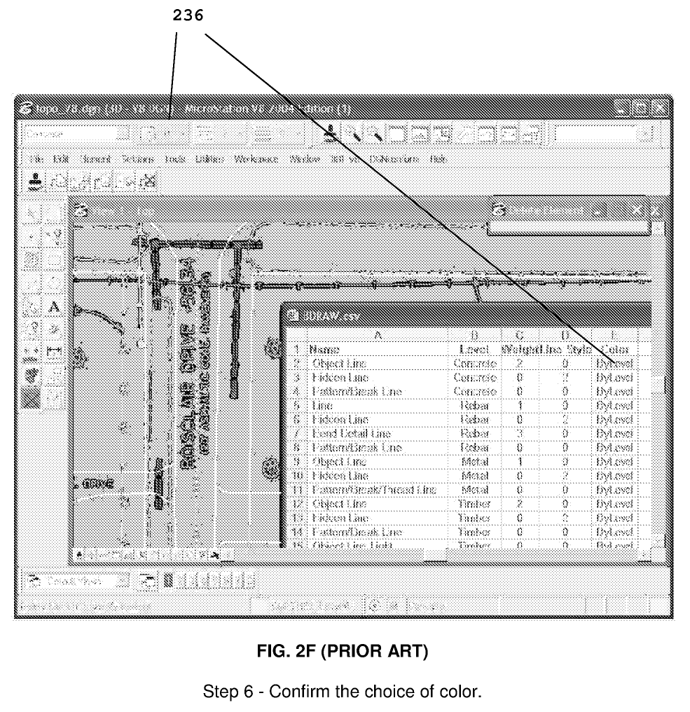

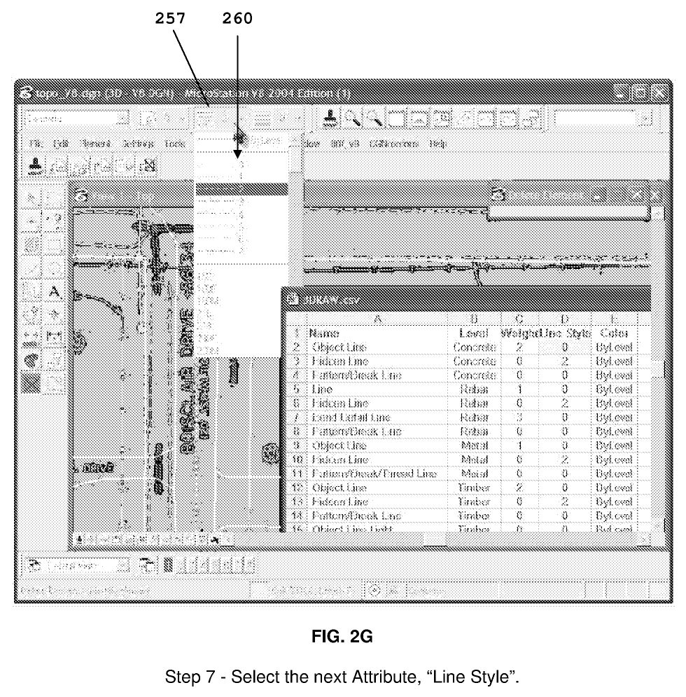

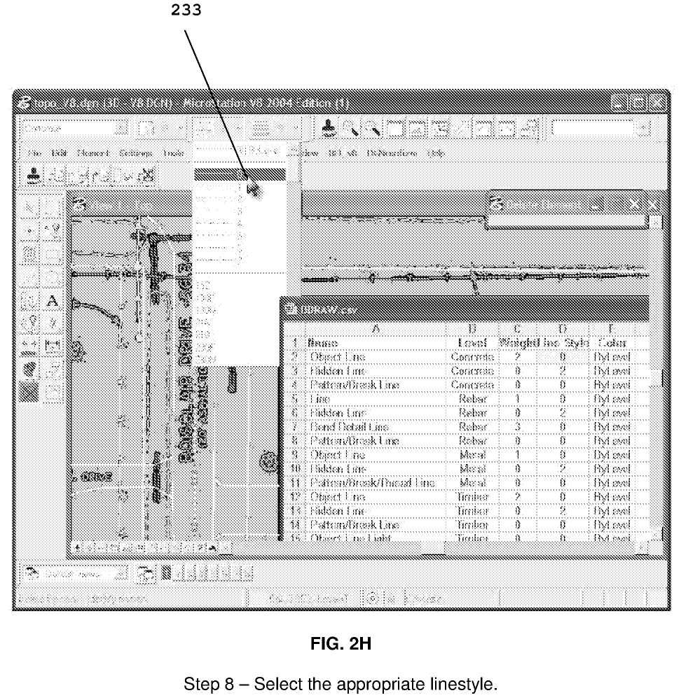

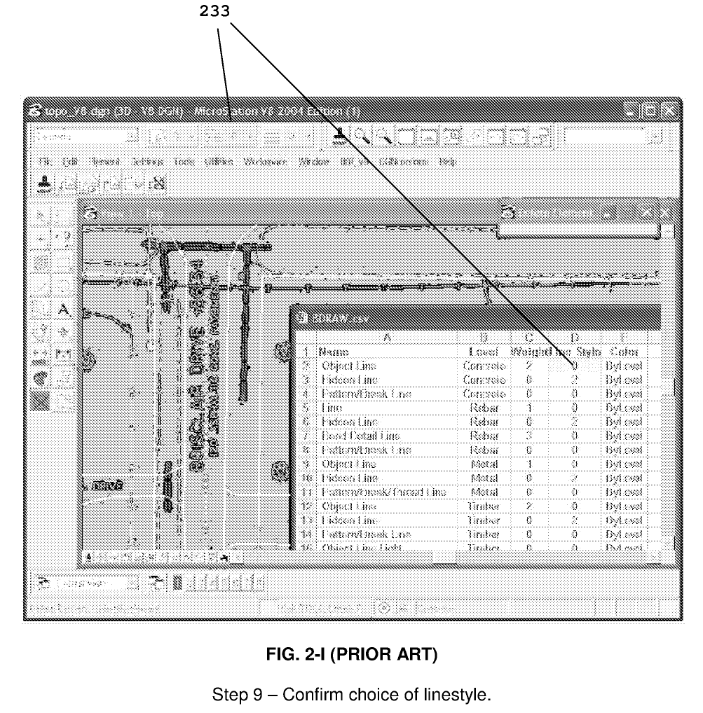

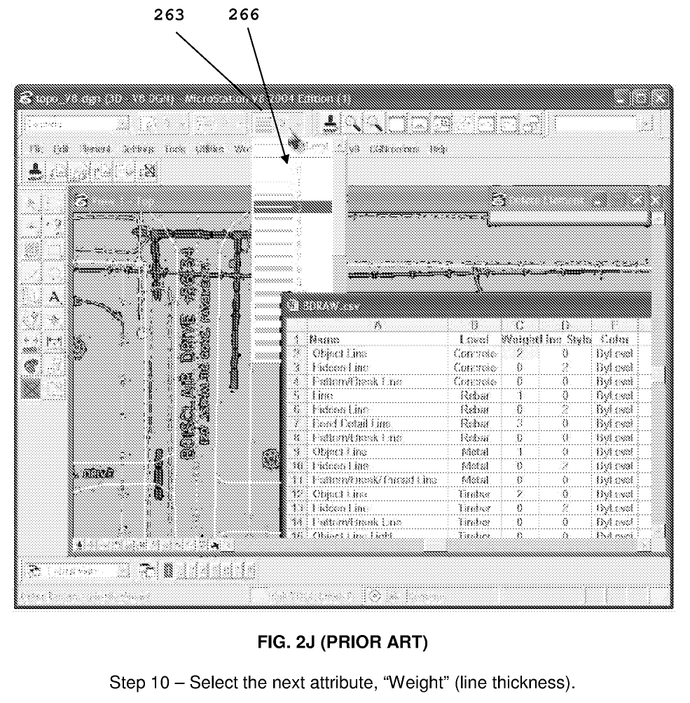

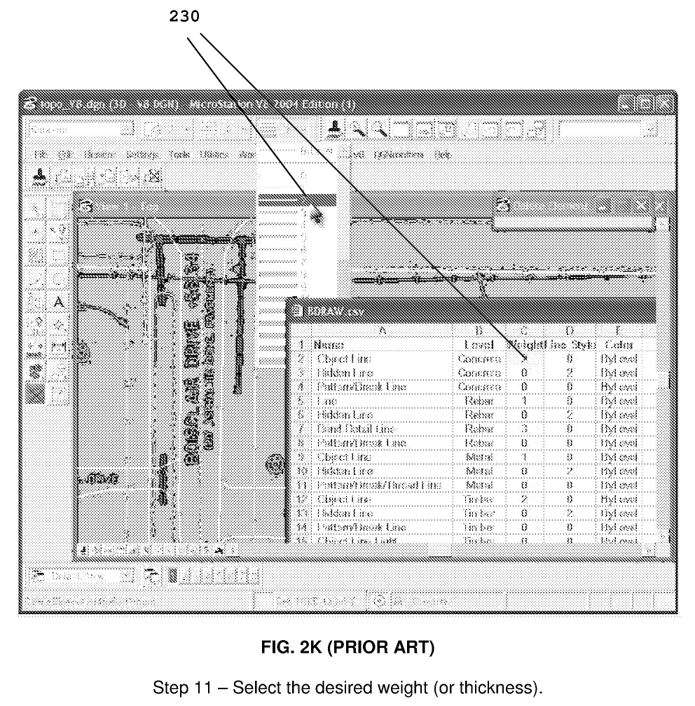

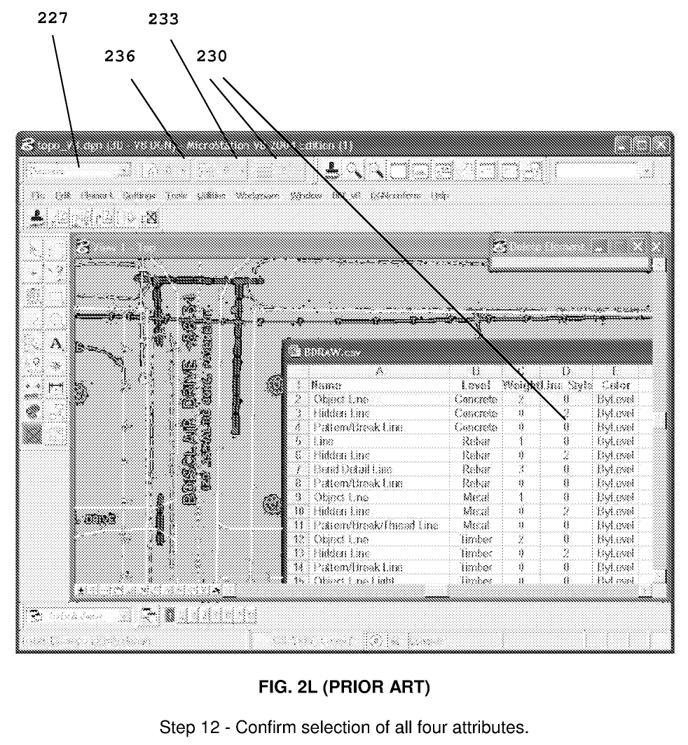

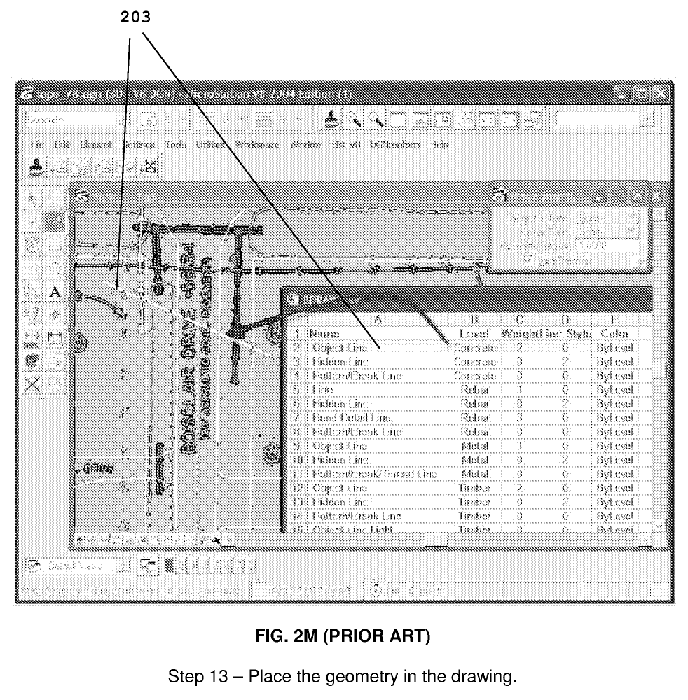

Referring now to a widely used manual method 100 in the art of placing an object 203 in a CADD drawing 200, FIGS. 2A-2M, inclusive, are screenshots showing a series of steps employed to place an object 203 in a MICROSTATION® brand CADD drawing 200 for a bridge construction project 104. The user utilizes an interface 206 presented on a computer screen from the CADD software application 209 used by the draftsman to produce the required drawing 200. The interface 206 comprises generally a title bar 212, one or more toolbars 215 to facilitate applicable software functions or manipulation of the drawing 200, a command bar 218 to access submenus of the application, and a window 221 for displaying the drawing 200. The visual appearance in the drawing 200 of the object line representing a concrete element 203 is determined by a standard 224. A standard may consist of one or more parameters. The standard 224 in this case consists of four specific parameters that would need to be set in the CADD application 209 before the geometry 203 could be placed in the drawing 200. These four parameters (more commonly known as ‘attributes’ to those skilled in the art) generally include (1) the level of the drawing 227, (2) the weight (or thickness) of the line 230, (3) the line style 233, and (4) the line color 236. To find the appropriate standard 224 in this example, the user would have a written manual 140 which would contain the standards compilation 136 and outline the attributes of every type of geometry 108 that could be placed in the drawing 200 for the client. As stated above, this manual 140 may have been produced from a unique set of standards 136 specific to a particular client, or from a set of standards 136 more widely available in the art, such as state or national standards. In order to set the standard 224 in the CADD drawing 200 of the example in FIG. 2, the user must search through pages 144 of the written manual 140 to find the standard 224 for the object 203 and then enter each attribute, 227 through 236, of the standard 224, manually into the CADD application 209 before placing the object 203 in the drawing 200.

Thus, in the existing manual method 100 shown in FIGS. 2A-2M, the user has been tasked to place geometry 203 in a CADD drawing 200 to define the edge of a concrete curb or sidewalk. Before the geometry 203 may be placed in the CADD drawing 200, the user must make certain that the CADD application 209 applies the correct standard 224 for each object to be placed. In FIG. 2A, the user first identifies the geometry 203 (in this case a ‘concrete object line’) to be placed in the drawing 200 from a set of approved items 239 comprising a compilation of standards 164. The concrete object line 203 is to define the edge of the concrete curb or sidewalk in the drawing 200. In the second step shown in FIG. 2B, the user selects a level access window 242 from a toolbar 215 and opens an application menu 245 showing all of the levels 227 available for the drawing 200. In FIG. 2C, the user slides the cursor down and selects the appropriate level name 248. In Step 4 shown in FIG. 2D, the user confirms that the appropriate level 248 has been chosen. In Step 5 shown in FIG. 2E, the user selects an attribute, for instance, “Color”, 236 by selecting the ‘color’ button 251 in the CADD software application 209 which will display a color palette 254, in this case 256 colors. In Step 6 shown in FIG. 2F, the user confirms that the appropriate color attribute 236 has been set in the application 209. Step 7 shown in FIG. 2G requires the user to set the next attribute, “Line Style”, 233 by selecting the ‘Line Style’ button 257 in the CADD software application 209 to display the various linestyles 260 available. In Step 8 shown in FIG. 2H the user selects the appropriate line style 233 and in step 9 of FIG. 2I confirms that the appropriate line style 233 was set for the drawing 200. Similarly, in steps 10 through 12 as shown in FIGS. 2J, 2K and 2L respectively, the user selects the Line Weight button 263 opens an application menu to display the available line weights 266, selects the appropriate line weight attribute 230 as defined by the relevant standards manual 140, and confirms that the appropriate weight 230 was set for the drawing 200. In addition, after setting the standard for the fourth attribute 230, the user confirms in step 12, shown in FIG. 2L, that all attributes, 227 to 236, have been set according to the standard in the manual 140. Once all the attributes are set for the object 203, the object 203 may be placed in the drawing 200 as shown in step 13 of FIG. 2M. The user must then repeat each step of this process 100 for each object 108 to be placed in a CADD drawing 180. Many other types of geometry 108 may be necessary to complete a drawing 180.

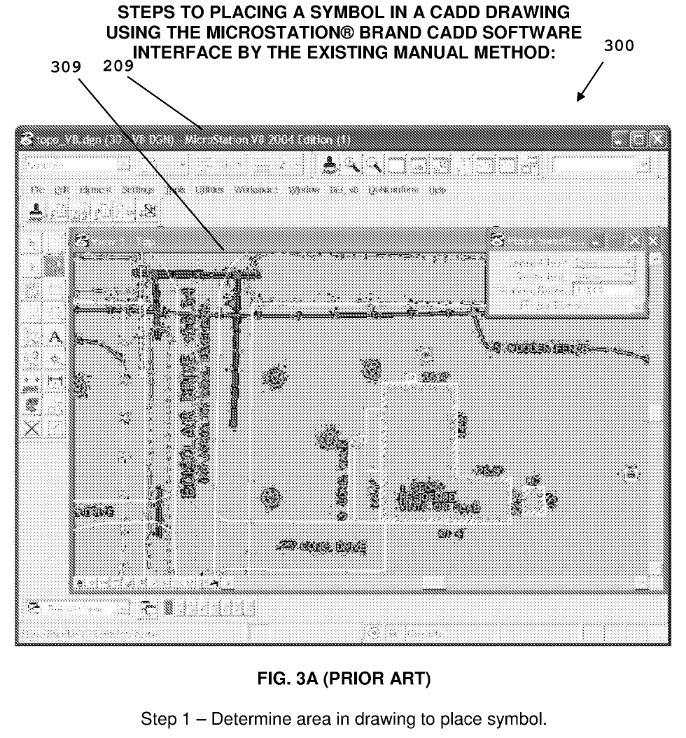

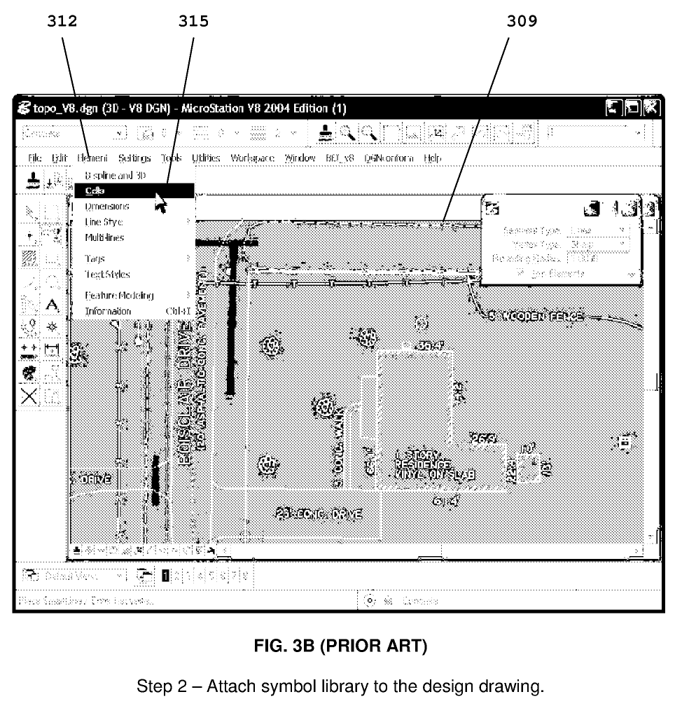

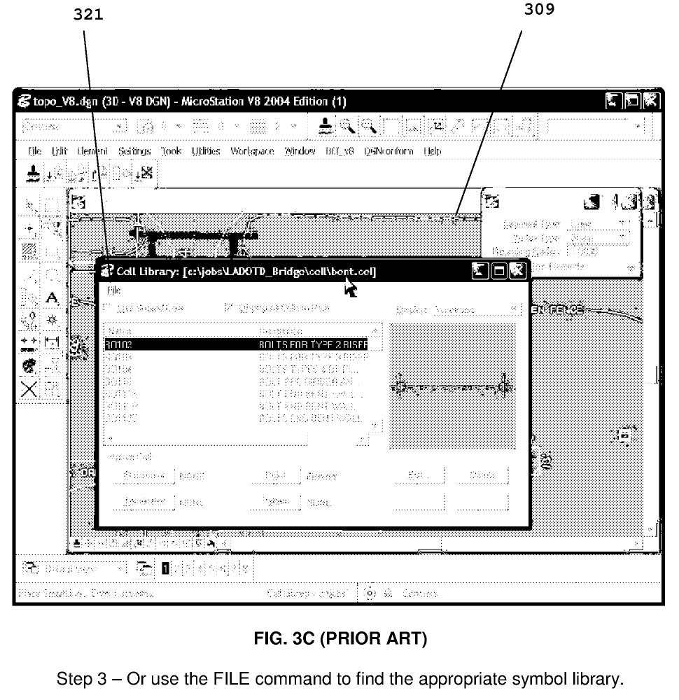

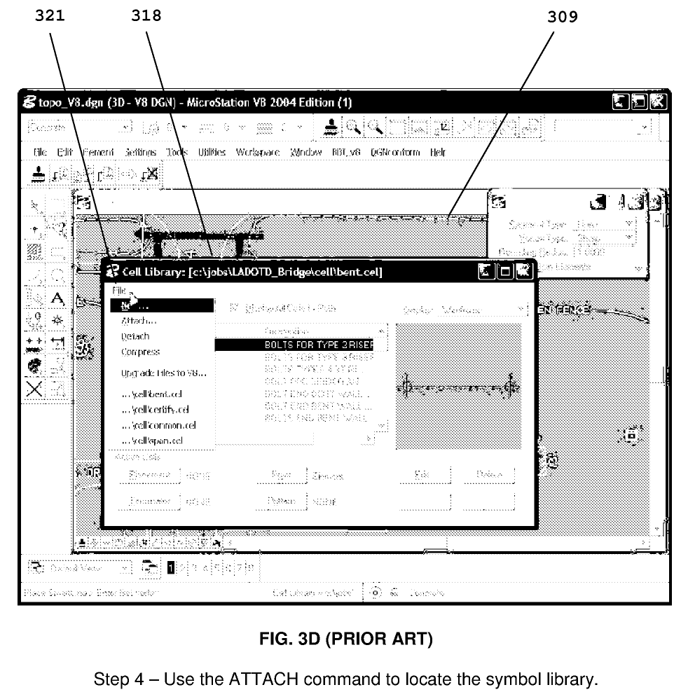

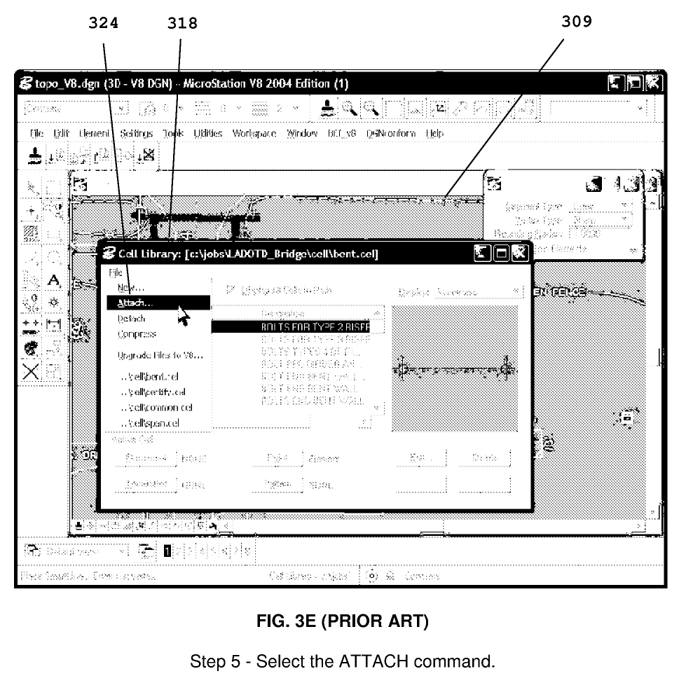

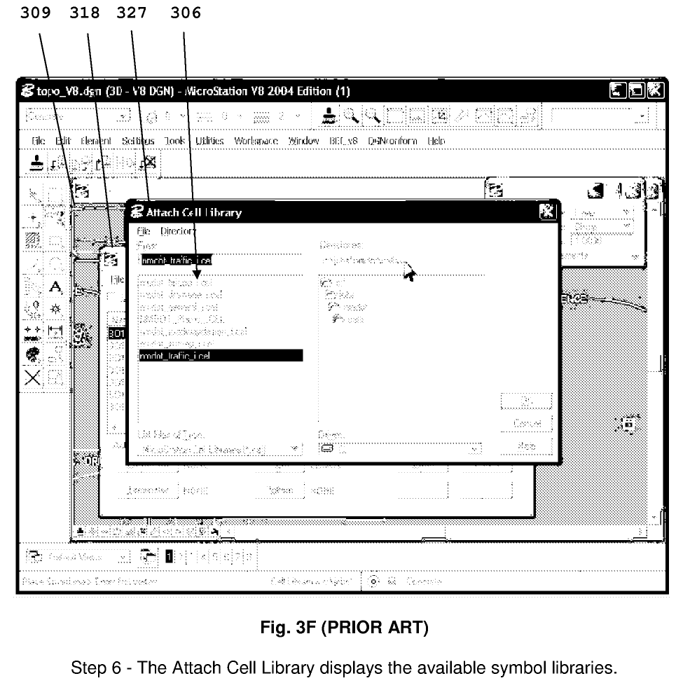

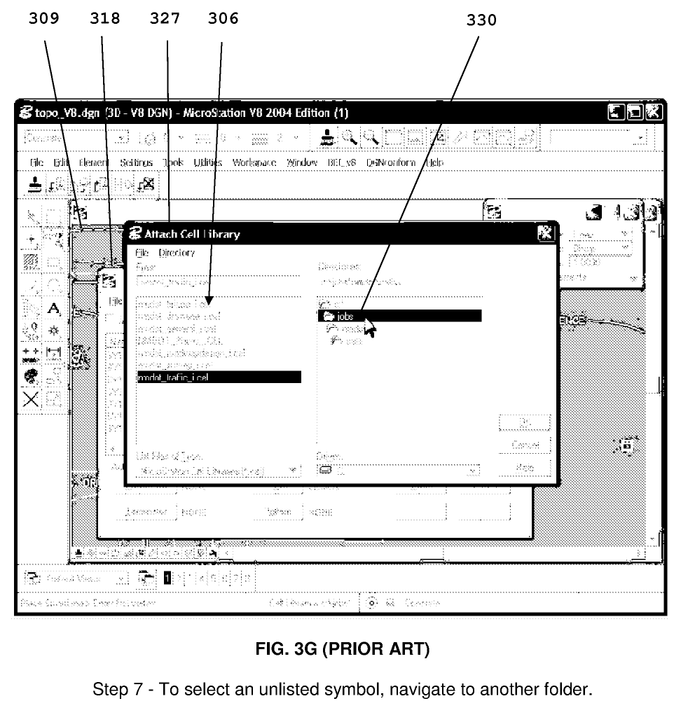

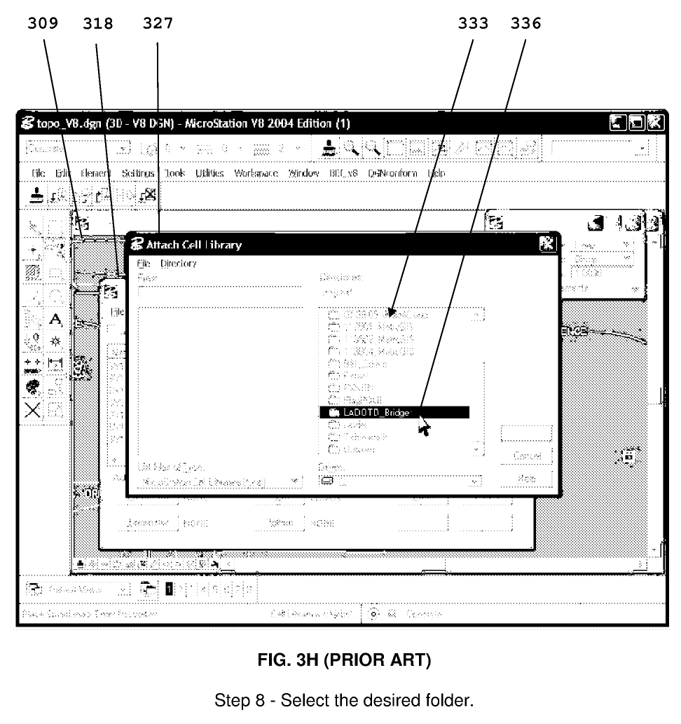

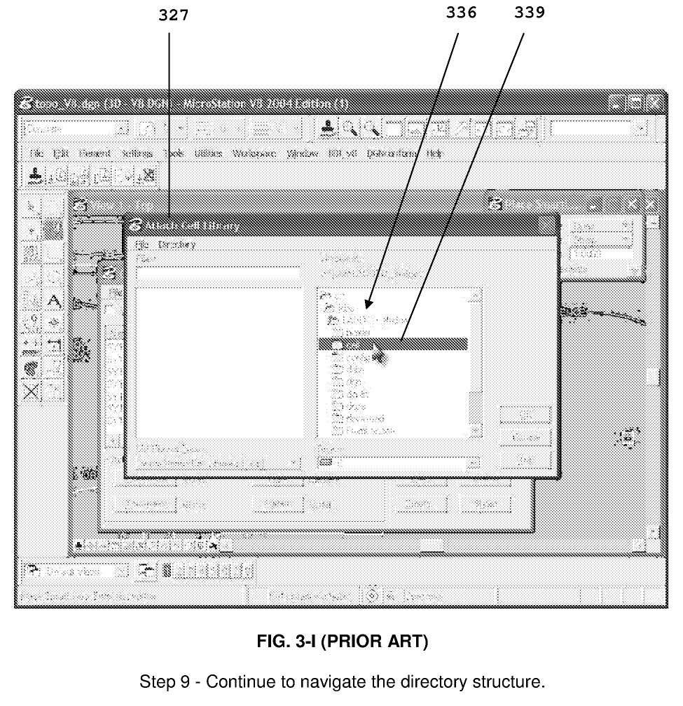

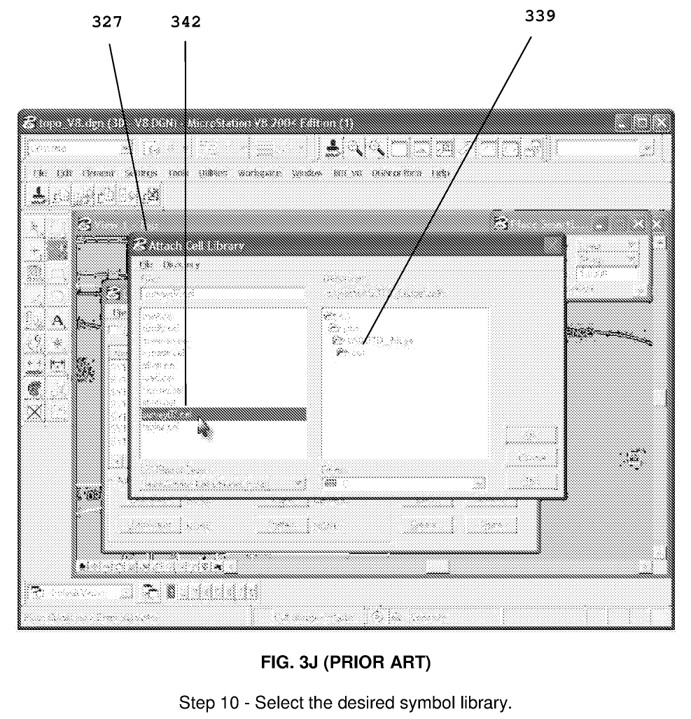

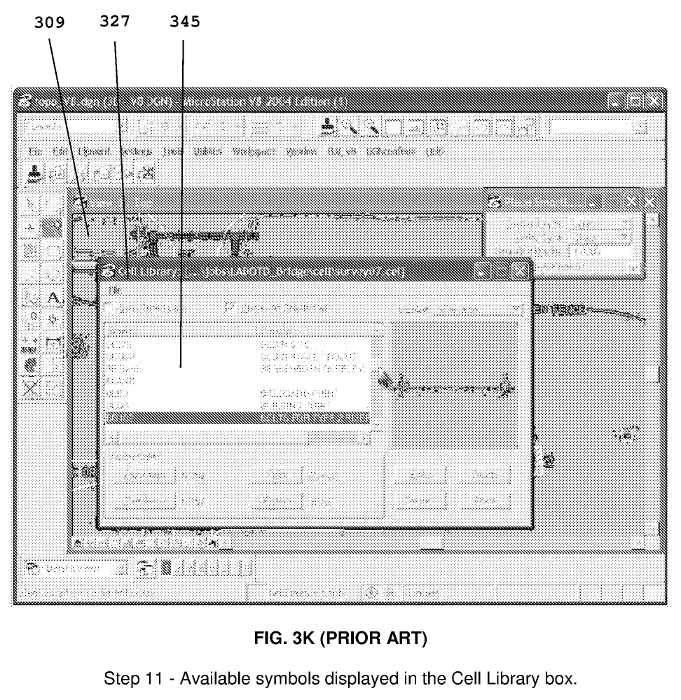

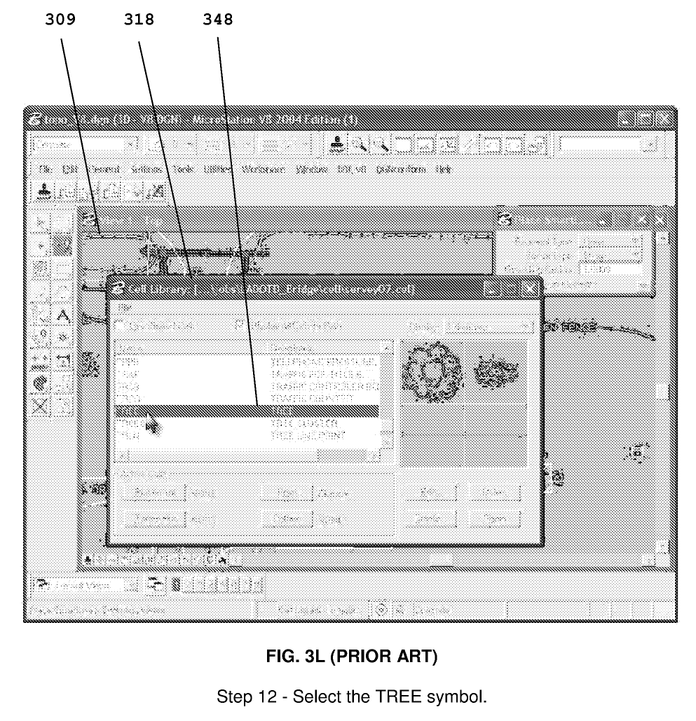

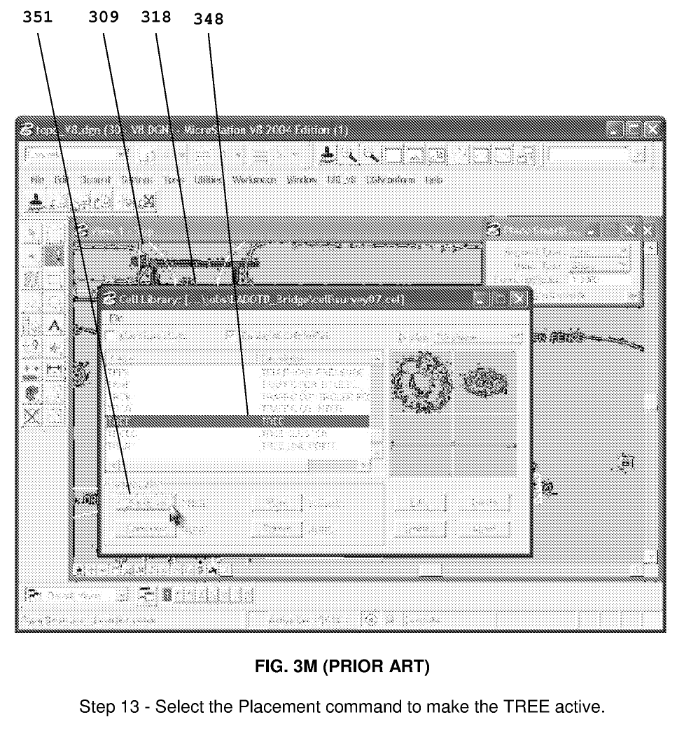

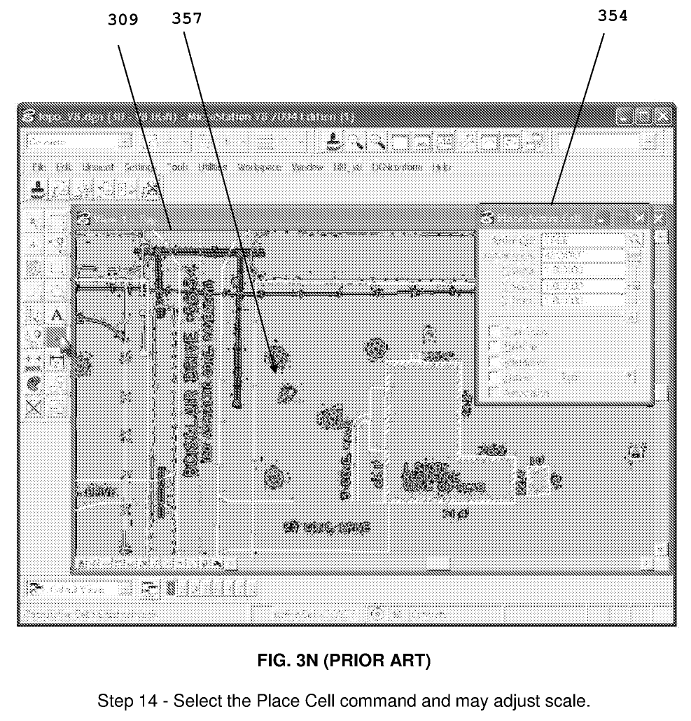

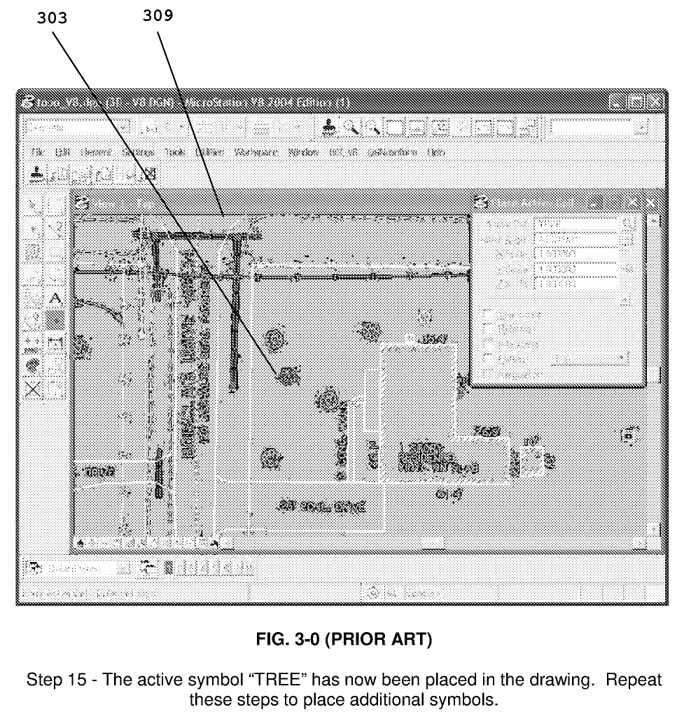

For example, in the existing manual method 100 illustrated in the fifteen (15) steps of FIGS. 3A-3O, are screenshots showing a series of steps the user has to follow to place a symbol 303 utilizing a MICROSTATION® brand CADD drawing interface 206, for placement of a landscaping material, in this example a tree in the CADD drawing 300. To complete the symbol 303 placement, the user selects the appropriate symbol library 342 that contains the required symbol 303, as shown in FIGS. 3F through 3L, steps 6 through 11 respectively. In step 12 the user selects the ‘tree’ symbol 303 from the library 342. In steps 13 through 15 respectively, as shown in FIGS. 3M through 3O, the tree object 303 is activated and placed in the drawing 300. Again, before the geometry 303 may be placed in the CADD drawing 300 the user must make certain that the CADD application 209 applies the correct set of symbols and standards 136 for each object 108 to be placed. In this example, the user must manually retrieve and input the correct symbols from a compilation 306 supplied by the client. In FIG. 3A, the user first identifies the area 309 of the CADD drawing 300 wherein the object 303 is to be placed. Next, In FIGS. 3B through 3E, steps 2 through 5 respectively, the user inputs or attaches the appropriate symbol library required by the client. This is accomplished in FIG. 3B by selecting the Element drop down menu 312 and selecting Cells 315. The Cell library 318 window opens revealing the available standards compilation 306 if they have already been input into the application 209. If the desired symbol library 306 is not input into the application 209, in FIG. 3C use the cursor to select the FILE command 321 to open a window to find the appropriate symbol library 306. In Fig. D navigate from the FILE command 321 to the ATTACH command 324, which is selected in Fig. E and opens an Attach Cell Library directory window 327 displaying available symbol libraries 306 in Fig. F. If the required symbol library is not located in the Attach Cell Library window 327 move the cursor to select a different folder 330. Upon selecting and opening folder 330 a new set of standards 333 is revealed and the desired standard folder 336 is selected in FIG. 3H. In FIG. 3I the directory structure is followed to locate the desired folder of standards 339 which is selected in FIG. 3J to reveal a library of symbols 342 in Cell Library window 345 in FIG. 3K. In FIG. 3L the TREE symbol 303 is selected with the cursor and made active in FIG. 3M by selection of the desired symbol 348 in the Cell Library window 318. Once the symbol 303 is activated 351 the user selects the Place Active Cell command 354 in FIG. 3N, moves the cursor into the placement area 309 to the symbol location 357 selected by the user for the symbol 303 and selects the location 357 in Fig. N to complete placement of the TREE symbol 303 in the placement area 309 in the drawing 300. The drawing is now ready for placement of additional objects, and to do so the user must repeat the steps above.

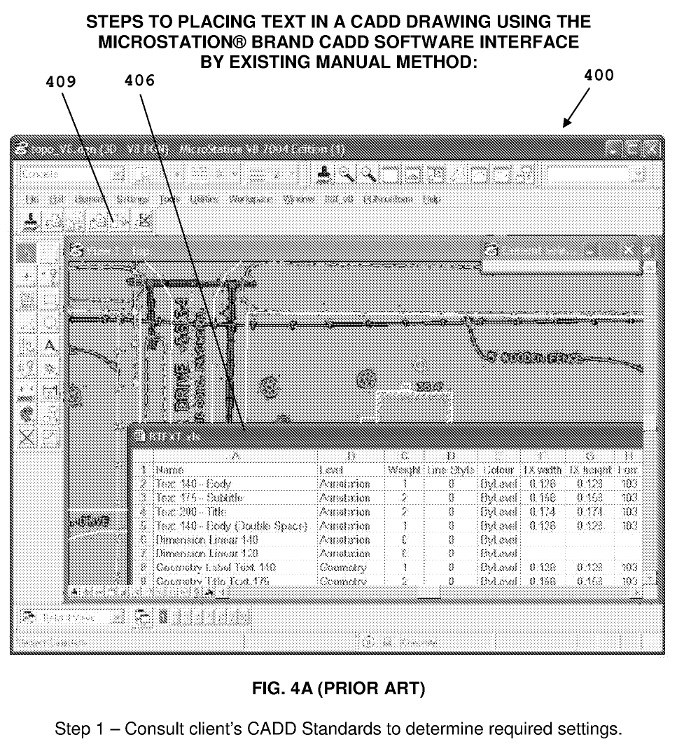

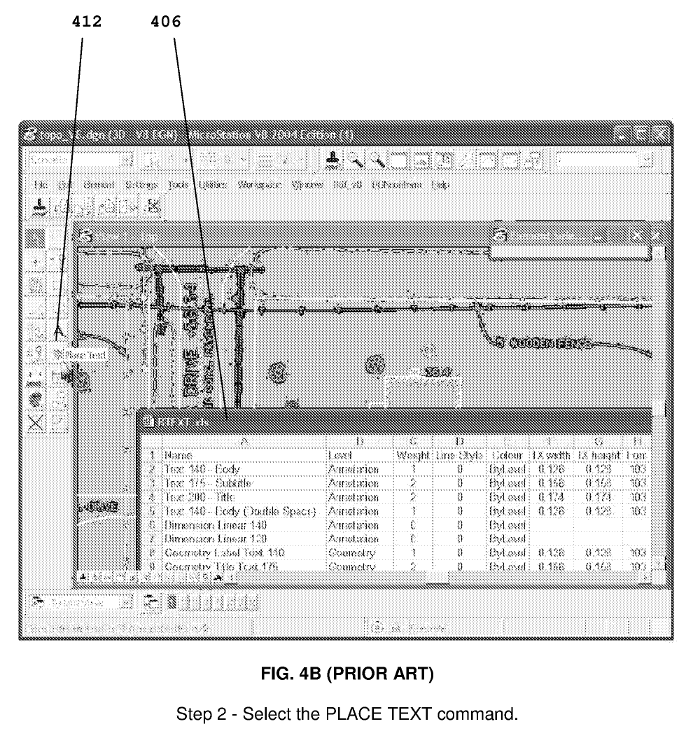

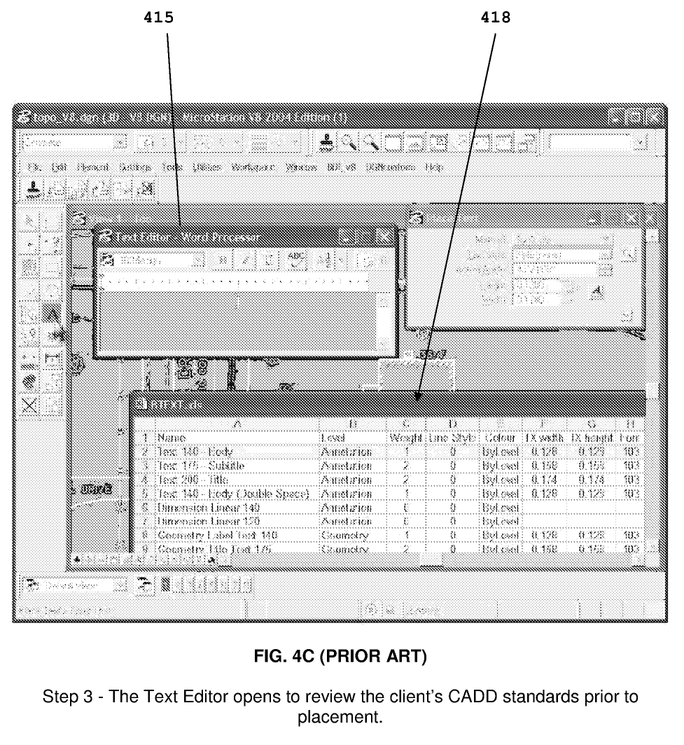

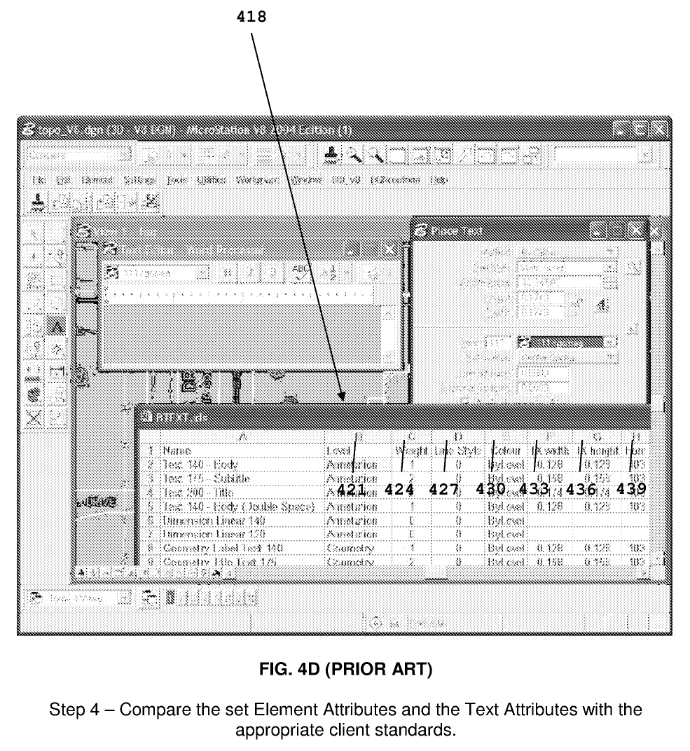

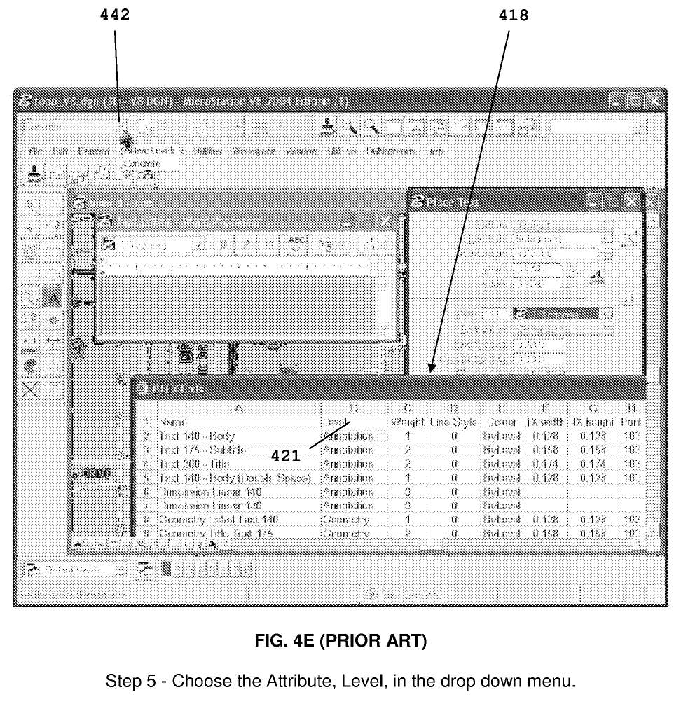

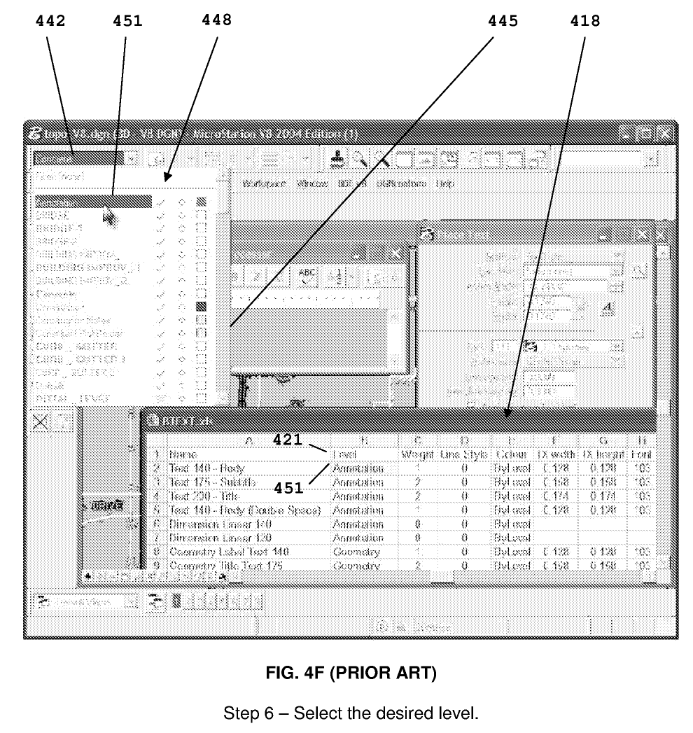

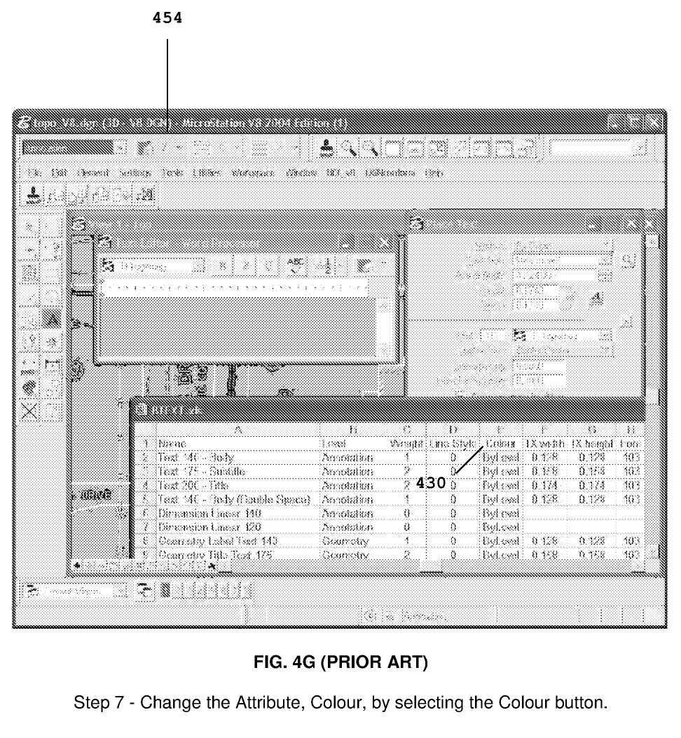

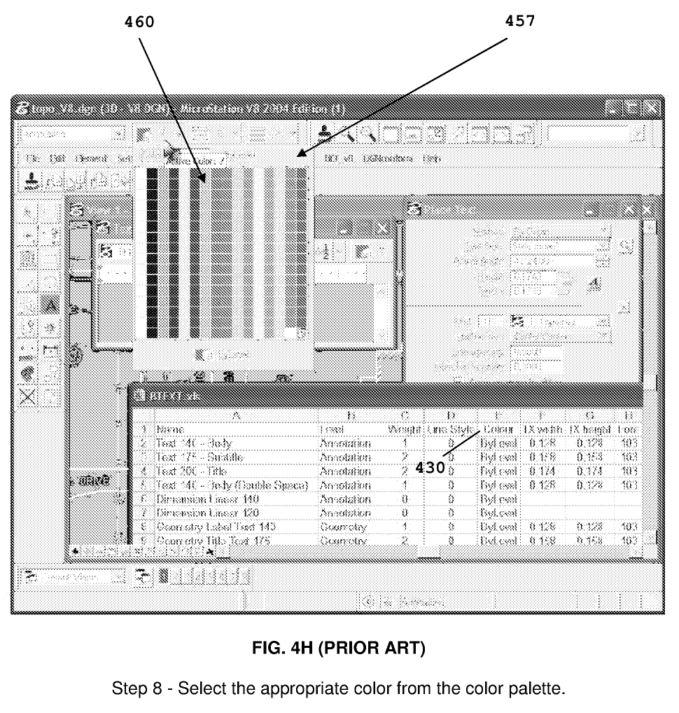

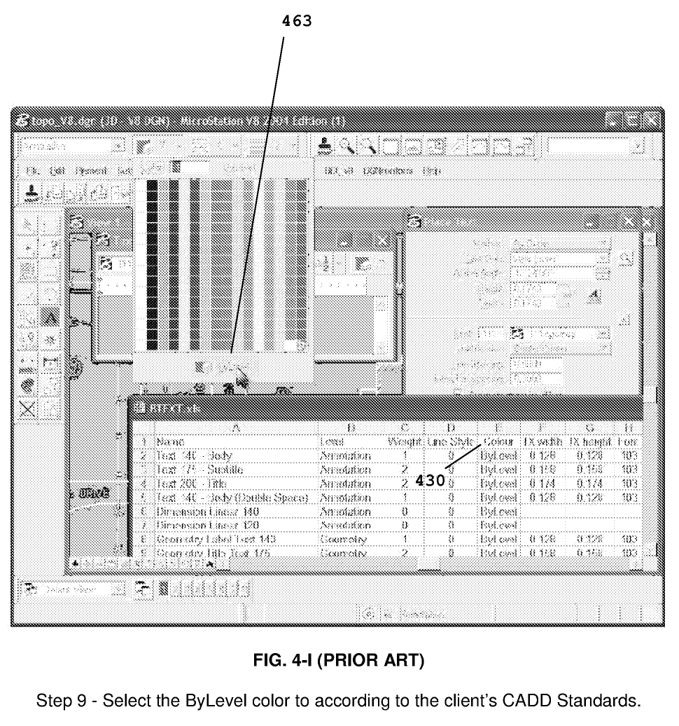

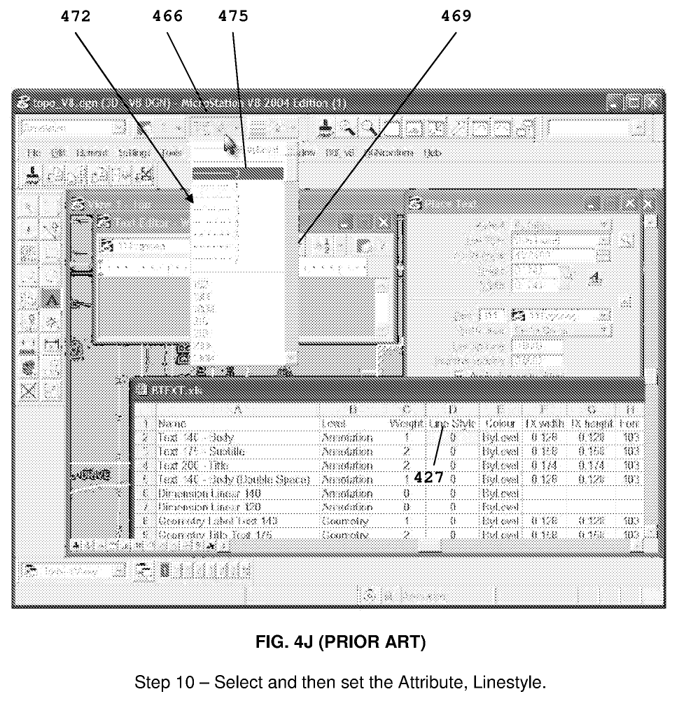

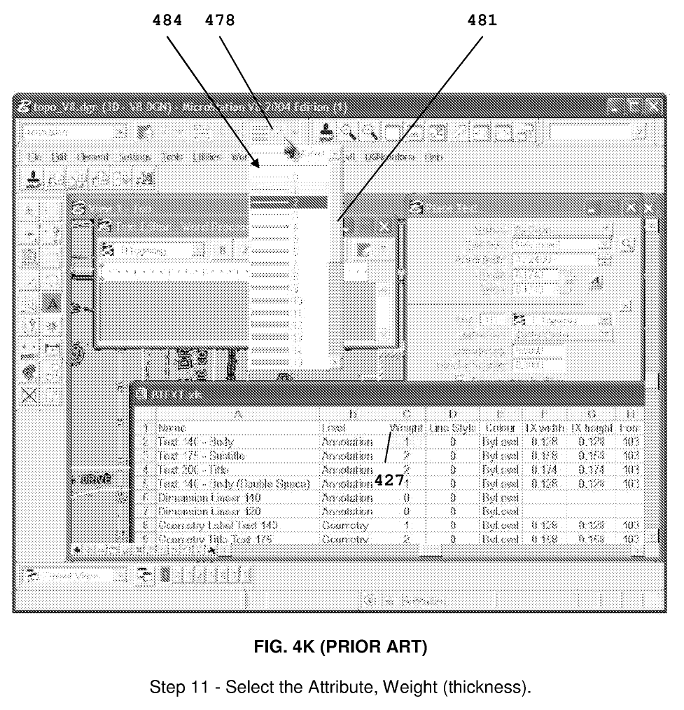

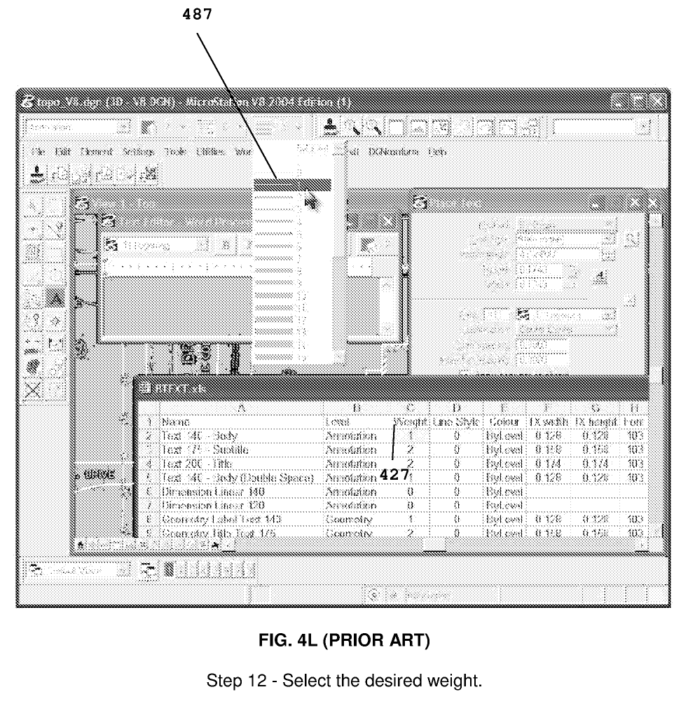

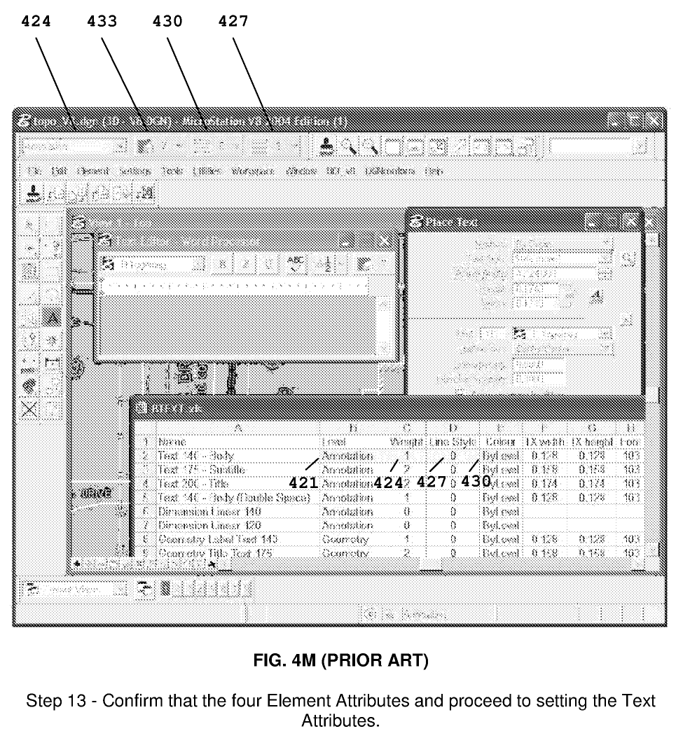

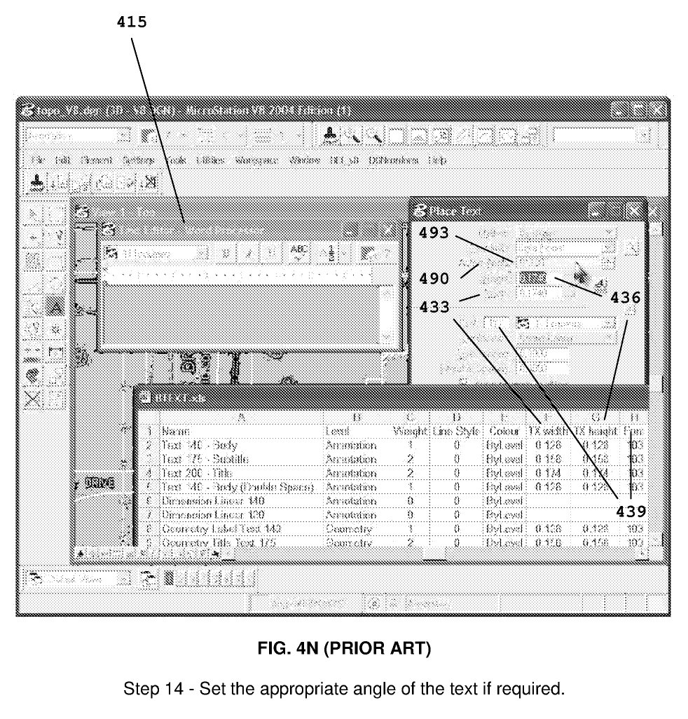

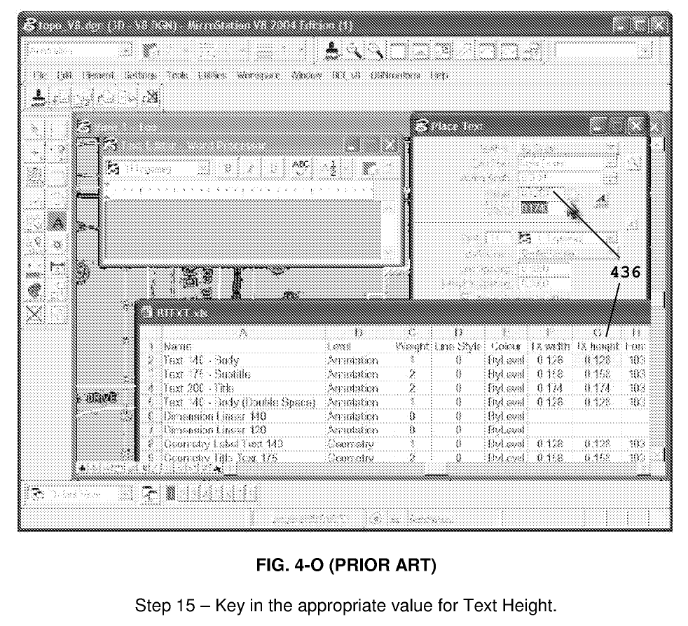

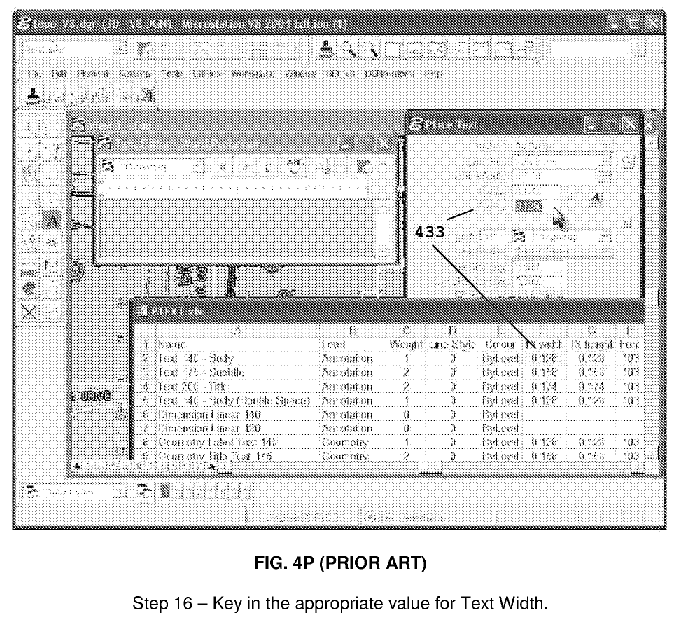

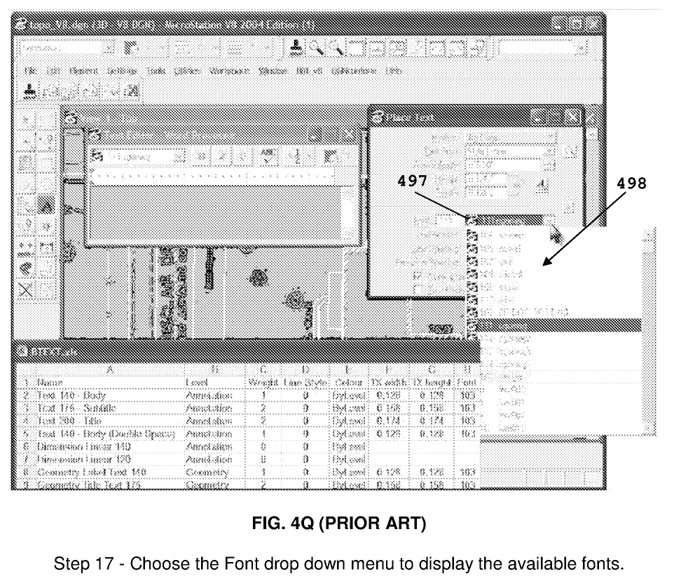

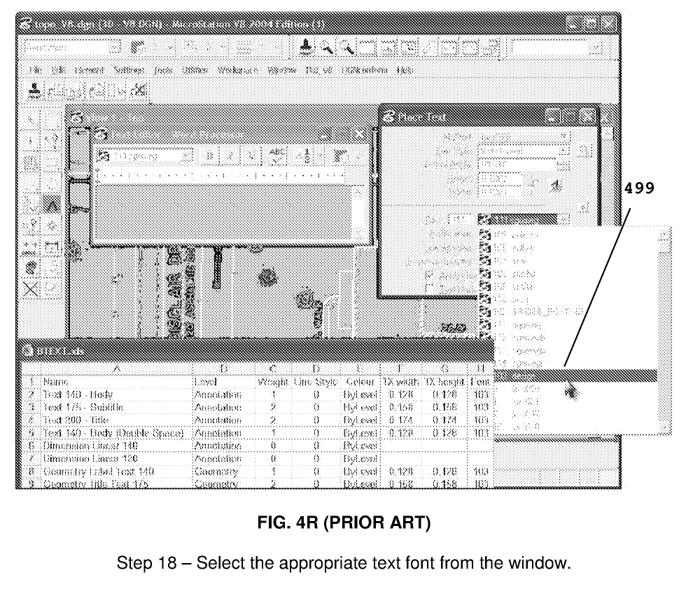

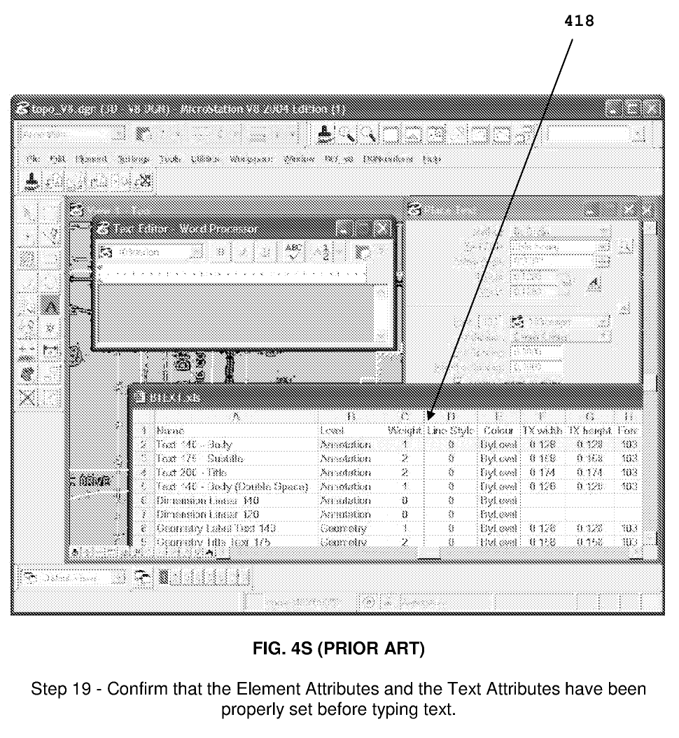

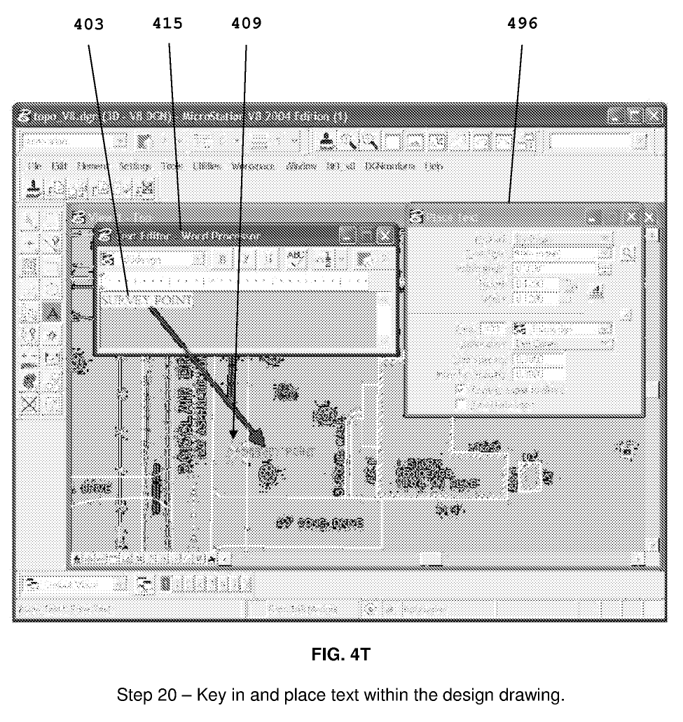

Another common element of a CADD drawing 400 is the placement of text 403. Before placing text 403 in a CADD drawing 400 using the existing manual method 100, as shown in the twenty (20) steps of FIGS. 4A through 4T, showing screenshots of a MICROSTATION® brand CADD drawing interface 206, the appropriate standards 406 for the specific client must be reviewed to determine the specific settings, as shown in step 1 and illustrated in FIG. 4A. To inspect the values for the text standards 406, in step 2 the user selects the text command 412, FIG. 4B, and opens the text editor 415 in step 3, FIG. 4C, to reveal the attributes 418. Before the text 403 can be placed in the drawing 400 in FIG. 4T, the element attributes of level 421, weight 424, line style 427, color 430 and the text attributes of width 433, height 436 and font 439 must be set as illustrated in steps 4 through 19 of FIGS. 4D through 4S respectively. In FIG. 4E, select the Level drop down menu 442 to open a window 445 in Fig. F comprising the various levels 448 available. Select the desired level 451. To change the color attribute 430, In FIG. 4G the Color button 454 in the CADD application 209 toolbar 215 is selected which opens a color palette 457 in FIG. 4H. The user selects the appropriate color 460 in the palette 457 and then the Bylevel command 463 to match the appropriate standard 430 as determined from the standards compilation 136. To change the Line Styles attribute 427 in FIG. 4J the user selects the Line Style button 466 in the CADD application 209 toolbar 215 to open a window 469 containing the available line styles 472. The user selects the appropriate line style 475 and then proceeds on to change the next attribute 418 in FIG. 4K. To change the Line Weight attribute 424 in FIG. 4K the user selects the Line Weight button 478 in the CADD application 209 toolbar 215 to open a window 481 containing the available line weights 484. In FIG. 4L the user selects the appropriate line weight 487 and then must confirm in FIG. 4M that the four element attributes for placing text, i.e., level 421, weight 424, line style 427, and color 430, have been set correctly from the client standards 138. Next the user must proceed to inspect and change the Text attributes of width 433, height 436 and font 439 in accord with the client standards 138. In FIG. 4N the user changes the Text angle 490 by selecting the Active Angle window 493 in the Place Text window 496 and enters the appropriate value according to the client standards 138. Similarly, the text height 436 and text width 433 are adjusted as necessary in FIGS. 4O and 4P. To adjust the text font 439, select the Font drop down menu 497 to display a list of the available fonts 498. The appropriate font 499 is selected in FIG. 4R. Now that all of the text attributes 418 have been entered the user must visually confirm in FIG. 4S that they conform with the appropriate standards of the client 138 before any text 403 may be entered into the drawing 400. In the final step in FIG. 4T, the user enters the appropriate text 403 the text editor 415, and then selects the drawing area 409 in the drawing 400 to enter the text 403. The drawing 400 is now ready for placement of additional text 403 as required, but the user must repeat the steps for each variation of the text 403 according to the client compilation of standards 138.

The method of the present invention substantially departs from the conventional concepts of the related art by providing single source, up-to-date CADD drawing standards, and any other additional information required by the client, via a network user interface application accessible from within a CADD drawing application 120. In a preferred embodiment of the present invention, applicable CADD standards are converted into an accessible digital form by compiling in a spreadsheet format, preferably with an .xls file extension. The digital CADD standards, or feature table, contained in the .xls file are then merged into a template file created and resident in the network user interface application. The template file then containing the CADD standards is used to display the standards for use in the network user interface application. The method of the present invention overcomes the limitations of the related art in that CADD standards are centrally controlled and accessible at one source via a network connection and may be automatically updated through command functions of the network application of the invention, or the CADD application.

Referring now to the method 500 of the present invention, FIG. 5 is a schematic diagram of an exemplary environment in which the method of a preferred embodiment of the invention may be used to input, process, retrieve and display a design drawing or data derived from the design drawing. A design drawing 504 is initiated in a CADD software application 505 resident on a single computer workstation 508, or a plurality of computer workstations 512. The computer workstations may be interconnected via a network 516 or otherwise connected to a network 520 to access the application pages of the standards control application 524 of the present invention resident on a remote server or other computer 528. Upon input of the appropriate standards from the internet application 524 into the design drawing 504 a completed drawing 536 may be provided by a printer 532, or data from the drawing may be extracted and compiled for analysis or further presentation 540 in support of a plurality of purposes and methods including but not limited to bid compilation, cost estimates, taxable assets, etc.

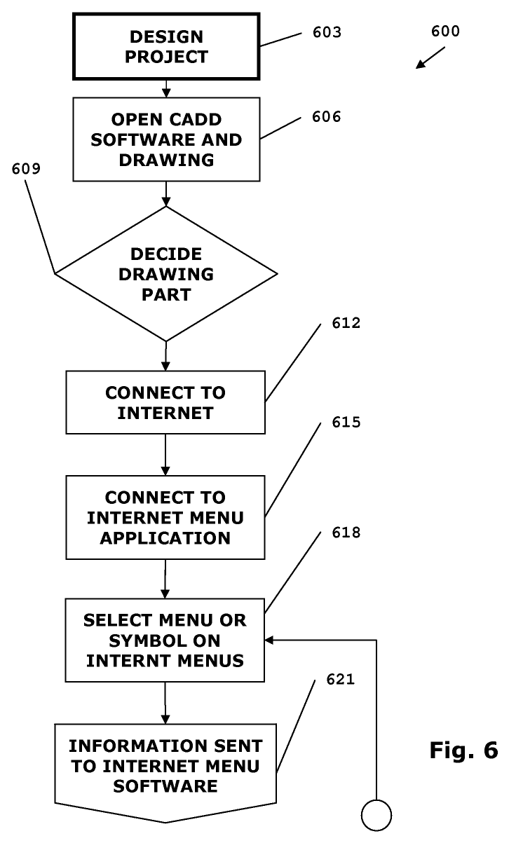

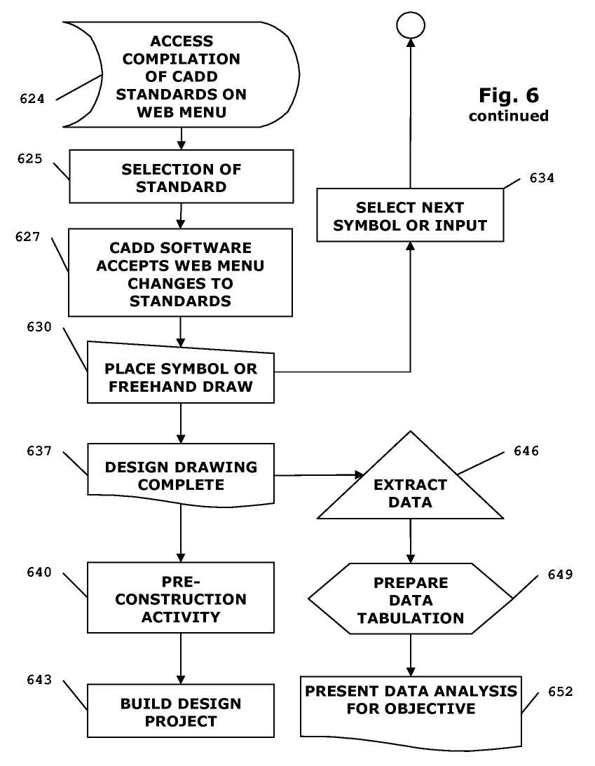

FIG. 6 is a flow diagram illustrating a preferred embodiment of the present invention wherein the preferred method of CADD standards management and quality control 600 is applied to a design project 603 that requires a drawing 637, or other two or three dimensional representation of geometry, via a CADD software application 606. The CADD application 606 is opened on the computer workstation and the relevant drawing file is accessed to display on the computer screen. To begin placing geometry in the drawing 637 the user first decides 609 what element or geometry to input. To access the standards relevant to the drawing the user connects to the network 612, navigates to the network user interface application 615 located on a remote server or other computer, and selects the relevant feature or symbol indicator of a client menu 618. Upon selection of the client menu 618 the information is sent to the network application software of the present invention 621 to access the client's compilation of standards 624. Upon making a selection 625, the information is electronically sent to the CADD software on the computer workstation which accepts the instructions from the standards 627 which commands the software to place the symbol 630 and the appropriate standard is displayed in the drawing 637. These steps are repeated for every symbol or other input 634. Once the CADD design drawing 637 is complete, a paper or other representation of the design may be produced to facilitate construction activity 640 to build the project 643.

In addition, the CADD standards management and quality control method of the present invention permits attachment of various types of data to the geometry, including but not limited to attributes, cost, value, and geographical location by satellite coordinates. Thus, when the geometry is imported by the network application method of the present invention into the drawing 637 resident in the CADD software application, all attributes assigned to that geometry are simultaneously imported into the CADD application drawing file. This permits extraction and analysis of data 646 to prepare data tabulations 649 in support of a plurality of objectives relevant to the design project including but not limited to project bidding estimates, loan valuations, asset valuations, tax valuations, geographical locations of geometry, and other types of analysis or objectives.

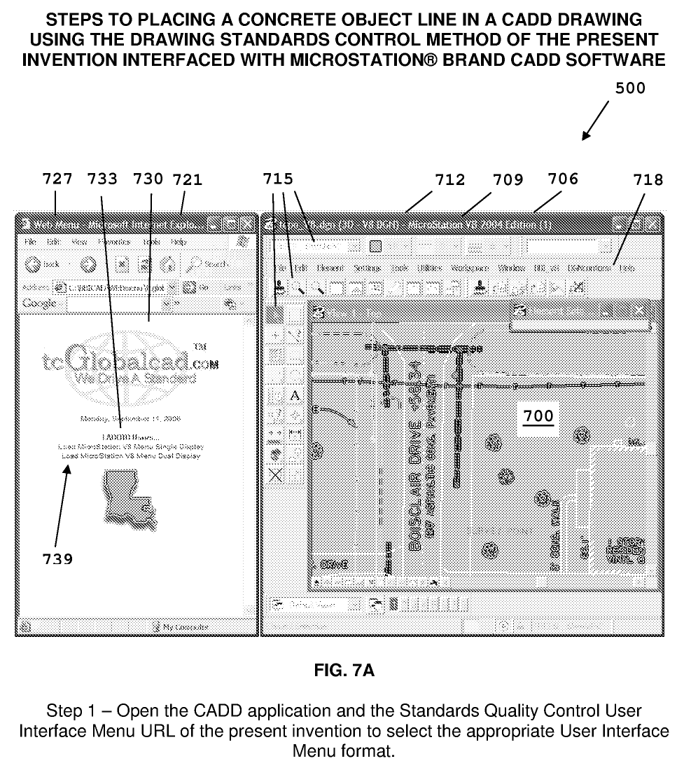

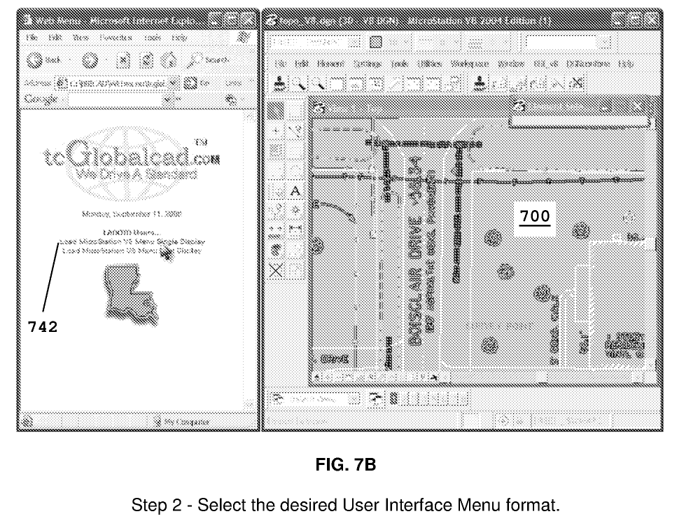

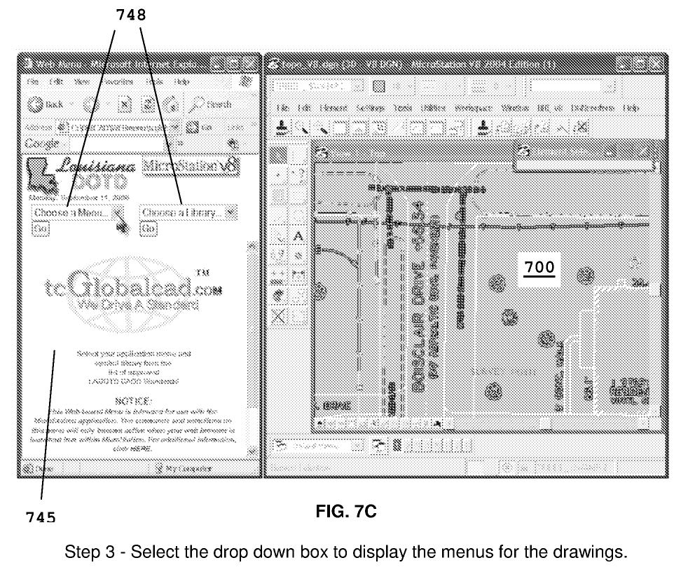

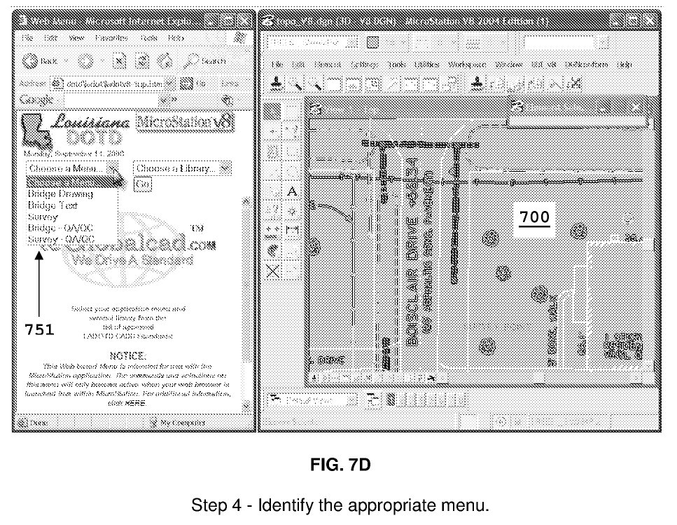

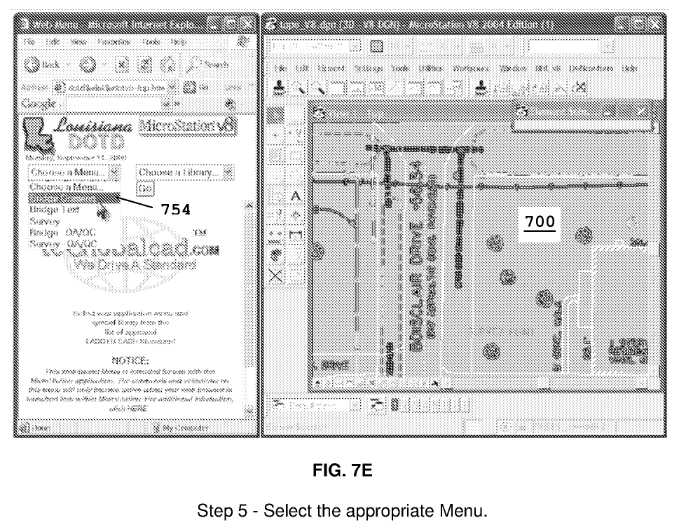

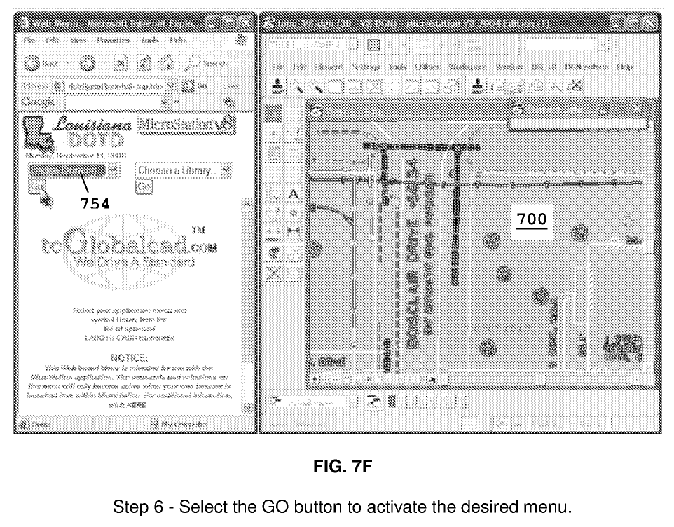

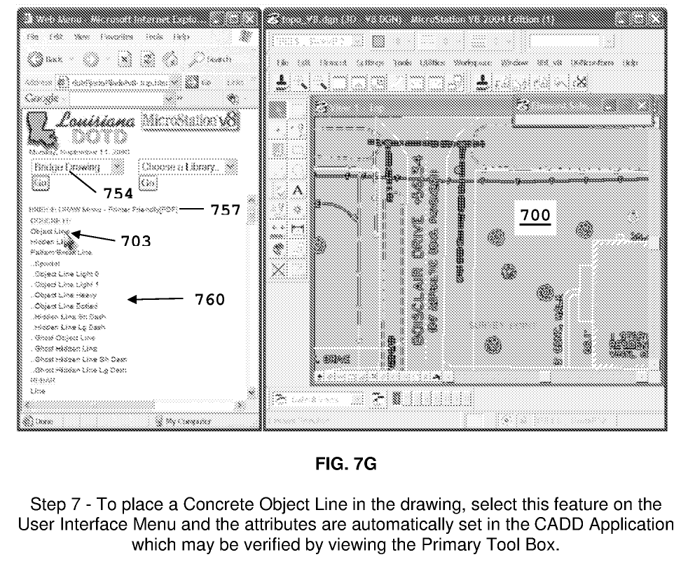

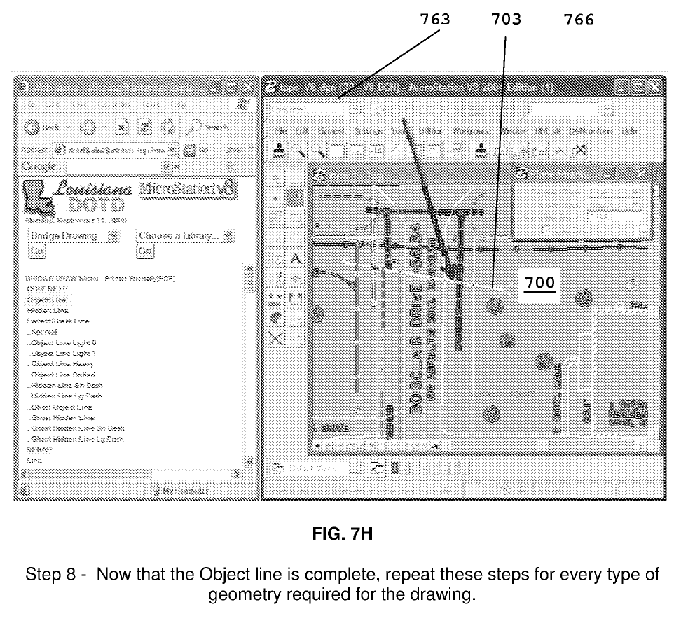

Referring now to a preferred embodiment of the present invention 500 of CADD standards management and quality control methods of the present invention, FIGS. 7A through 7H demonstrate the creation of an object 703 in a drawing 700 utilizing a compilation of CADD standards 739 accessed via a network 520. In a preferred embodiment, the CADD application software interface is MICROSTATION® brand CADD drawing software application 709 supplied by Bentley Systems, Inc., of Exton, Pa. In FIG. 7A the user first opens the CADD application 709, develops a connection to the internet 520 and opens an internet access application 721. In the internet access application 721 the user enters the appropriate URL (universal resource locator) address 724 to connect to the internet server 528 containing the standards management and quality control application 727 of the present invention. This opens the network user interface feature table in the application 730 of the standards management and quality control application 727 of the present invention associated with the client or project 733 comprising the relevant compilation of CADD standards 736, known in the art as geometry or symbology. The standards 736 may be provided in a plurality of formats 739 as required by the client or project. In a preferred embodiment, the network server based standards management and quality control application 727 and the user interface application 730 are supplied by Texas Computer Graphics, Inc. For ease of use on the screen of the computer workstation 508 or 512 the user may adjust the size and location of the CADD application software interface 706 and the network user interface application 721 so that they appear side-by-side as shown in FIG. 7. In FIG. 7B the user selects the appropriate CADD application format 742 from the network page menu application 730 of the standards management and quality control application 727 associated with the client or project 733 comprising the relevant compilation, or feature table, of CADD standards 736. Upon selection of the appropriate format 742 a page 745 opens making available one or more selection or drop-down boxes or windows 748. In steps 3 through 6 of FIGS. 7C through 7F, respectively, the user selects a selection or drop down box 748 on the network page 745 to display the available selection menus 751 for the plurality of disciplined drawings associated with the client project 733. The user then selects the relevant drawing 754 and activates the menu 757 to display a list 760 of geometry available to place in the drawing 700. To place an object 703 in the CADD drawing 700 in step 7, as shown in FIG. 7G, the user first selects the object 703 on the list 760. The object attributes (including but not limited to level, color, weight, & line style) have been previously entered into the standards quality control network application feature table 736 and comprise the standard for the object 703 according to the requirements of the client. By selecting the desired object 703 from the list 760, the object attributes, and therefore the object standard, are automatically set before the object 703 is included in the CADD drawing 700. In the method of the present invention the attributes do not require any input or maintenance from the user. The user may verify that the appropriate attributes have been set by viewing the Primary Tool Box 763 in the CADD application 709. To place the selected object 703 in the CADD drawing 700, as shown in FIG. 7H, the user selects the appropriate command 766 (such as ‘place line’) and places the selected geometry 703 in the drawing 700. These steps are repeated for every type of object 703 or feature which needs to be added to the CADD drawing.

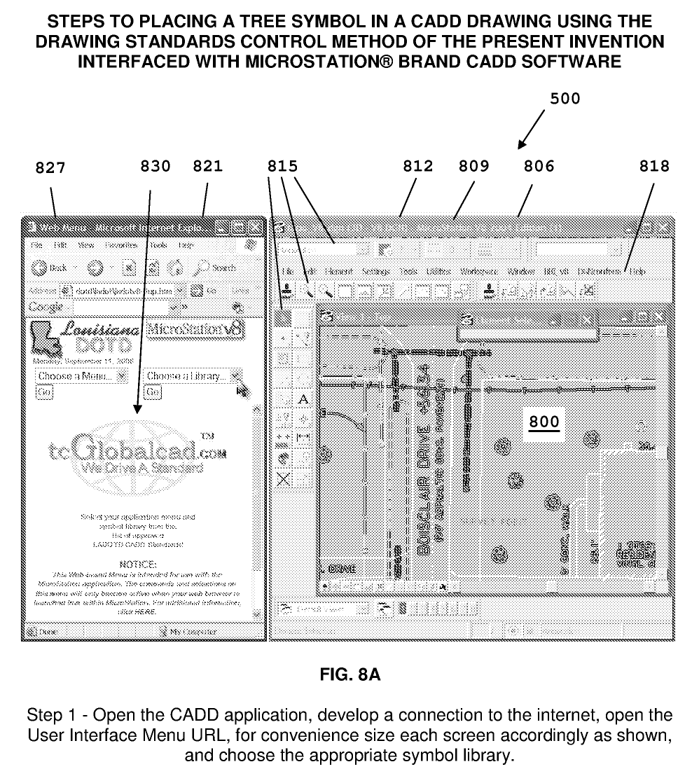

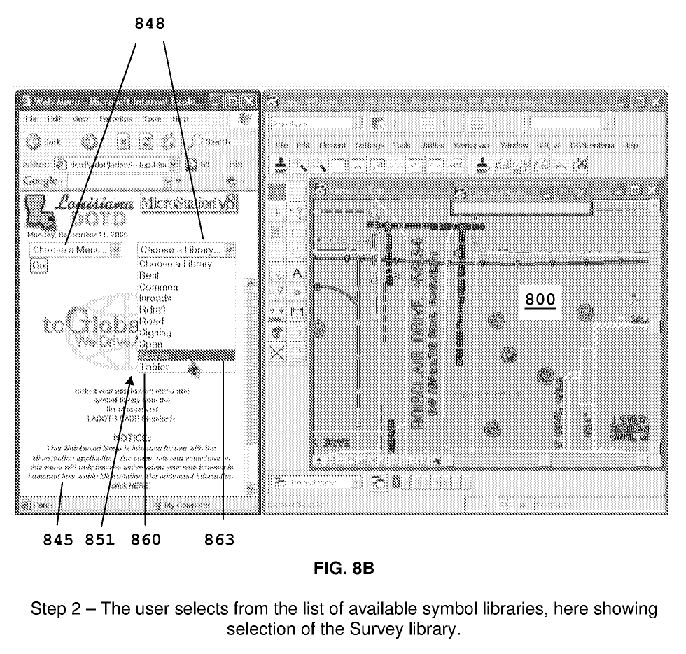

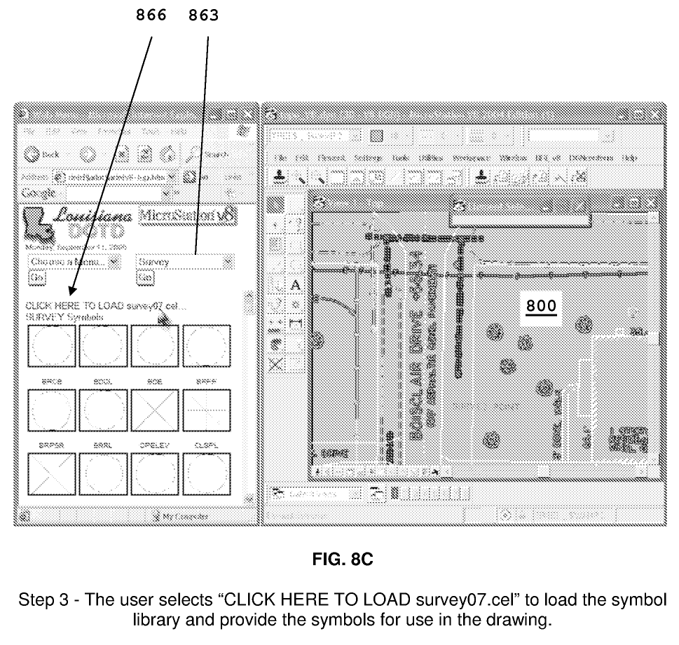

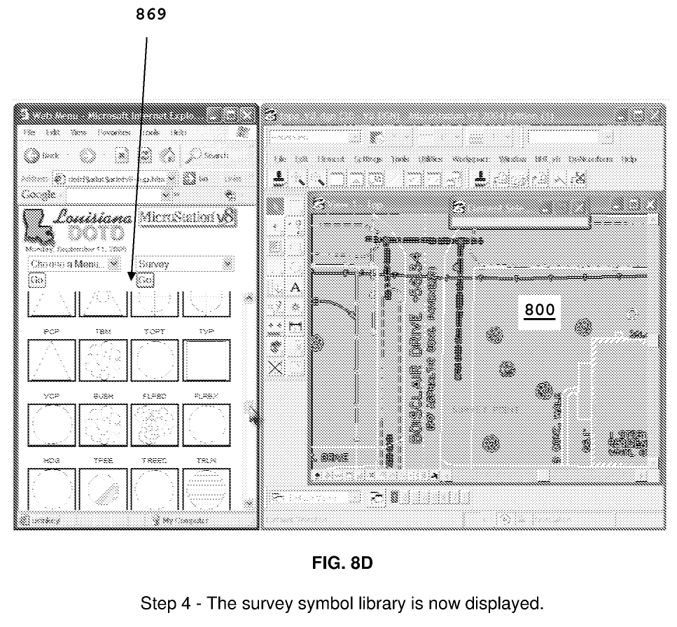

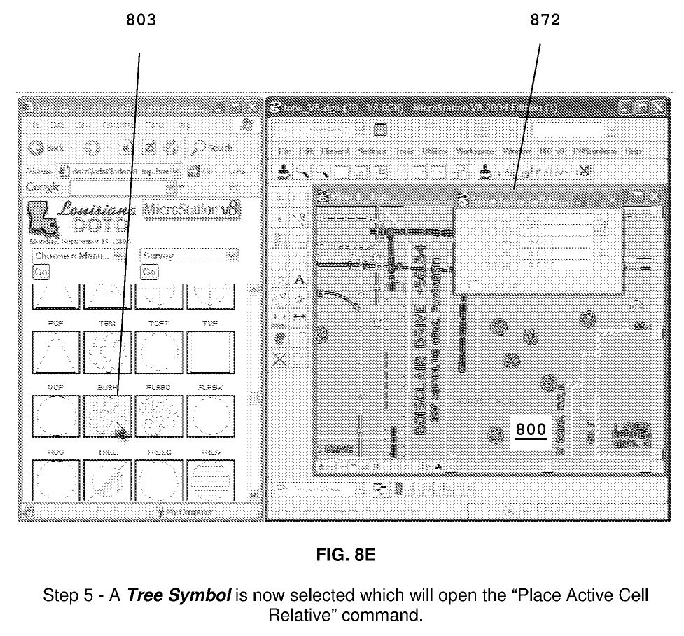

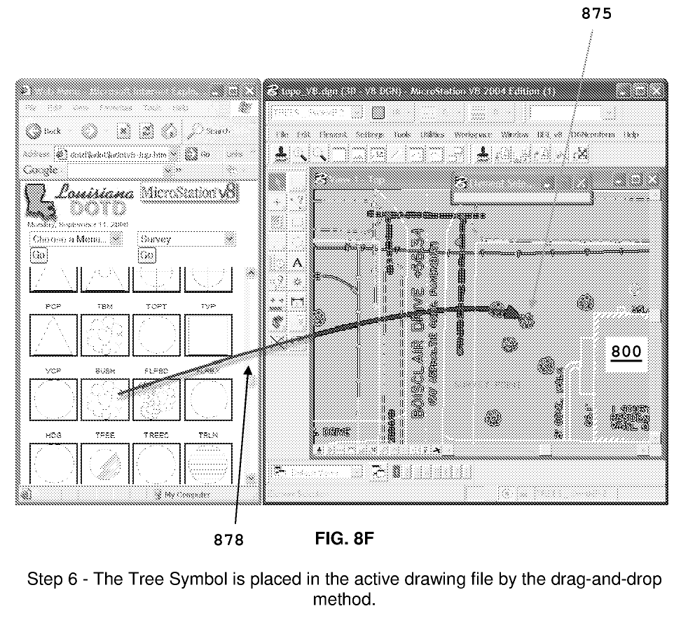

Additional types of geometry may be added to a CADD drawing by the method of the present invention. A preferred embodiment of the present invention, as shown in FIGS. 8A through 8F, demonstrates placing or creating a symbol 803 in a CADD drawing 800 utilizing a compilation of CADD standards 836 accessed via the internet or other network 520. In a preferred embodiment, the CADD application software 809 is MICROSTATION® supplied by Bentley Systems, Inc., of Exton, Pa., and the Network server based standards quality control application 827 and the network page menu application 830 are supplied by Texas Computer Graphics, The steps for accessing the symbol library 860 are as illustrated above in FIGS. 7A through 7G incorporated herein by reference. In FIG. 8B, the user reviews the list of available symbol libraries 860 and selects the relevant library 863. In FIG. 8B the user selects the survey library 863. In FIG. 8C the user displays the survey symbol library 863 in the network based application 830 and then activates the library to make the symbols accessible for selection. FIG. 8D displays the symbols 869 of the survey library so that all of the symbols in the library 863 will be available for use in the CADD drawing 800. Finally, the desired symbol 803 is selected from the library 863 in FIG. 8E which activates a place cell command 872, and the symbol is inserted in the desired location 875 in the drawing 800 in FIG. 8F by the drag-and-drop method or point-and-click method 878. The object attributes (i.e. color, weight, linestyle & shape) have been previously entered into the standards management and quality control network user interface application 830 and comprise the standard 836 for the object 803 according to the requirements of the client 833. By selecting the desired object 803 from the library 863, the appropriate attributes, and therefore the object standard 836, are automatically set without any input from the user before the object 803 is included in the CADD drawing 800.

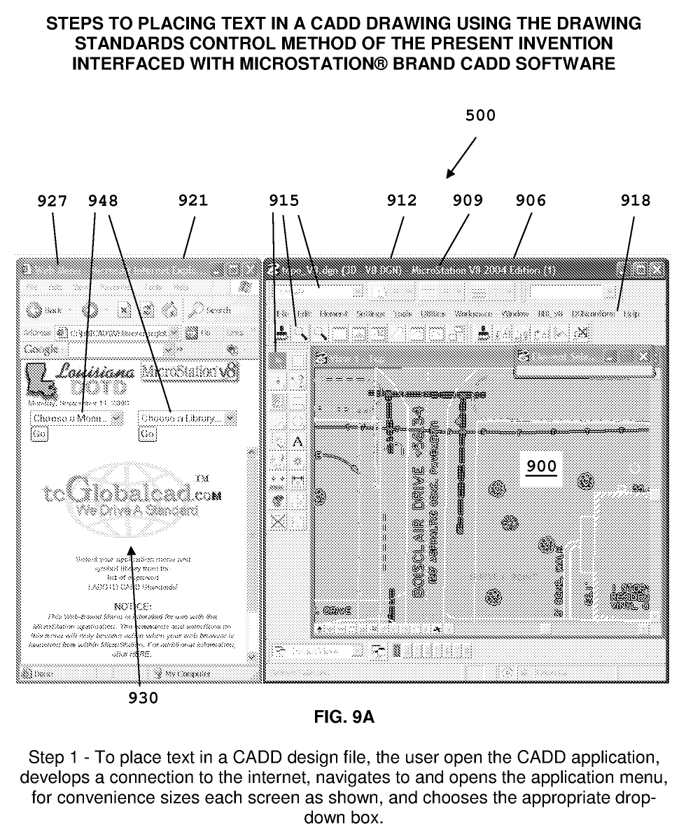

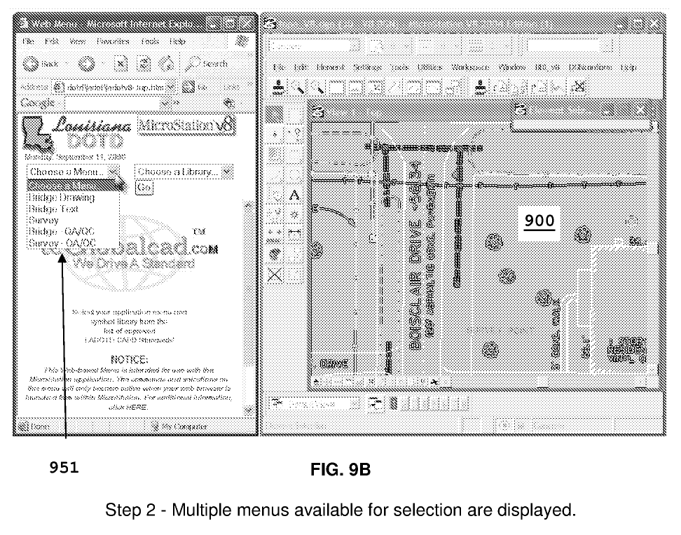

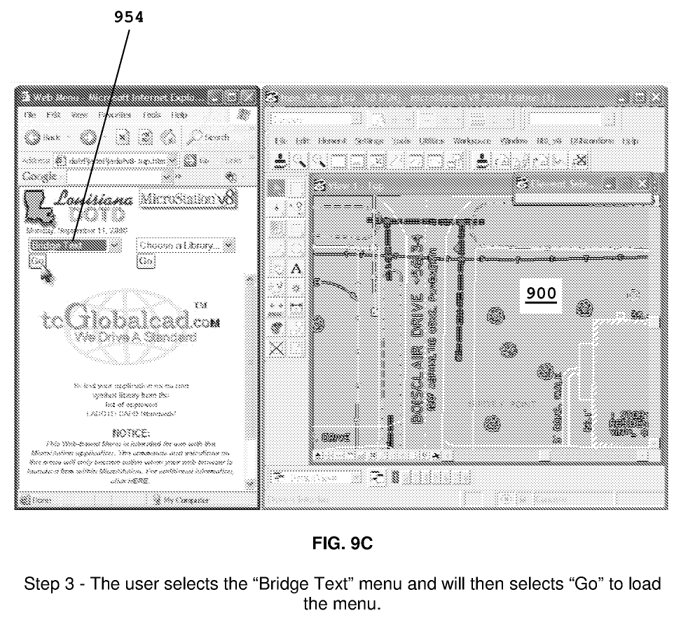

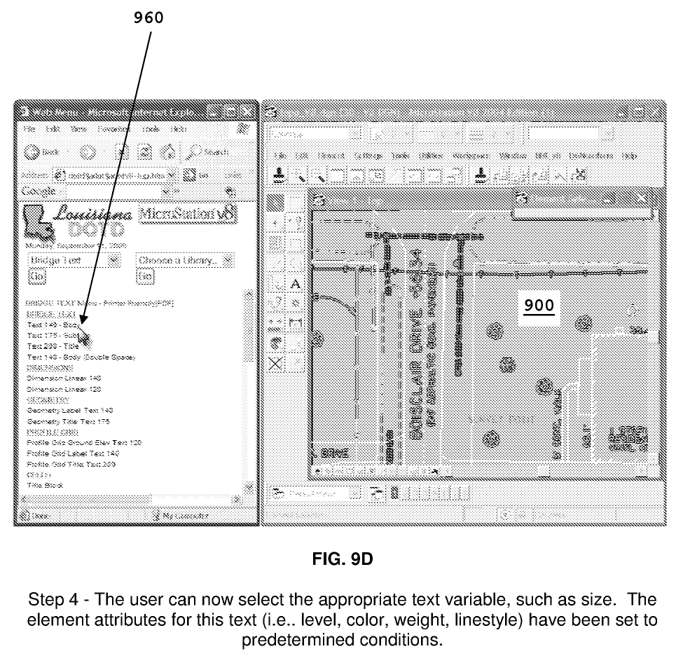

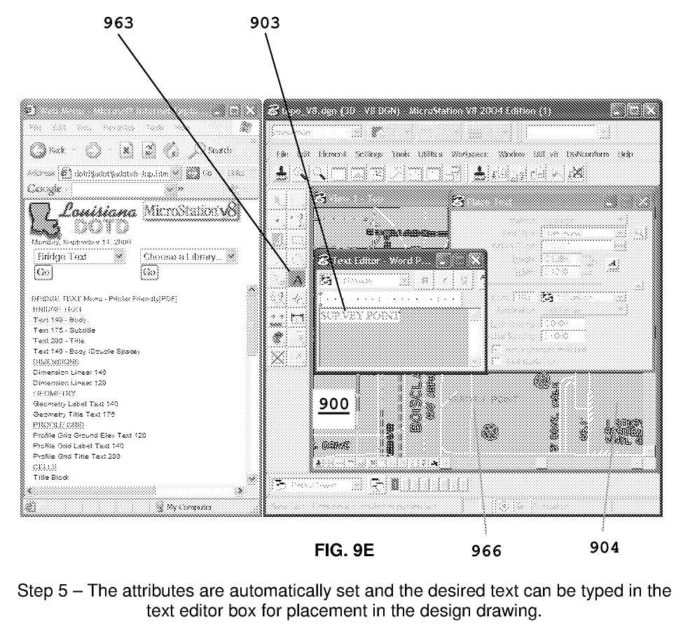

Text may also be added to a CADD drawing by the method of the present invention. A preferred embodiment of the present invention, as shown in FIGS. 9A through 9E, demonstrates placing or creating text 903 in a CADD drawing 900 utilizing a compilation of CADD standards 936 accessed via the internet or other network 520. In a preferred embodiment, the CADD application software 909 is MICROSTATION® supplied by Bentley Systems, Inc., of Exton, Pa., and the Network server based standards quality control application 927 and the network page menu application 930 are supplied by Texas Computer Graphics. The steps for adding text 903 to the drawing design file 900 are as illustrated above in FIGS. 7A through 7G incorporated herein by reference. In FIGS. 9B and 9C, the user has opened a window comprising the available menus 951 for selection. To place text on the bridge drawing 900, the user selects Bridge text 954. In FIG. 9D the available text attributes 960 are displayed for selection by the user. The element attributes for the text (i.e. level, color, weight & linestyle) have been previously entered into the standards quality control network page application 930 and comprise the standards 936 for the text 903 according to the requirements of the client 833. In an alternative embodiment, the text attributes may also be predefined according to the requirements of the client 933. Finally, once the attributes are set by the user, the desired text 903 is entered into a window xxx in FIG. 8E which activates a place text command 963, and the text 903 is inserted by the user in the desired location 966 in the drawing 900. By selecting and setting the desired text attributes 960 for the text 903, the complete text attributes, and therefore the text standards 936, are automatically set before the text 903 is included in the CADD drawing 900.

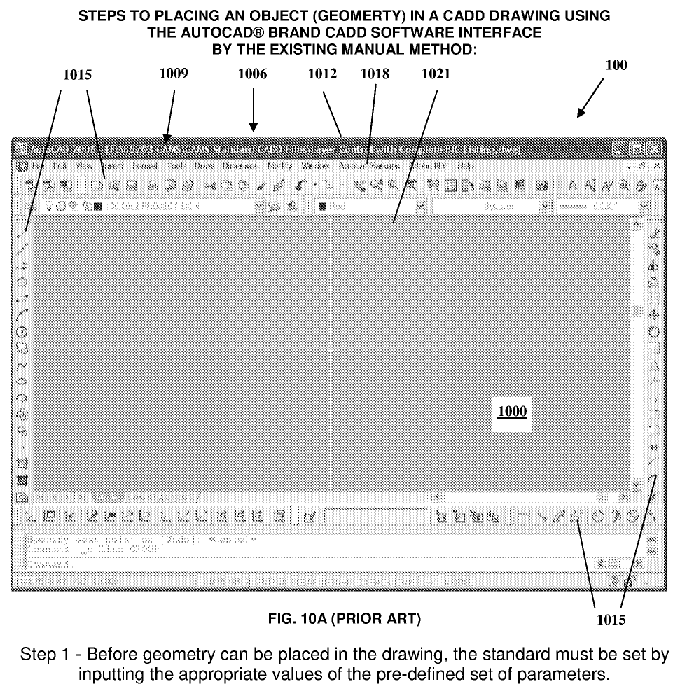

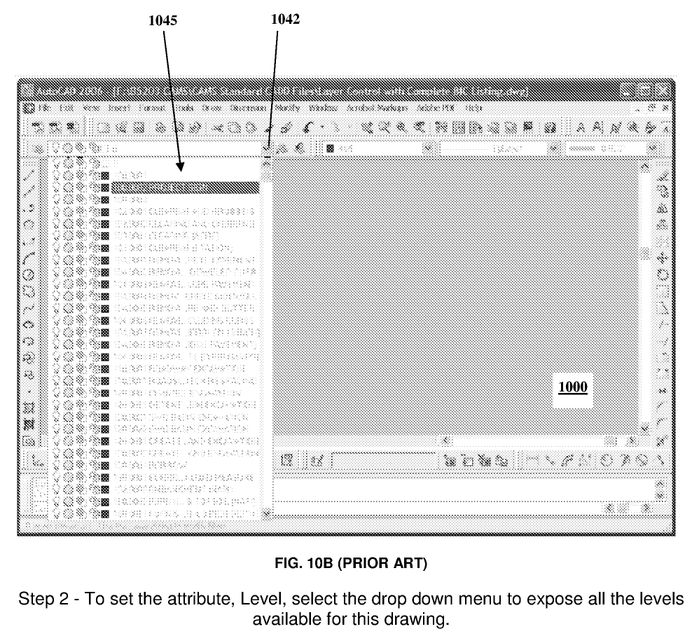

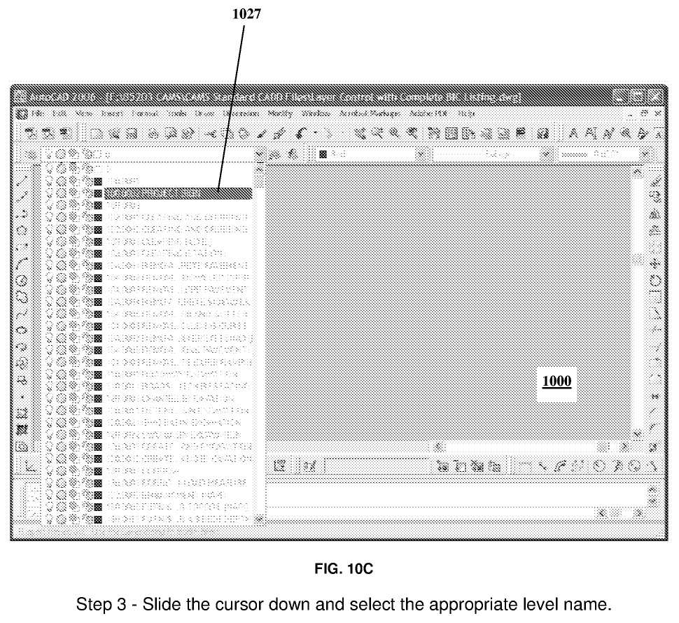

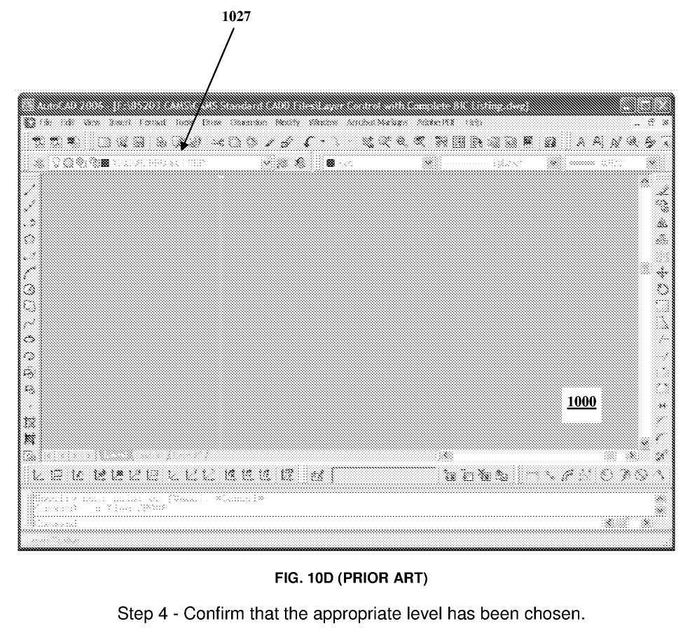

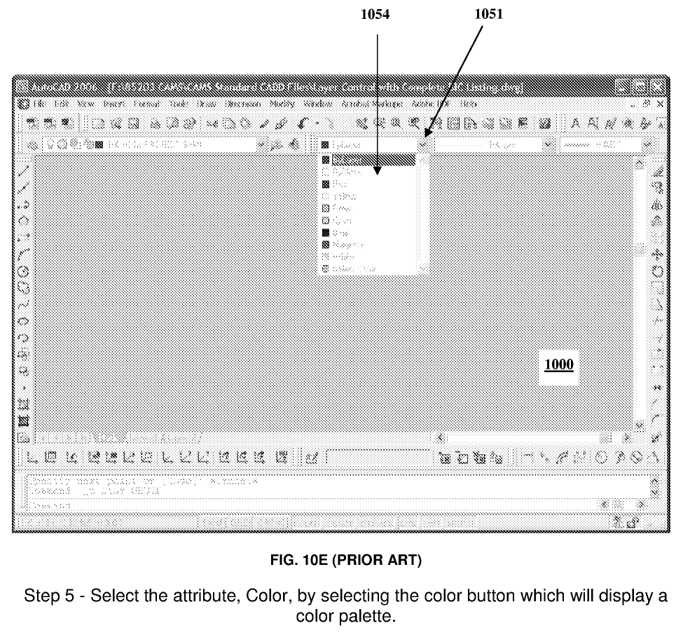

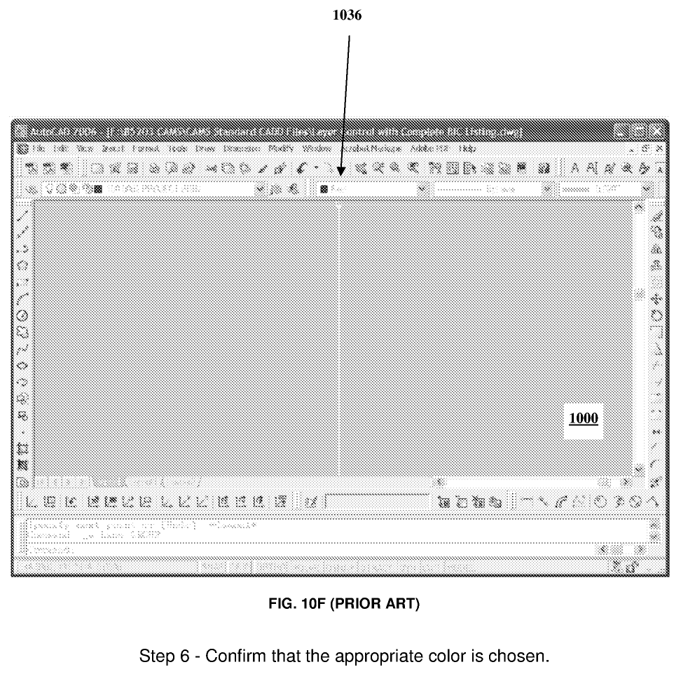

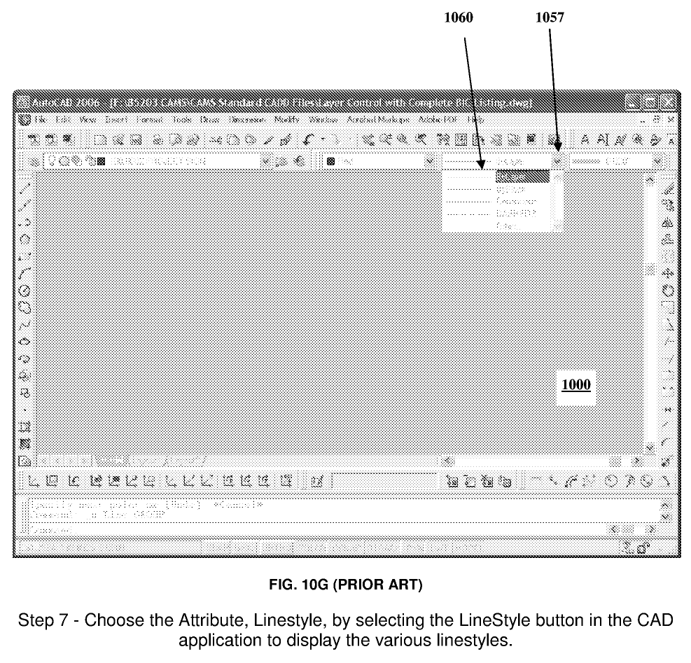

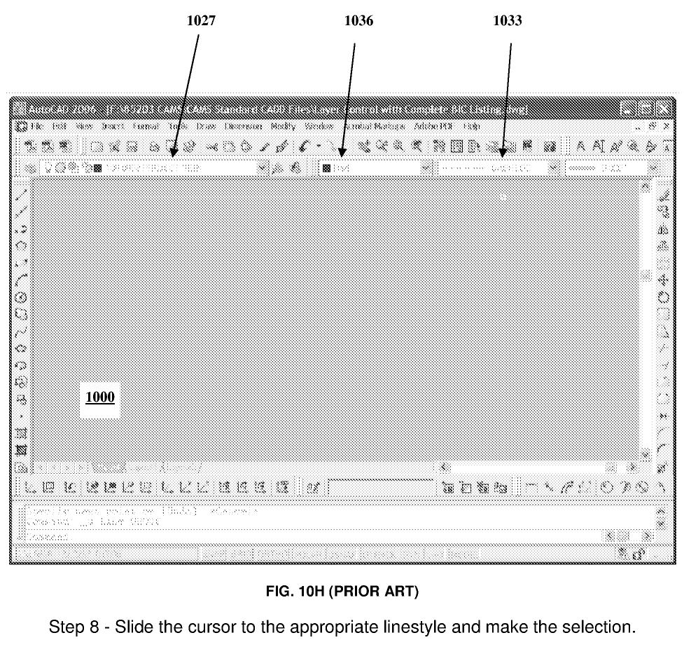

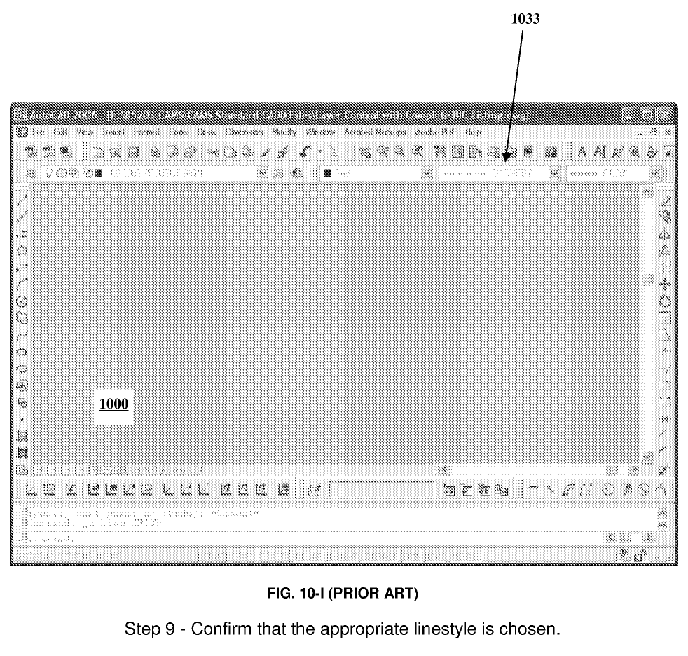

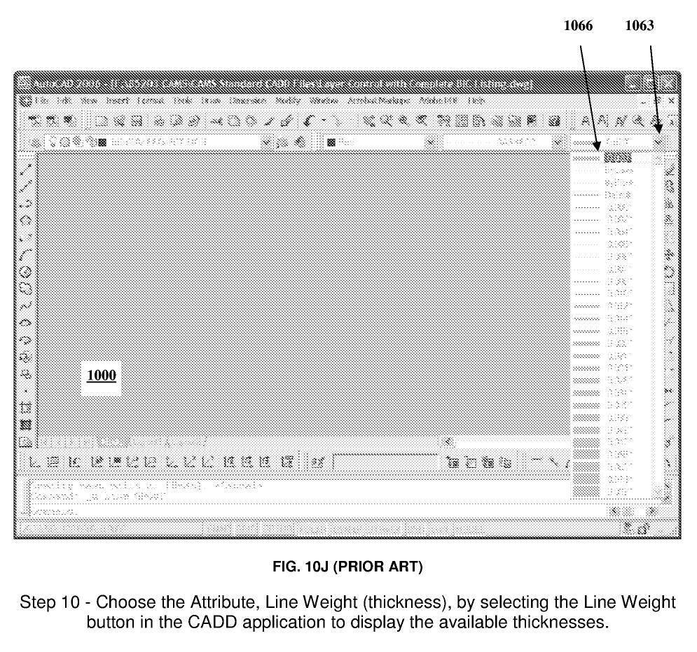

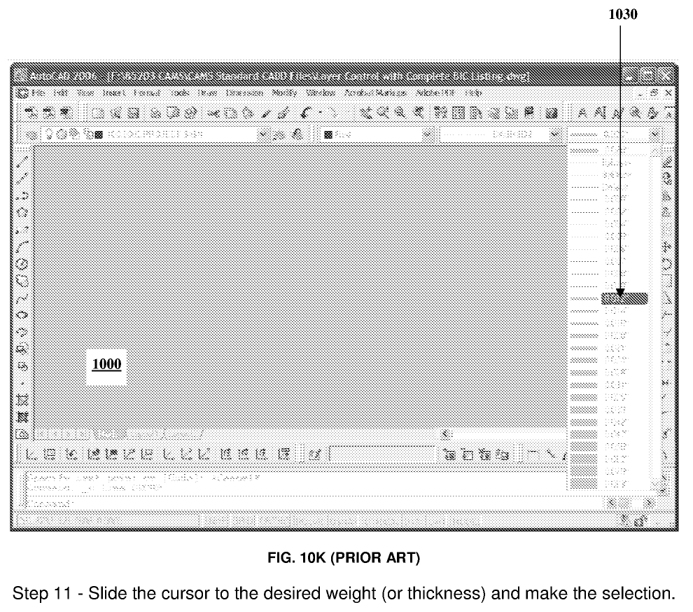

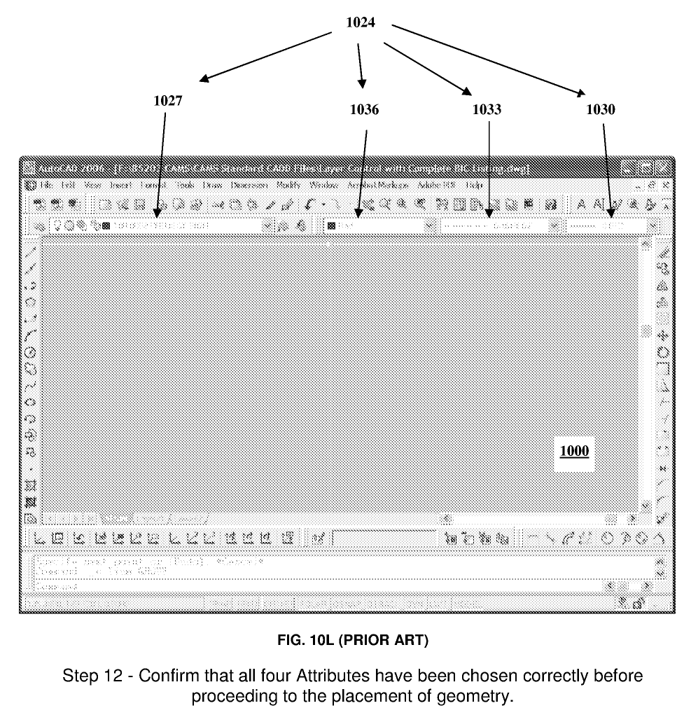

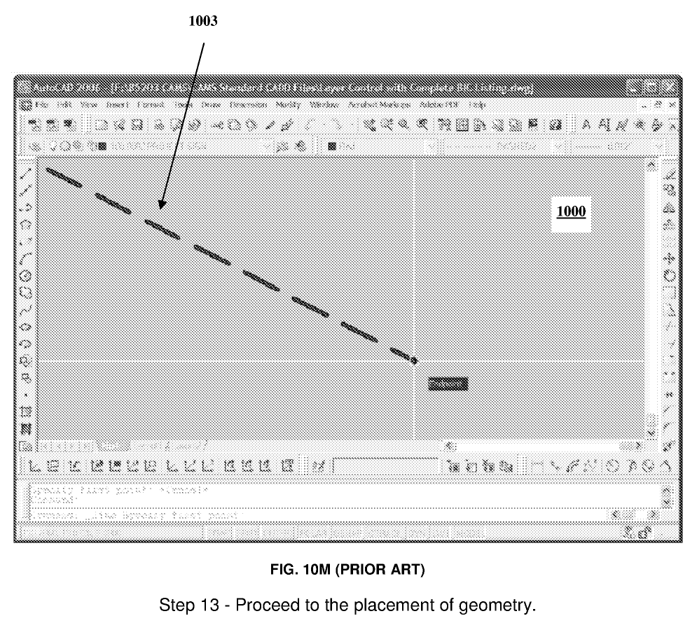

Referring now to a widely used manual method 100 in the art of placing an object 1003 in a CADD drawing 1000, FIGS. 10A-10M, inclusive, are screenshots showing a series of steps employed to place an object 1003 in an AUTOCAD® brand CADD drawing 1000. Before geometry can be placed in a CADD drawing, the attributes of the geometry must be set in the software according to a pre-defined set of parameters usually dictated by the client. A particular object would generally have four specific parameters which would need to be set in the software before the geometry could be placed in the CADD drawing. These four parameter (or attributes) are level, weight (or thickness), line style, and color. In this manual method the user would usually have a written manual which outlined the attributes of every type of geometry that would be placed in a drawing for the client. The user would search through each page of this manual until he/she found the object to be placed. The user would then identify and input the values for the four attributes into the CADD software application that would need to be set before placing the geometry in the drawing.

In the example provided in FIGS. 10A-M the user utilizes an interface 1006 presented on a computer screen from the AUTOCAD® brand CADD software application 1009 used by the draftsman to produce the required drawing 1000. The interface 1006 comprises generally a title bar 1012, one or more toolbars 1015 to facilitate applicable software functions or manipulation of the drawing 1000, a command bar 1018 to access submenus of the application, and a window 1021 for displaying the drawing 1000. The visual appearance in the drawing 1000 of the object line t 1003 is determined by a standard 1024. A standard may consist of one or more parameters. The standard 1024 in this case consists of four specific parameters that would need to be set in the AUTOCAD® software application 1009 before the geometry 1003 could be placed in the drawing 1000. These four parameters (more commonly known as ‘attributes’ to those skilled in the art) generally include (1) the level of the drawing 1027, (2) the weight (or thickness) of the line 1030, (3) the line style 1033, and (4) the line color 1036. To find the appropriate standard 1024 in this example, the user would have a written manual 140 which would contain the standards compilation 136 and outline the attributes of every type of geometry 108 that could be placed in the drawing 1000 for the client. As stated above, this manual 140 may have been produced from a unique set of standards 136 specific to a particular client, or from a set of standards 136 more widely available in the art, such as state or national standards. In order to set the standard 1024 in the AUTOCAD® brand CADD drawing 1000 of the example in FIG. 10, the user must search through pages 144 of the written manual 140 to find the standard 1024 for the object 1003 and then enter each attribute, 1027 through 1036, of the standard 1024, manually into the AUTOCAD® brand CADD application 1009, as shown in FIGS. 10B through FIG. 10L before placing the object 1003 in the drawing 1000 in FIG. 10M. To set the standard attribute, level, 1027, in FIG. 10B, select the drop down menu 1042 to expose a compilation of all the levels 1045 available for this drawing 1000. In FIGS. 10C and 10D the appropriate level 1027 is selected from the drop down menu 1042 and confirmed in the standard 1024. In FIGS. 10E and 10F the attribute, Color, 1036, is set by selecting the color button 1051 in the AUTOCAD® brand software 1009 which will display a color palette 1054 of up to 256 colors. Next, in FIGS. 10G to 10-I the attribute, Linestyle, 1033 is set by selecting the LineStyle button 1057 in the CADD application 1009 to display a compilation of the various linestyles 1060 from which to choose. The user slides the cursor to the appropriate linestyle 1033, makes the selection and confirms that the appropriate linestyle 1033 is input. In FIGS. 10J and 10K the user sets the attribute, line weight (thickness) 1030 by selecting the line weight button 1063 in the AUTOCAD® software application 1009 to display a compilation of the available thicknesses 1066. The user slides the cursor to the desired weight (or thickness) 1030 and make the selection to set the attribute in the application 1009. Finally, in FIGS. 10L and 10M the user confirms that all four attributes 1027, 1030, 1033 and 1036 of the applicable standard 1024 have been chosen and set correctly in the AUTOCAD® software application 1009 before proceeding to the placement of geometry 1003 in FIG. 10M.

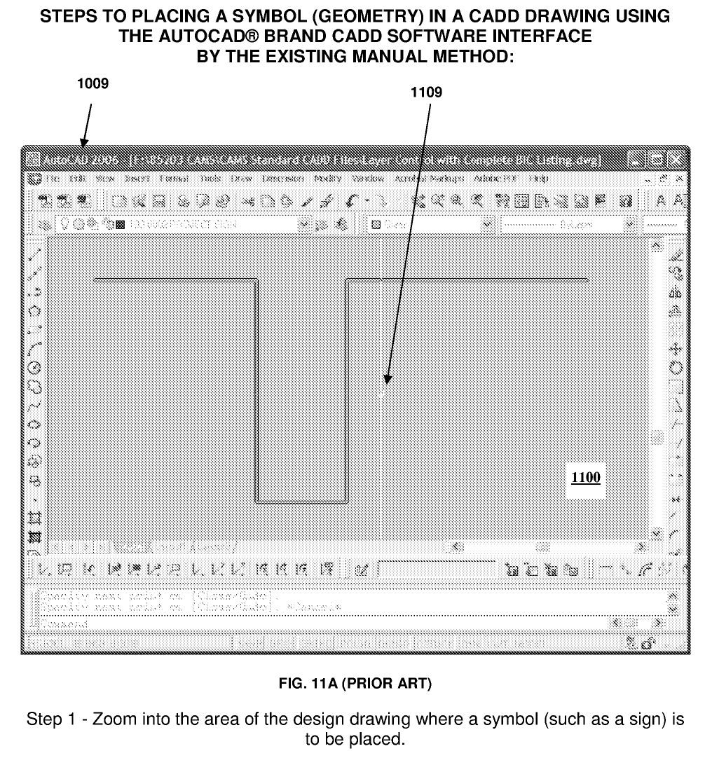

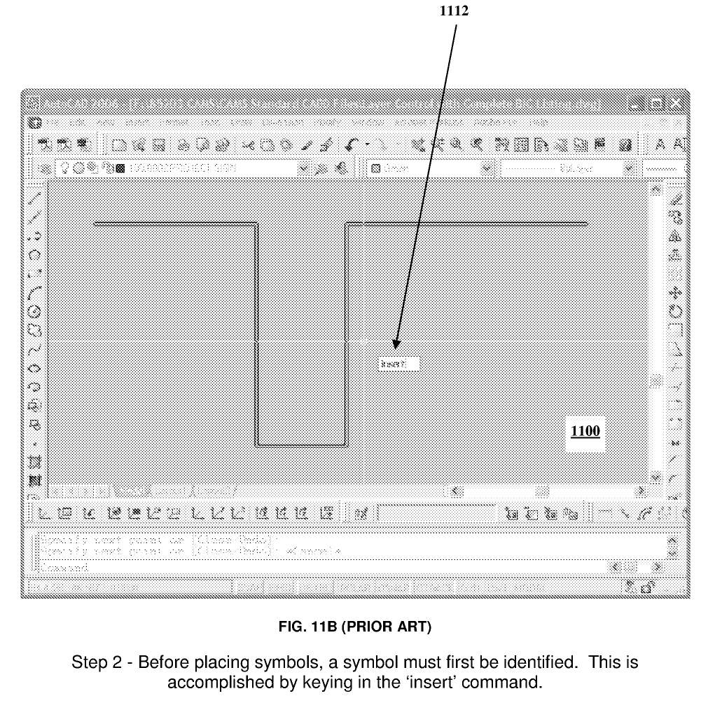

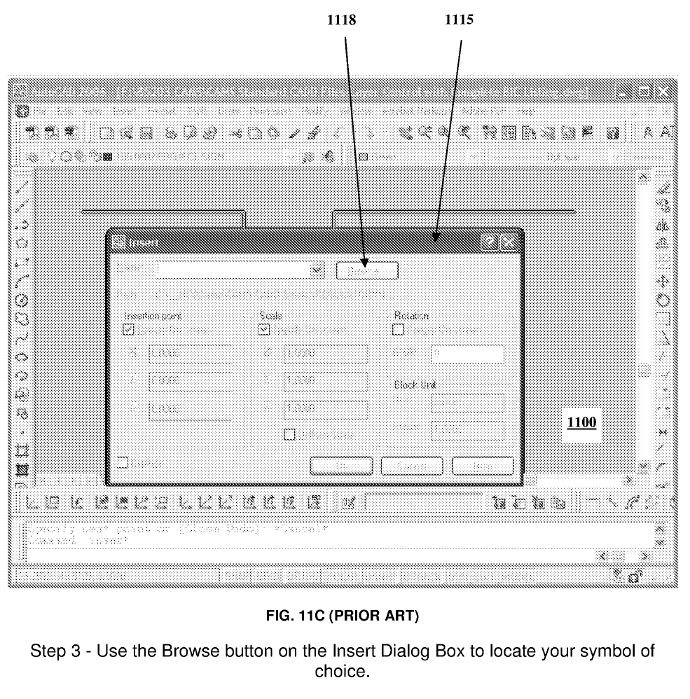

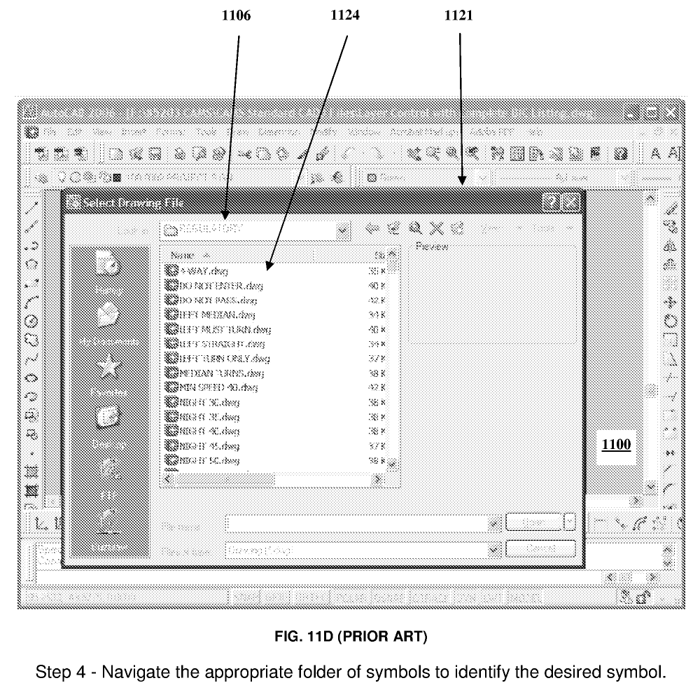

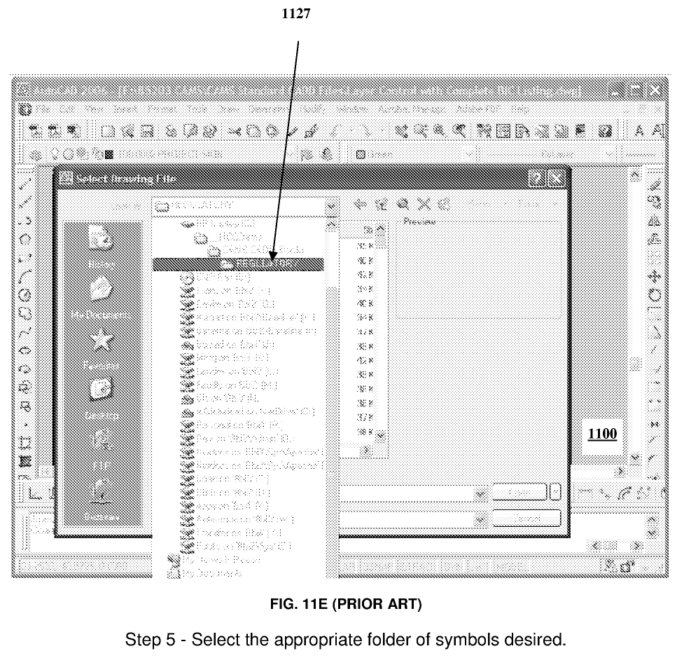

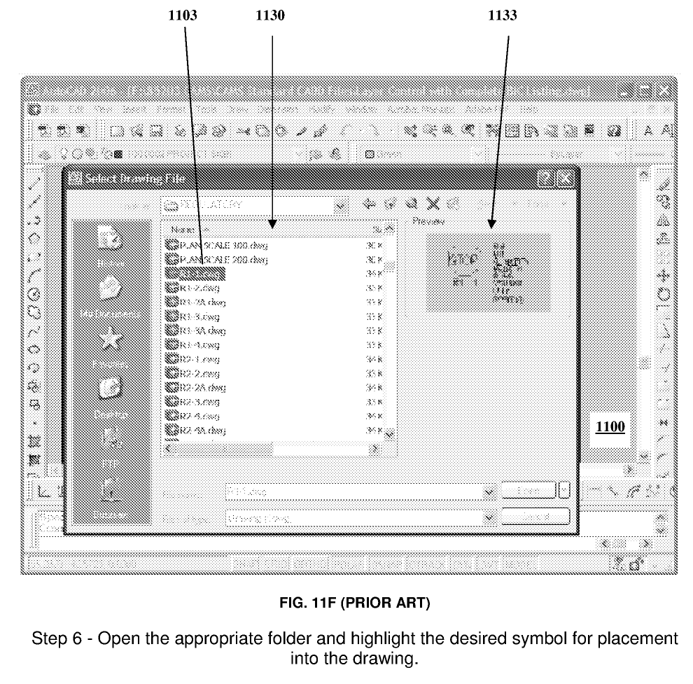

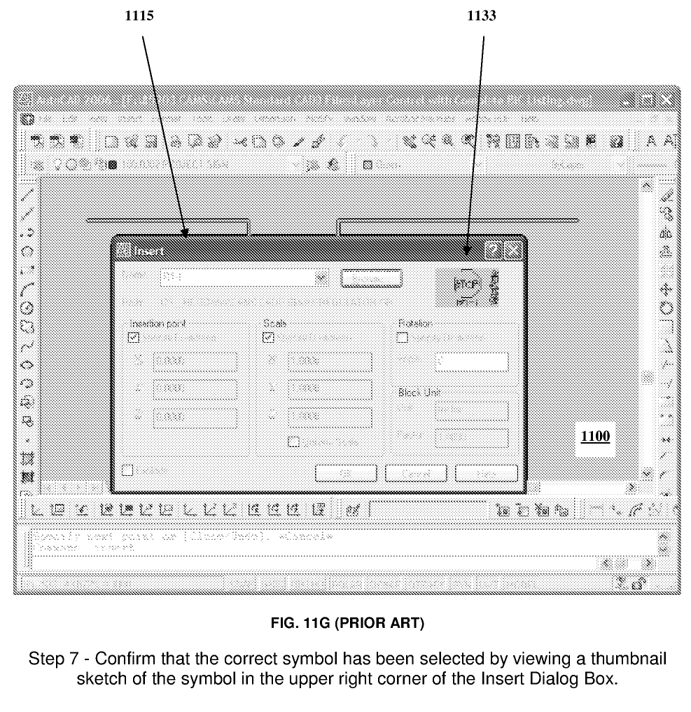

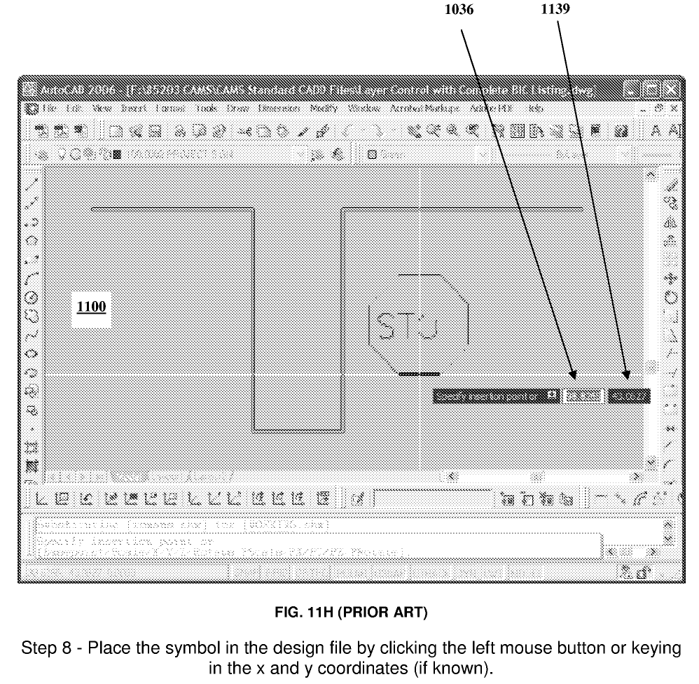

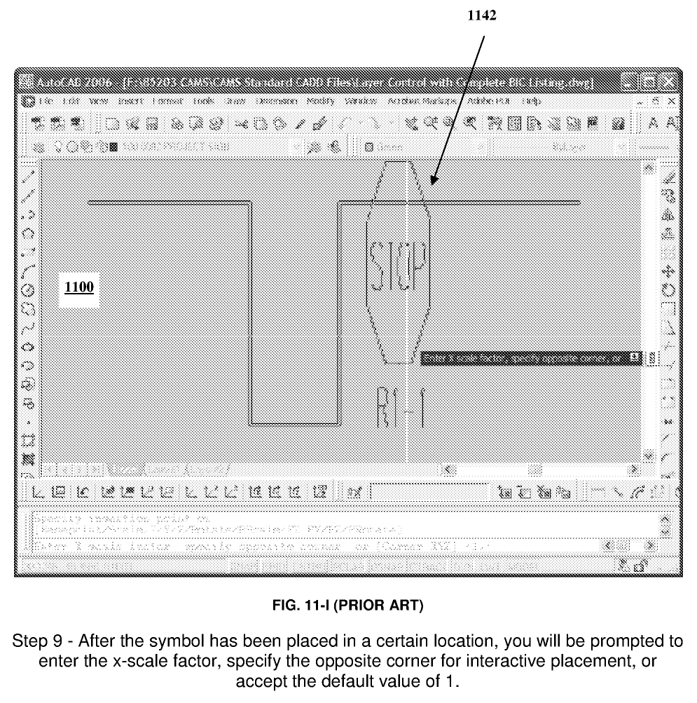

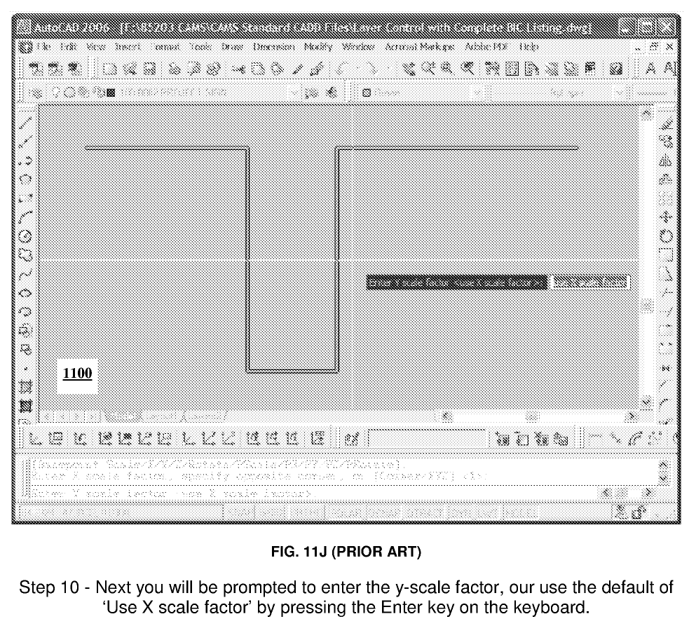

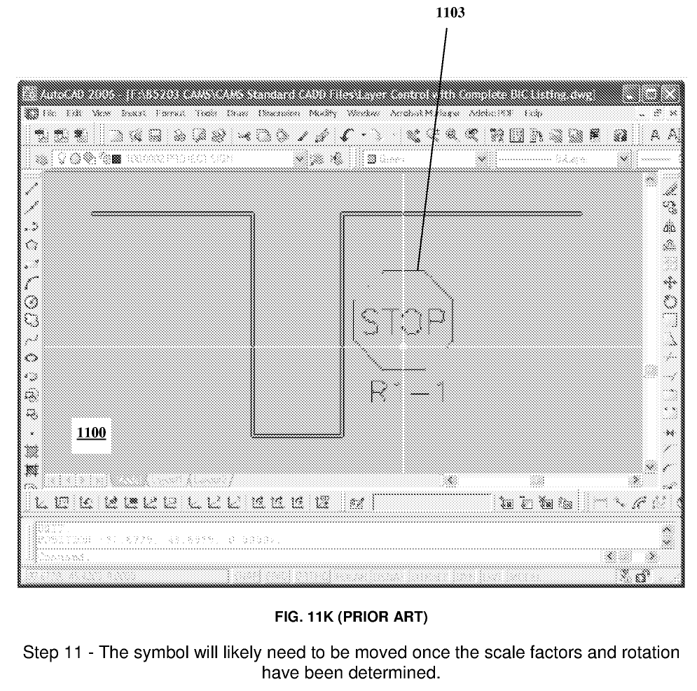

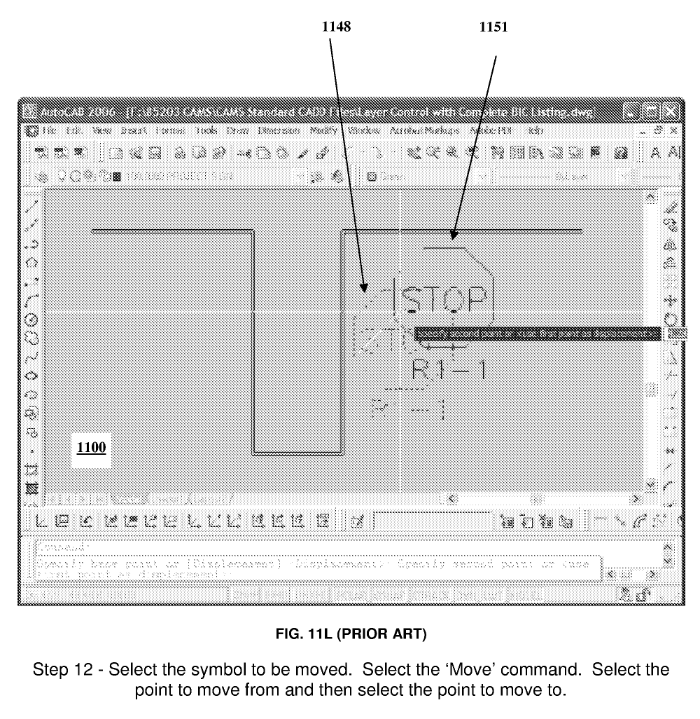

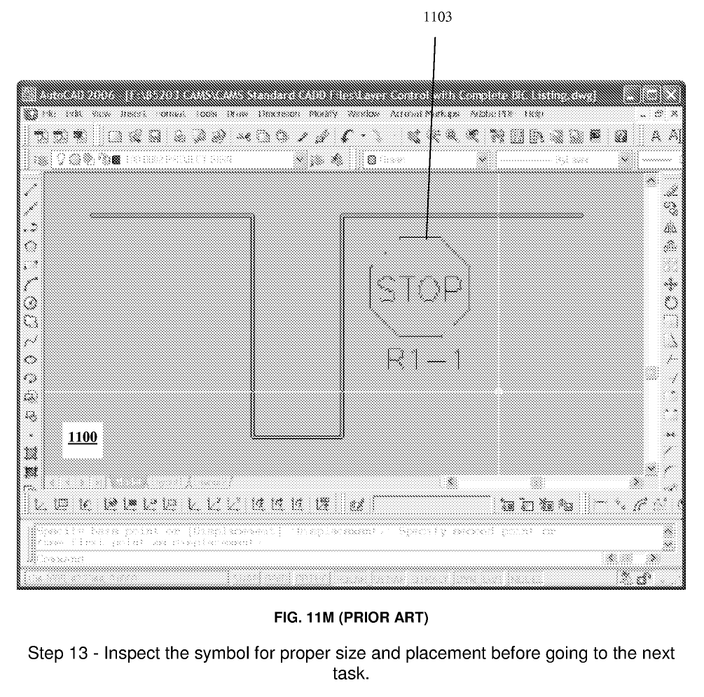

Another type of geometry 108 that may be necessary to complete a drawing 180 is the input of a symbol. For example, in the existing manual method 100 illustrated in the thirteen (13) steps of FIGS. 11A-3M, the user has to place a symbol for a sign 1103 in a CADD drawing 1100 utilizing the AUTOCAD® brand design software 1009. Again, before the geometry 1103 may be placed in the CADD drawing 1100 the user must make certain that the CADD application 1009 applies the correct set of standards 136 for each object 1103 to be placed. In this example, the user must manually retrieve and input the correct symbol 1103 from a compilation 1106 supplied by the client. In FIG. 11A, the user first identifies the area 1109 of the CADD drawing 1100 wherein the object 1103 is to be placed. Next, In FIGS. 11B through 11H, steps 2 through 7 respectively, the user selects the appropriate symbol 1103 from a symbol compilation 1106 required by the client. This is accomplished in a series of steps beginning in FIG. 11B by keying the Insert command 1112 to open the Insert dialog box 1115. The user selects the Browse button 1118 on the Insert Dialog Box 1115 to locate the symbol 1103 of choice. The symbol compilation window 1121 opens revealing the available symbol folders 1124 of the standards compilation 1106 if they have already been input into the application 1009. If the desired symbol library 1106 is not input into the application 1009 then the user will have to perform that maintenance function first prior to symbol 1103 selection. In FIG. 11E the user selects the appropriate folder of symbols 1127 and opens it in a window 1130 to reveal a compilation of symbols 1106 within the selected folder 1127. The user then opens the appropriate folder 1127 and highlights or selects the desired symbol 1106 for placement in the drawing 1100. The user then confirms that the correct symbol 1103 has been selected by viewing a thumbnail sketch 1133 of the symbol 1103 in the upper right corner of the Insert Dialog Box 1115. In FIG. 11H the user places the symbol 1103 in the drawing 1100 (the design file) by clicking the left mouse button or keying in the x 1136 and y 1139 coordinates if known. After the symbol 1103 has been placed in the desired location 1109, in FIG. 11-I the user is prompted to enter the x-scale factor 1136, specify the opposite corner for interactive placement, or accept the default value of 1. In FIG. 11J the user is prompted to enter the y-scale factor 1139, or use the default of ‘Use X scale factor’ by pressing the Enter key on the keyboard. It is likely that the symbol 1103 will need to be moved once the scale factors and rotation 1142 have been determined. In FIG. 11L to move the symbol 1103, the symbol 1103 is selected and made active by selection of the ‘Move’ command 1145. Select the point to move from 1148 and then select the point to move to 1151. To conclude the process in FIG. 11M the user inspects the symbol 1103 for proper size and placement 1109 before going to the next geometry 108. The drawing 1100 is now ready for placement of additional objects 108, and to do so the user must repeat the steps above.

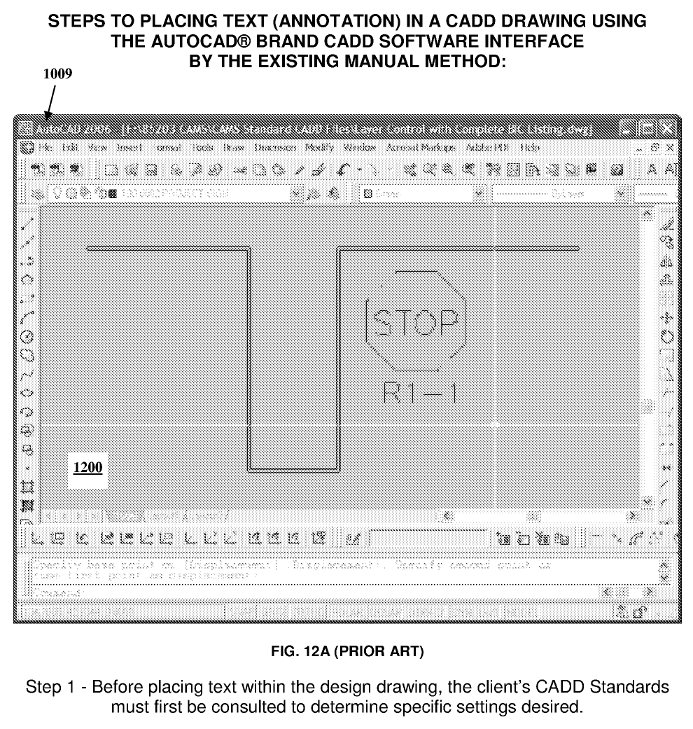

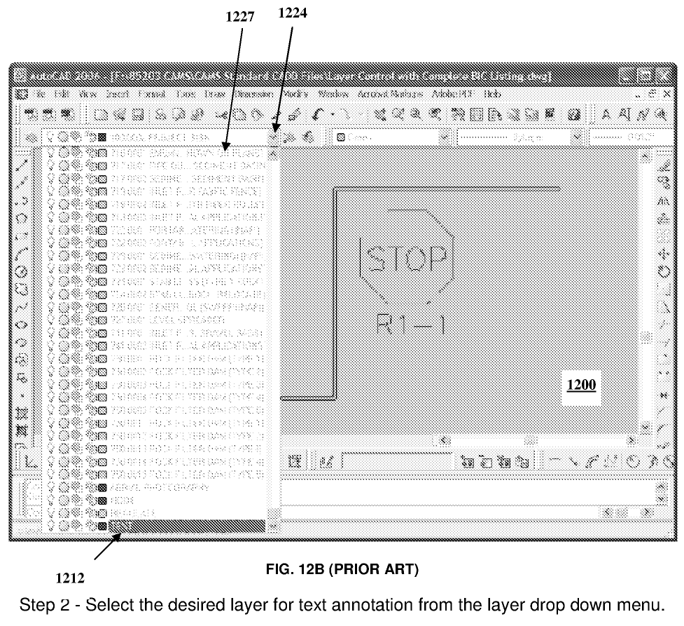

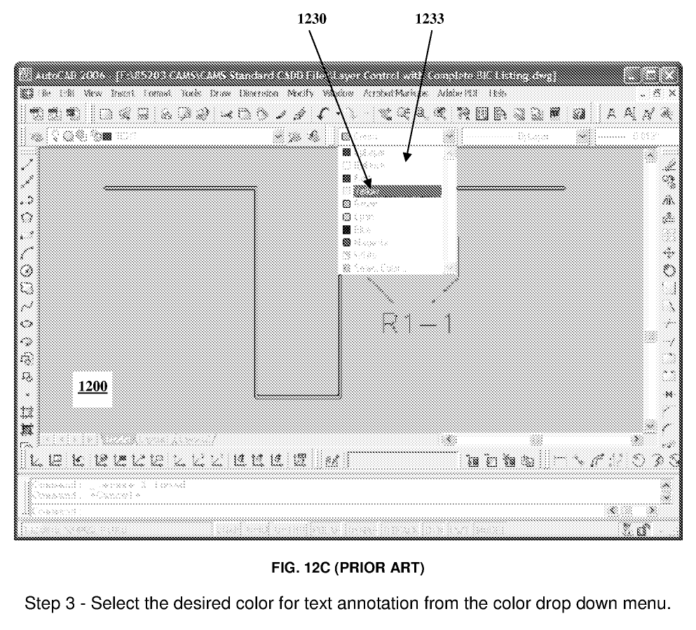

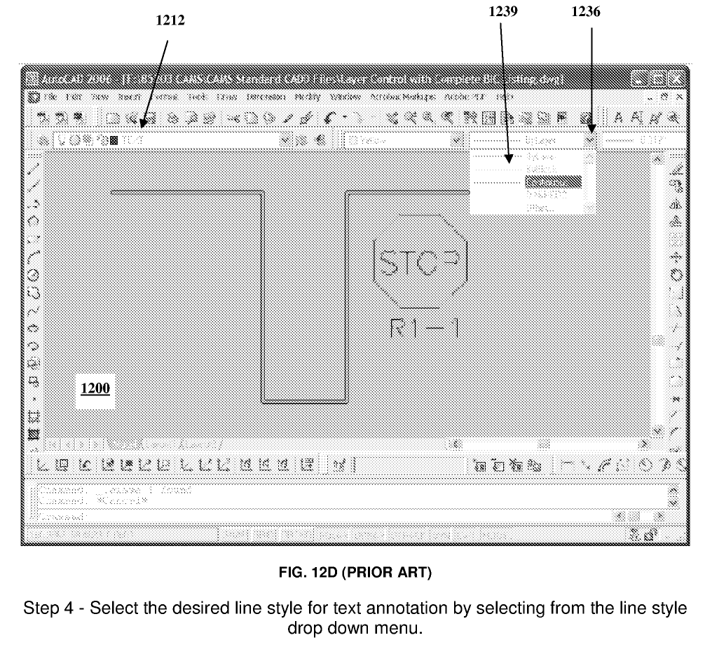

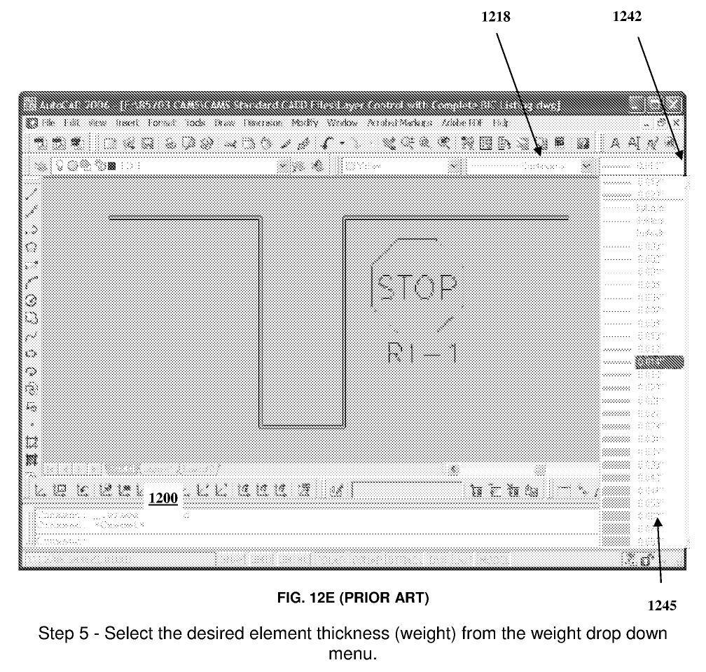

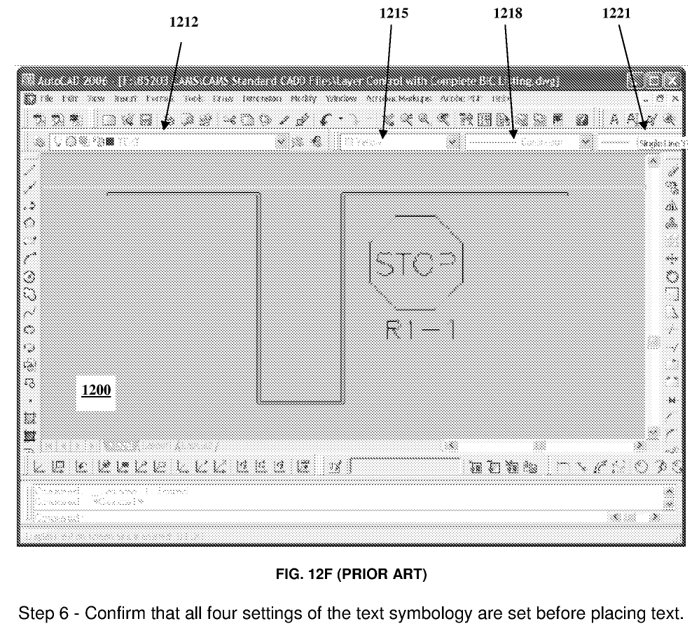

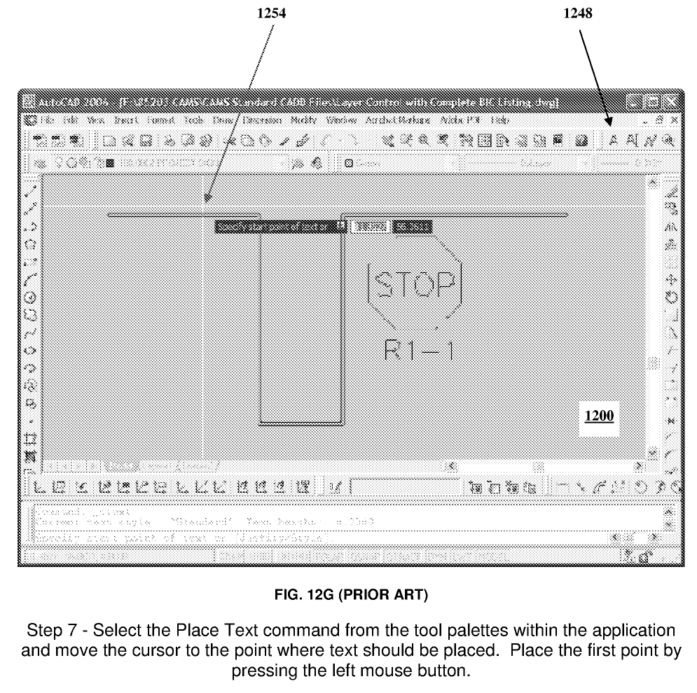

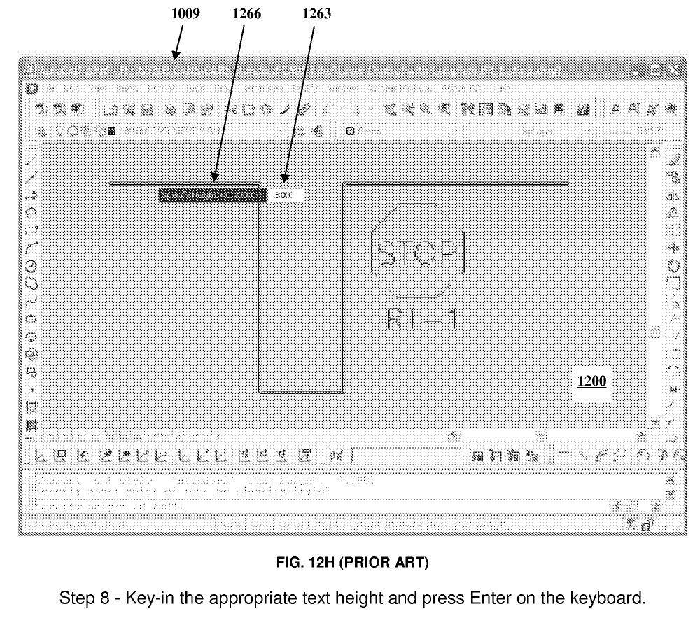

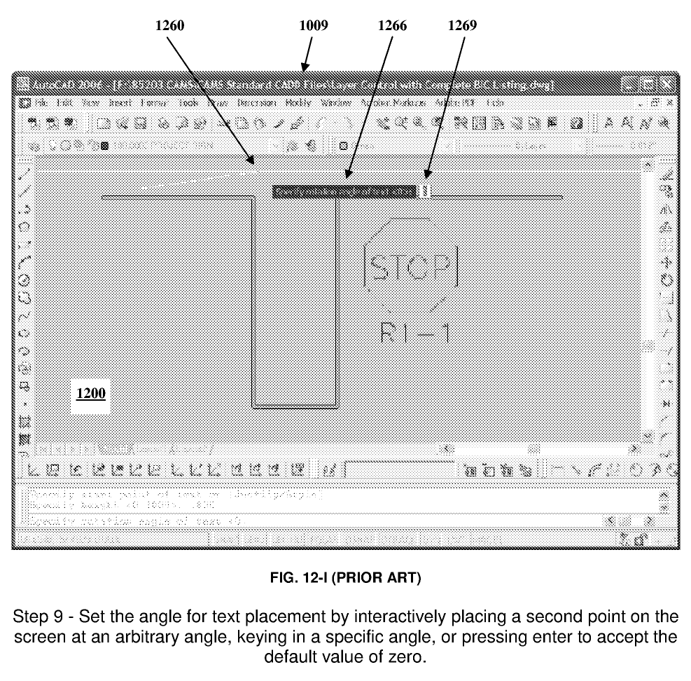

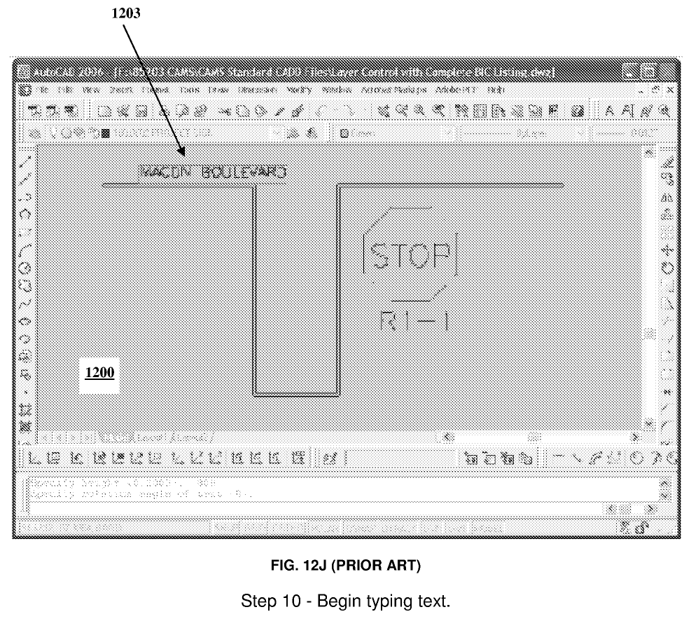

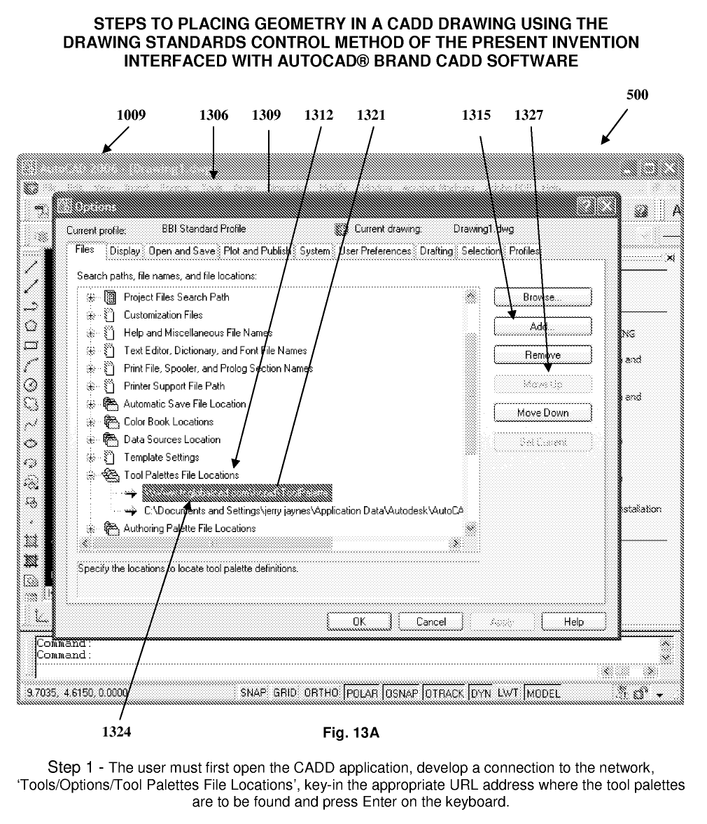

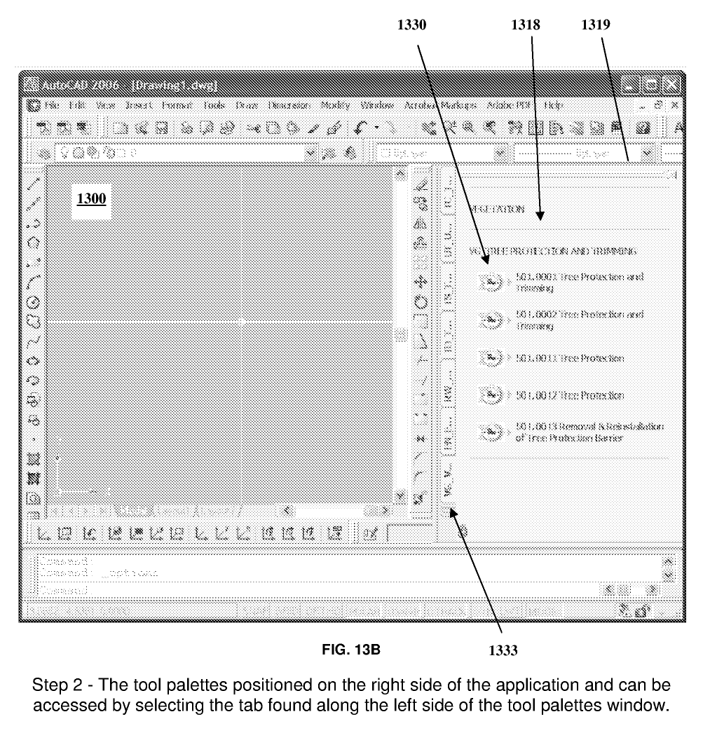

Another type of geometry 108 that may be necessary to complete a drawing 100 is the placement of text or annotation. For example, in the existing manual method 100 illustrated in the ten (10) steps of FIGS. 12A-12J, the user has to place text 1203 in a CADD drawing 1200 utilizing the AUTOCAD® brand design software 1009. Before placing text 1203, the appropriate standards 138 for the specific client must be reviewed to determine the specific settings, as shown generally in FIG. 4 and FIG. 10. Before the text 1203 can be placed in the drawing 1200 in FIG. 12, the element attributes of layer 1212, weight 1221, line style 1218, and color 1215 must be set as illustrated in steps 2 through 6 of FIGS. 12B through 12E respectively. In FIG. 12B the user selects the desired layer 1212 for text annotation from the Layer drop down menu 1224 comprising the various layers 1227 available. To change the color attribute 1215 in FIG. 12C the user selects the appropriate color 1230 from a drop down color palette 1233. To change the Line Styles attribute 1218 in FIG. 12D the user selects the Line Style button 1236 to open a line style compilation 1239. The user selects the appropriate line style 1218 and then proceeds on to change the next attribute, line weight 1221 in FIG. 12E. To change the Line Weight attribute 1221 the user selects the Line Weight button 1242 to open a compilation of available line weights 1245. In FIG. 12F the user must confirm that the four element attributes for placing text, i.e., layer 1212, weight 1221, line style 1218, and color 1215, have been set correctly from the client standards 140 before proceeding to place text. Next, the user selects the Place Text command 1248 from the tool palettes within the application 1009 and moves the cursor (cross-hair) to the text placement location 1254. Before text can be typed, additional attributes such as text height 1263 and text angle 1269 must be set in the application in accord with the client standards 138. In FIG. 12H the user must input the appropriate text height 1263 in a text specification box 1266 and press Enter on the computer keyboard to set the entered attribute value. In FIG. 12-I the user sets the angle 1269 for text placement according to the client standards 138 by interactively placing a second text placement point 1260 in the drawing 1200 on the screen at an arbitrary angle, keying in a specific angle, or pressing enter to accept the default value of zero. Now that all of the text attributes 1209, comprising the layer 1212, the color 1215, the line style 1218, the line weight 1221, the line height 1263 and the line angle 1269, have been separately entered into the AUTOCAD® brand drawing, the user must visually confirm in FIG. 12J that they conform with the appropriate standards of the client 138 before any text 1203 may be entered into the drawing 1200. Once confirmed, the user may type in the appropriate text 1203. The drawing 1200 is now ready for placement of additional text 1203 as required, but the user must repeat the steps for each variation of the text 1203 according to the client compilation of standards 138.

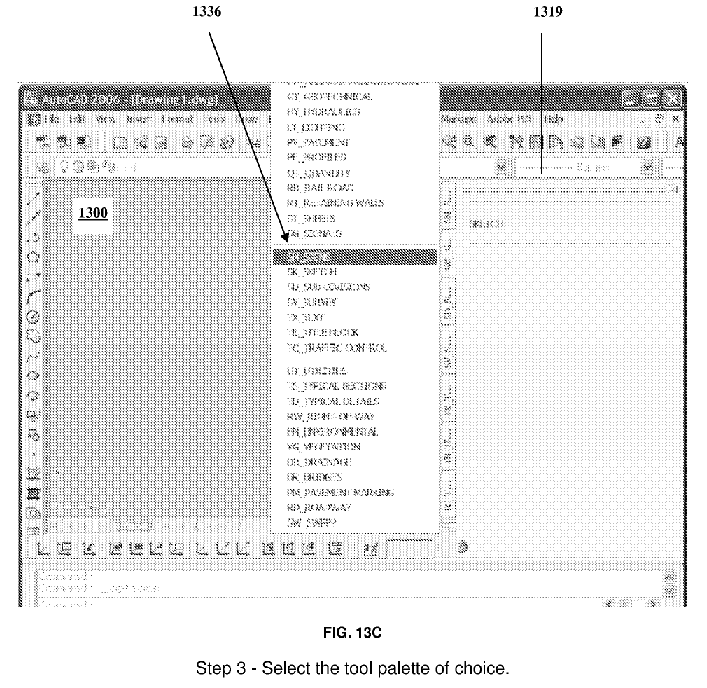

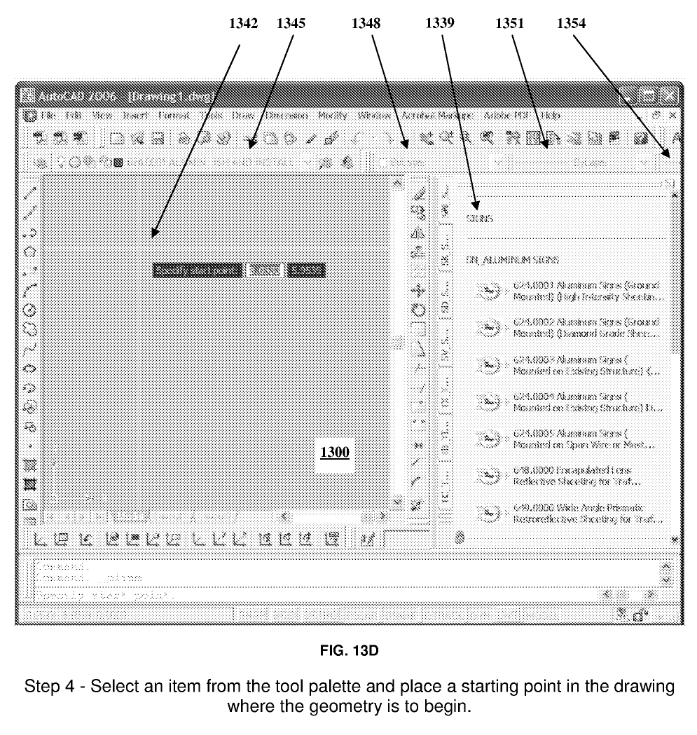

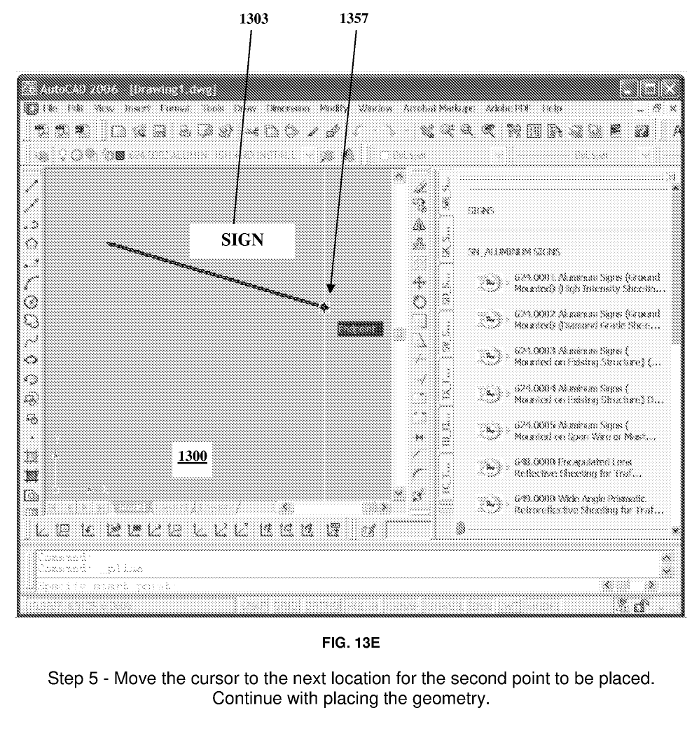

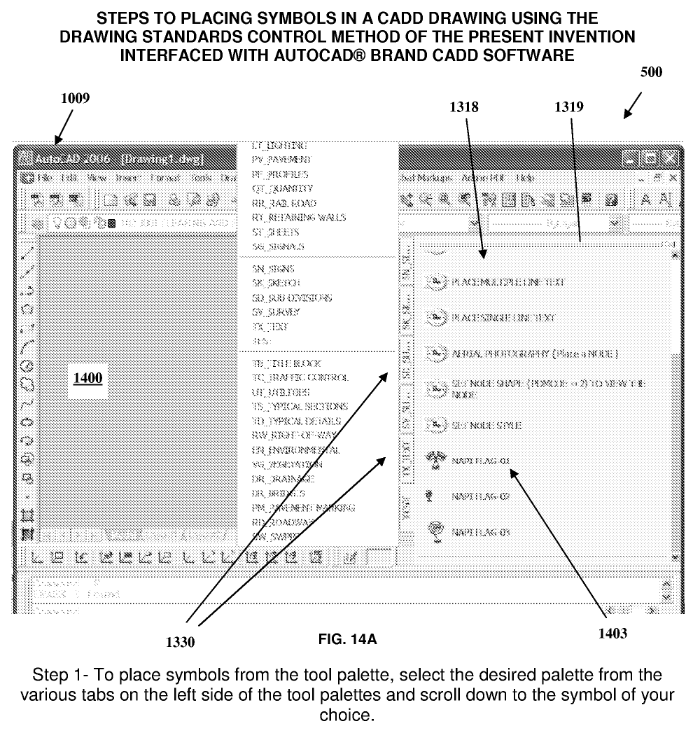

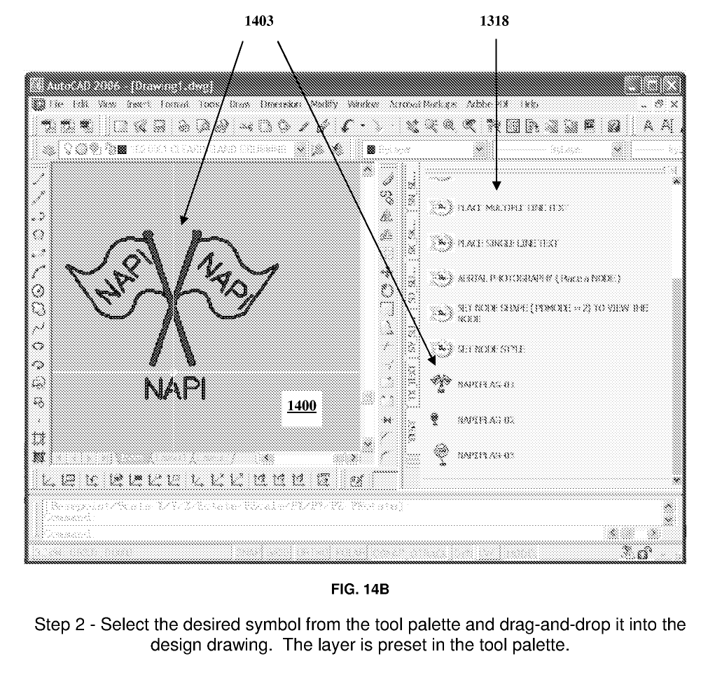

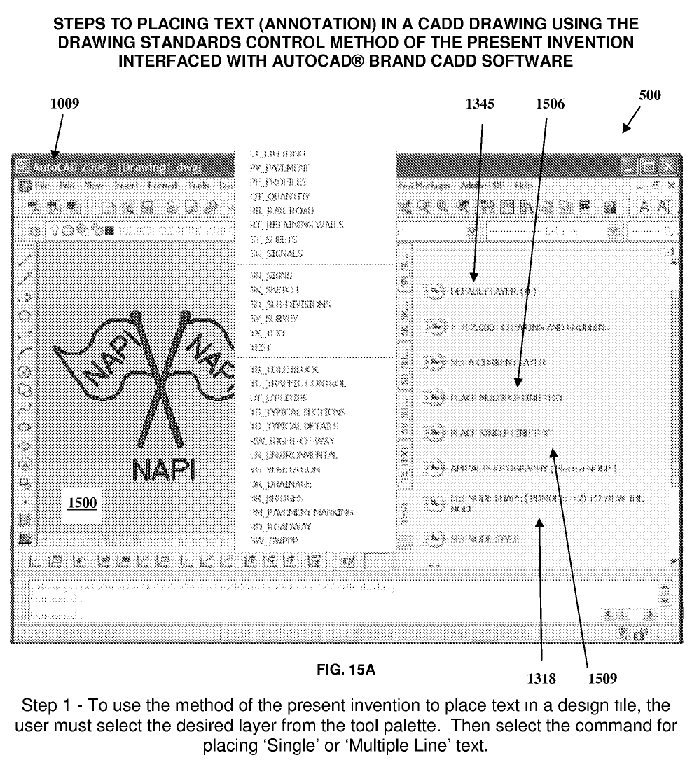

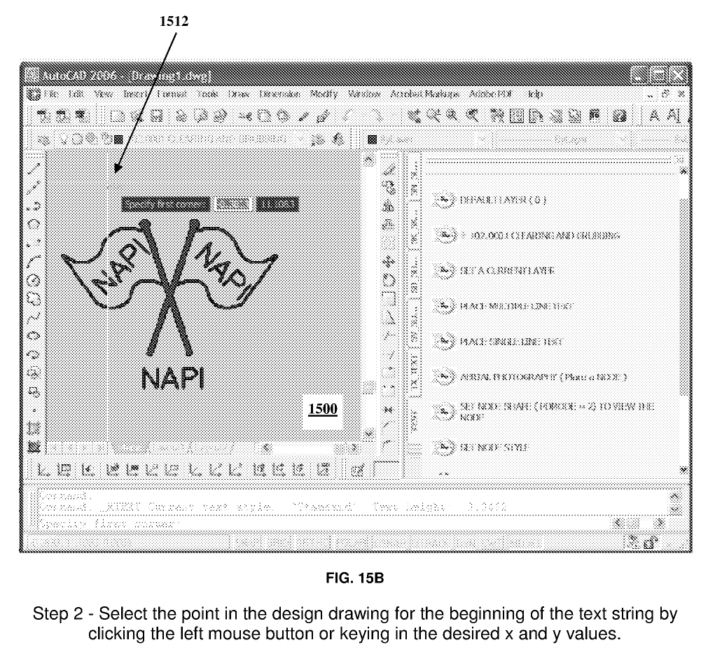

Referring now to a preferred embodiment of the present invention 500 of CADD standards management and quality control, FIGS. 13A through 13E are screenshots of a series of steps that demonstrate the creation of an object 1303 in a CADD drawing 1300 utilizing an interface with the AUTOCAD® brand design software 1009 and a compilation or feature table of CADD standards 138 provided by the network application of the present invention 1324. In the preferred embodiment of placing geometry 1303 in a drawing (also known in the art as the ‘design file’) 1300, the user must first open the CADD application 1009 and develop a connection to the network 520. Then in FIG. 13A the connection to a network is made by selecting ‘Tools’ 1306 on the command bar 1018, which opens a Tools dialog box where ‘Options’ is selected, an Options dialog box 1309 then opens, the command ‘Tool Palettes File Locations’ 1312 is selected, then the ‘Add’ button 1315 on the right of the dialog box 1309 is selected to add a new path for tool palettes 1318. The user enters the appropriate URL address 1321 to access the network application 1324 of the present invention where the tool palettes 1318 for the respective client or project are located. The user then presses Enter on the keyboard, and selects the ‘Move Up’ button 1327 on the right of the dialog box 1309 to move this expression 1321 up to the top slot. In this manner, the application 1009 will look to the URL address 1321 for the tool palettes 1318 before looking at any default location of the application 1009. The user then closes and re-opens the application 1009 to make the tool palettes 1318 of the present invention appear automatically in the tool palette window 1319. When the connection to the network application 1324 is made, the tool palettes 1318 from the drawing standards management and quality control application 1324 of the present invention are positioned on the right side of the AUTOCAD® brand design application 1009, as shown in FIG. 13B. Individual tool palettes 1318 can be accessed by selecting their respective tabs 1330 found along the left side of the tool palettes 1318. When there are more tool palettes 1318 than can be displayed along the left side, the user may select the cascading tabs icon 1333 found at the lower left of the tool palettes 1318 to expose all possible tool palettes 1318. In FIG. 13C the user then selects the tool palette of choice 1336 by moving the cursor to the appropriate name and pressing the left mouse button. In FIG. 13D the user then selects an item 1339 (in this example, the geometry, Signs) from the tool palette 1336 and places a starting point 1342 in the drawing 1300 where the geometry 1303 is to begin. Notice that the settings for the four symbology attributes (layer 1345, color 1348, line weight 1351, and line style 1354) were set when the item 1339 was selected from the tool palette 1336. By the method of the present invention, selecting the desired object 1339 from the list 1336, the object attributes and therefore the object standard, are automatically set before the final geometry 1303 is included in the CADD drawing 1300. To proceed with placing the geometry 1303, in FIG. 13E the user moves the cursor to the next location for the second point, or endpoint 1357, for the geometry to be placed and repeats the steps above. When the endpoint 1357 is placed the user proceeds to set geometry 1303 in the drawing without the need for further modification of attributes. These steps are repeated for every type of object 1303 or other geometry which needs to be input into the CADD drawing 1300. In the method of the present invention the attributes and therefore the relevant standards do not require any input or maintenance from the user due to the centralized network standards management.

Referring now to a preferred embodiment of the present invention 500 of CADD standards management and quality control, FIGS. 14A and 14B are screenshots of a series of steps that demonstrate the creation of a symbol 1403 in a CADD drawing 1400 utilizing an interface 1301 with the AUTOCAD® brand design software 1009 and a compilation of CADD standards 138 provided by the network application of the present invention 1324. In the preferred embodiment of placing a symbol 1403 in a drawing (also known in the art as the design file) 1400, the user opens the CADD application 1009 and then proceeds to access the relevant tool palette compilation 1318 for the client or project as described in FIG. 13 above, incorporated herein by reference. To place symbols from the tool palettes 1318, select the desired symbol 1403 from the various tabs 1330 on the left side of the tool palettes 1318 by scrolling to the symbol of choice 1403. In FIG. 14B, the user selects the desired symbol 1403 from the tool palette 1318 and inserts the symbol 1403 by the drag-and-drop or point-and-click methods into the design drawing 1400. The layer attribute 1345 is preset in the tool palette 1318 so the symbol 1403 will be placed on the proper layer 1345 without intervention from the user. All additional object attributes (i.e. color, weight, linestyle & shape) have been previously entered into the standards management and quality control application 1324 of the present invention and comprise the standards 138 for the object 1403 according to the requirements of the client. By selecting the desired object 1403 from the tool palettes 1318 provided by the present invention, the appropriate attributes, and therefore the appropriate object standard 138, is automatically set without any input from the user before the object 1403 is input into the CADD drawing 1400.

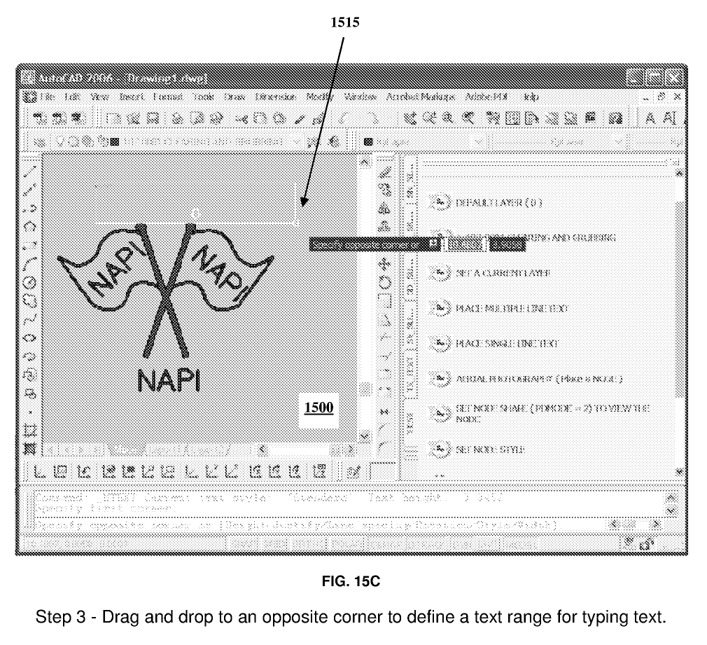

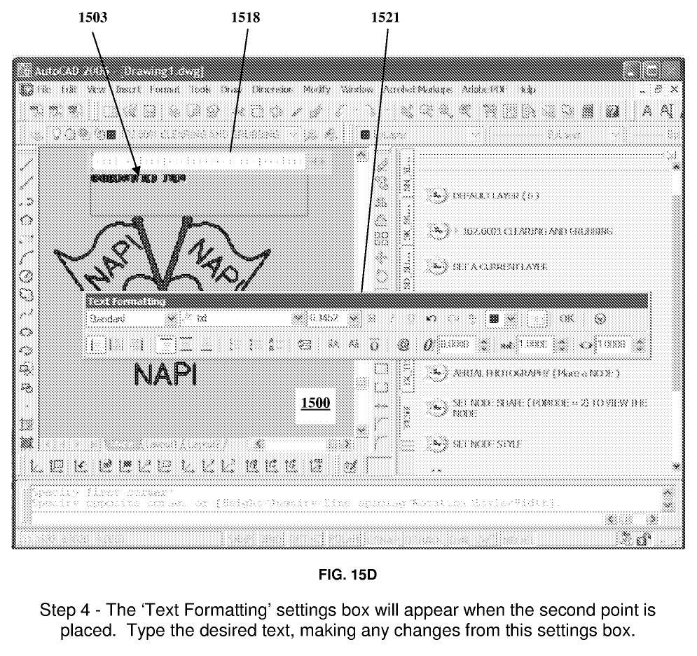

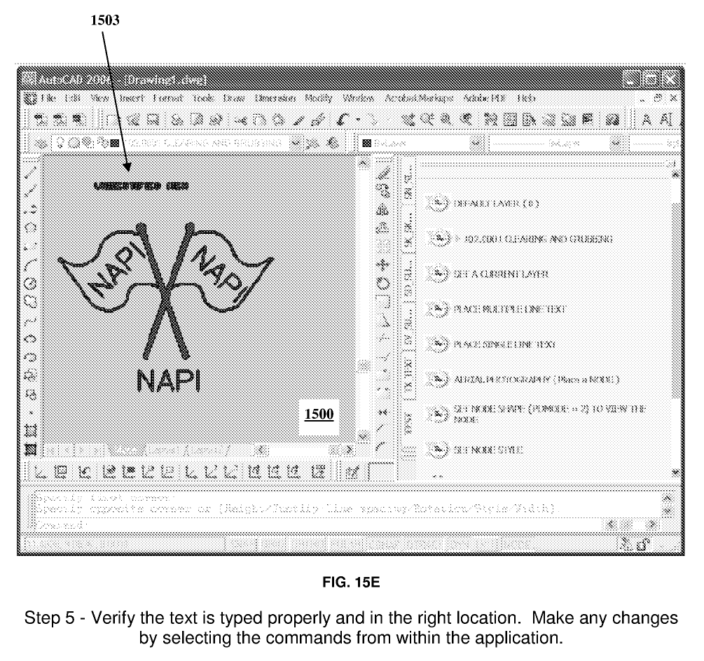

Referring now to a preferred embodiment of the present invention 500 of CADD standards management and quality control, FIGS. 15A through 15E are screenshots of a series of steps that demonstrate the creation of text 1503 in a CADD drawing 1500 utilizing an interface 1301 with the AUTOCAD® brand design software 1009 and a compilation of CADD standards 138 provided by the network application of the present invention 1324. In the preferred embodiment of placing text 1503 in a drawing 1500, the user opens the CADD application 1009, proceeds to establish an interface with the network application 1324 of the present invention, and then proceeds to access the relevant tool palette compilation 1318 for the client or project as described in FIGS. 13 and 14 above, incorporated herein by reference. The user then navigates to the tool palette 1318 that will provide a selection of the desired layer 1345 in the drawing. The user then selects the command for placing ‘Single’ 1506 or ‘Multiple Line’ text 1509. The symbology, or attributes, for the text 1503 (layer, color, weight, line style) is preset in the tool palette 1318 without user intervention. In FIG. 15B, the user then selects the point in the design drawing for the beginning of the text string 1512 by clicking the left mouse button or keying in the desired x and y values. In FIG. 15C the user then uses the method of drag-and-drop to an opposite corner or point 1515 to define a text range 1518 for typing to begin for text input. In FIG. 15D the ‘Text Formatting’ settings box 1521 appears when the second point 1515 is placed. Type the desired text 1503, making any changes from this settings box 1521. The user then verifies the text 1503 is typed properly and in the right location as shown in FIG. 15E. The user may make any changes by selecting the commands from within the application 1324 of the present invention. By inputting the desired text 1503 from the tool palettes 1318 provided by the present invention, the appropriate attributes, and therefore the appropriate standard 138, is automatically set without any input from the user before the text 1503 is input into the CADD drawing 1500.

In a further alternative embodiment, the client is provided access to its own administrative page in the network user interface application 615 of the present invention. In this administrative page the client may input its own CADD standards and any other applicable data. This feature table will feed the network user interface application without a third party, such as the network user interface programmer, having to perform a merge. As the client needs to make changes to its CADD standards on the network user interface application, the client simply accesses the CADD standards feature table through its administrative page and inputs the necessary changes. Similarly to the inputs by the network user interface menu programmer, whatever is entered into the standards feature table directly by the client will be available to all of the users authorized by the application owner or the client, such as independent engineering consulting firms.

In a further alternative embodiment of the present invention, the menu of CADD standards available on the network user interface application will be scalable to make access and use of the standards more efficient. The network user interface application programmer, the client or the user will be able to create a subset menu of CADD standards by selecting from, or filtering, the existing list of standards and compiling a separate subset file as needed. For example, a large government entity such as a county is the client. The county has initiated a highway construction project and contracted with several independent consulting, construction and engineering companies to design and build the project. By the method of the present invention, the entity charged with control of the applicable CADD standards for the project will have access to their CADD standards feature table through their administrative page on the network user interface application of the present invention. Initially, the feature table will be populated with the desired CADD standards, for example 4,000 line items. Thereafter, changes to these CADD standards, such as corrections or periodic updates, may be performed at any time by the standards control entity through the administrative network page. The standards end user working for a consulting company designing drawings for the county highway project must use these standards. If the end user is creating a proposed traffic control plan, the user may only need 150 of the 4,000 standards. Thus to increase the productivity of the end user, it would be advantageous to limit the standards feature table to 150 primary standards. This scalable feature table function of the present invention provides that a subset of standards may be prepared from the existing feature table and this specific subset made available to the user on the network user interface application of the present invention. Therefore the end user does not have to waste time searching through the entire feature table (example of 4,000 items) when only a subset (150) is applicable to a project.

In a further alternative embodiment, just as a client would have an administrative page to post their CADD standards, the end user could also have their own user administration page to create subset menus. Thus the end user could select or otherwise filter a feature table of standards to create a subset for a specific purpose. This subset list would feed their network user interface application and it would not be necessary to wade through superfluous standards, thus reducing frustration, fatigue, and the time it takes to select an item and begin drawing.

If the end user cannot find an item on the custom page, the user can go back to the user administration page and check additional items which will automatically appear on the custom page for use. In this manner, a consulting firm can tailor a variety of menus from the county CADD standards for their engineers to use in traffic control, bridge design, demolition work, and so forth.

It is understood that the embodiments and descriptions of the invention herein described are merely instruments of the application of the invention and those skilled in the art should realize that changes may be made without departure from the essential elements and contributions to the art made by the teachings of the invention herein.

The foregoing description of the preferred embodiments of the invention has been presented for purposes of illustration and description. It is not intended to be exhaustive or to limit the invention to the precise form disclosed, and any modifications and variations are possible in light of the above teaching without deviating from the spirit and scope of the invention. The embodiments described are best selected to explain the principles of the invention and its practical applications to thereby enable others skilled in the art to best utilize the invention in various embodiments and with various modifications as suited to the particular purpose contemplated.

All such changes, and others which will be clear to those skilled in the art from this description of the preferred embodiments of the invention, are intended to fall within the scope of the following, non-limiting claims.

What is claimed is:

1. In a computer aided drafting and design environment, a system of managing and updating CADD standards from a single source comprising:
(a) A centralized network standards distributive control system, said system comprising a first computer in data communication with a network, the user interface application of the present invention, a single source compilation of CADD standards coupled to said user interface application, and a standards control entity;
(b) A network;
(c) CADD drawing production system comprising a second computer in data communication with said network, a CADD software application, and a CADD drawing coupled to said CADD application requiring input of said standards from said compilation; and
(d) Said centralized network distributive control system coupled to said CADD drawing production system.

2. The system of claim 1 wherein said user interface application comprises a plurality of additional command functions.

3. The system of claim 1 wherein said user interface application comprises automatic input and update of said standards.

4. The system of claim 1 wherein said compilation of CADD standards comprises embedded data.

5. A CADD drawing of the system of claim 1.

6. A method of CADD standards quality control comprising:
(a) Providing a single source compilation of said CADD standards in a user interface application of the present invention on a first computer, said first computer in data communication with a network;
(b) Accessing said network;
(c) Accessing a second computer in data communication with said network, said second computer comprising a CADD application, and a drawing comprising said CADD standards;
(d) Communicating said user interface application located on said first computer with said CADD application located on said second computer;
(e) Placing said single source compilation of CADD standards on said first computer in data communication with said CADD application drawing on said second computer;
(f) Comparing said standards in said drawing with said standards in said single source standards compilation;
(g) Recognizing standards resident in said drawing that vary from said respective standards in said compilation;
(h) Transferring a standard from said single source compilation of CADD standards on said first computer to said design drawing on said second computer;
(i) Updating said drawing.

7. A CADD drawing by the method of claim 6.

8. A computer implemented method of business for marketing and providing interactive, single source CADD drawing standards management and quality control to a client via a network, the steps comprising:
(a) providing an on-line centralized network standards distributive control system, said system comprising a first computer in data communication with a network, the user interface application of the present invention, a single source compilation of client CADD standards information coupled to said user interface application, and management of said standards information by a standards control entity;
(b) providing said client with access to data communication with said system, said client accessing said system via a CADD application operable on a second computer, said CADD application comprising a drawing;
(c) accepting command inputs by said client to access said system and retrieve said standard information from said system compilation;
(d) said client selecting standards information on said system related to said drawing resident in said CADD application on said second computer;
(e) transmitting said information over said network from said system to said second computer;
(f) displaying said transmitted standard information on said second computer;
(g) said client importing said displayed information into said CADD application drawing;
(h) said client completing said drawing.

9. The method of claim 8 wherein said client interacts with said system to update said standards information in said drawing from said compilation of standards information.

10. The method of claim 8 wherein said standards information is customized to the requirements of said client.

11. The method of claim 8 wherein said standards information is manually updated by said standards control entity.

12. The method of claim 8 wherein said standards control entity is said client.

13. The method of claim 8 wherein said system provides automatic input and update of said standards information in said drawing.

14. The method of claim 8 wherein said compilation of standards information comprises embedded data.

15. The method of claim 8 wherein said compilation of standards information comprises scalable data.

16. The method of claim 8 wherein said compilation of standards information comprises embedded data analyzed into sub-sets of said embedded data.

17. The method of claim 8 wherein said compilation of standards information comprises a feature table

18. The method of claim 8 wherein said compilation of standards information comprises embedded data comprising price or cost information of an object in said drawing.

19. The method of claim 8 wherein said compilation of standards information comprises embedded data supporting bid tabulation analysis.

20. The method of claim 8 wherein said compilation of standards information comprises embedded data supporting asset identification analysis.

21. The method of claim 8 wherein said compilation of standards information comprises embedded data supporting asset valuation analysis.

22. The method of claim 8 wherein said compilation of standards information comprises embedded data supporting a loan valuation analysis.
